(19) United States
(12) Patent Application Publication
(10) Pub. No.: US 2026/0084994 A1
(43) Pub. Date: Mar. 26, 2026

(54) SYSTEMS AND METHODS FOR CONTROLLING PRODUCT WATER MINERAL CONTENT AND ALKALINITY

(71) Applicant: Pentair Residential Filtration, LLC, Brookfield, WI (US)

(72) Inventors: Derek Sajdak, Fountain Hills, AZ (US); Robert Orvin Crowder, Lino Lakes, MN (US); Charles Bulger, Falcon Heights, MN (US); Ezra Coughlin, Minneapolis, MN (US); Vaughn Stetter, Maplewood, MN (US)

(21) Appl. No.: 19/280,886

(22) Filed: Jul. 25, 2025

Related U.S. Application Data
(60) Provisional application No. 63/699,504, filed on Sep. 26, 2024.

(51) Int. Cl. C02F 9/00; C02F 1/00; C02F 1/66; C02F 1/68

(52) U.S. Cl. CPC C02F 9/00; C02F 1/006; C02F 1/008; C02F 1/001; C02F 1/66; C02F 1/686; C02F 1/687; C02F 2201/005; C02F 2209/06; C02F 2209/07; C02F 2209/10; C02F 2209/40

(57) ABSTRACT

A water treatment system including a prefiltration unit, a pump, a membrane element, one or more valves, a remineralization system, and a first sensor is provided. The prefiltration unit is in fluid communication an untreated water source and produces a prefiltered water. The pump is in fluid communication with the prefiltration unit and the membrane element. The membrane element produces a permeate stream and a retentate stream. The one or more valves regulate a flow of the prefiltered water and a flow of the permeate stream in the water treatment system. The remineralization system is in fluid communication with the membrane element and provides a remineralization material to the permeate stream to produce a remineralized water stream. The first sensor is in fluid communication and positioned downstream of the remineralization system, and the first sensor measures a first characteristic of the remineralized water stream.

### CROSS-REFERENCE TO RELATED APPLICATIONS

This application claims priority to U.S. Provisional Patent Application Ser. No. 63/699,504, filed on Sep. 26, 2024, entitled “SYSTEMS AND METHODS FOR CONTROLLING PRODUCT WATER MINERAL CONTENT AND ALKALINITY,” currently pending, the entire disclosure of which is incorporated herein by reference

### FIELD OF DISCLOSURE

The present disclosure relates generally to systems and methods for controlling product water mineral content and alkalinity in water treatment systems, more specifically to self-mediated saltless whole-home water treatment systems, methods, and apparatus.

### BACKGROUND

Hard water, which is water that contains a high concentration of mineral ions, is a common problem. The most common mineral ions found in hard water are calcium and magnesium, although other metals such as iron, aluminum, manganese, lead, and copper may also be found in hard water. According to the American National Standards NSF/ANSI 44 and NSF/ANSI 330, measured water hardness values of 1 grain per gallon (or 17.1 milligrams per liter) or higher are indicative of hard water. Water may be characterized based on various levels of hardness as shown in Table 1 below.

TABLE 1

| GRAINS PER | MILLIGRAMS PER | WATER |
|---|---|---|
| GALLON | LITER/PPM | HARDNESS |
| Less than 1 | Less than 17.1 | Soft |
| 1-3.5 | 17.1-60 | Slightly Hard |
| 3.5-7 | 60-120 | Moderately Hard |
| 7-10 | 120-180 | Hard |
| Over 10 | Over 180 | Very Hard |

The use of hard water may cause several issues including, among others: dry skin and hair, strange odor or taste of water, dingy cloths, spots on dishes, low water pressure, scale deposits in plumbing and bathroom fixtures, and/or premature appliance breakdown.

Currently, several technologies are available to soften hard water for use in residential or commercial properties. The most common water softening technology is a resin water softener system, which uses an ion exchange resin to remove hard water minerals such as calcium and magnesium from the water. In a resin water softener system, resin beads are placed inside a tank of the water softener system to form a “bed”. Over time, however, the resin bed becomes saturated with the exchanged hardness ions. To regenerate the resin bed for repeated use, a monovalent salt or brine must be added to the tank to flush out the saturated ions. The regenerated water is drained out of the softener tank, and the resin is then ready for reuse.

While resin-based water softeners are effective at removing hardness from water, there are several disadvantages. First, the resin bed needs to be regenerated for repeated use to remove hardness from the water, which increases maintenance costs. Second, resin-based systems require additional water for flushing the resin bed during the regeneration process and a drain for removing the regenerated water; thus, wastewater is produced, and a larger footprint in a residence or commercial space is required for the system.

Another technology that may be used to combat hard water is template assisted crystallization (TAC) technology. However, TAC technology is a water conditioning technology and does not soften water. More specifically, TAC systems do not remove calcium and magnesium ions from water. Rather, they provide nucleation sites that induce the formation of microscopic crystals of calcium and magnesium, and the microscopic crystals then freely pass through the media and do not readily attach to pipes or appliances.

The benefits of TAC technology include that such systems do not need to be regenerated with salt and do not need to be connected to a drain for flushing out retentate water as with resin water softening systems. One disadvantage of TAC water conditioners is that they are not well suited for extremely hard water. Resin water softeners are currently the best option for softening extremely hard water. In addition, TAC water conditioners do not remove iron. Thus, TAC water conditioners require an iron purifier to remove iron from hard water. TAC water conditioners also still allow for some hard water to form scale, though only in small amounts. Finally, the benefits to skin, hair, clothing, and dishes are also negligible with TAC systems.

To meet environmental regulations and customer demand for meaningful saltless water softening, desalination membrane technology has been developed for softening water for residential and commercial use. In particular, Reverse Osmosis (RO) and Nanofiltration (NF) membrane technology have been applied as these membranes remove both total dissolved solids (TDS) and hardness from water, although to different degrees depending on the operating conditions. In addition to removing hardness and TDS, micropollutants, bacteria, viruses, and other contaminants may also be removed. However, the current system designs are complex, require a large footprint, and/or are expensive, which hinders their acceptance by homeowners or commercial end users.

The pH and concentration of dissolved minerals in the product water may have a significant effect on both the aesthetic effects of the water and the possible corrosion of metal plumbing and appliances downstream of the treatment system. As the pH drops farther from a value of 7, the rate of corrosion typically increases. Many typical systems lack features to prevent corrosion of metal plumbing due to low pH in the product water.

Furthermore, membrane-based saltless whole home water treatment systems typically rely on either a pressurized bladder tank or an atmospheric tank to deliver the softened water to the point of use (POU). If a bladder tank is used, the tank pressure and the line pressure drop when water is dispersed, and the water supply may be interrupted. If an atmospheric tank is used, the water must be repressurized with a pump to meet the required line pressure for water delivery to the POU. The filling and emptying of an atmospheric tank also require air exchange, which offers a possibility for contaminants such as airborne bacteria to enter the system, which may have a limited supply of filtered water depending on the size of the reservoir.

Therefore, to overcome the drawbacks of the current water treatment systems and methods, the present disclosure recognizes the need for an improved saltless whole home water treatment system for residential and commercial uses. Additionally, there is a need for a systems and methods for controlling product water mineral content and alkalinity.

### SUMMARY

The present systems, methods, and apparatuses overcome many of the shortcomings and limitations of the prior art devices and systems discussed above. The systems, methods, and apparatuses described include several embodiments of a saltless water treatment system and associated methods.

In one aspect, a water treatment system is disclosed. The water treatment system includes a prefiltration unit, a pump, a membrane element, one or more valves, a remineralization system, and a first sensor. The prefiltration unit is in fluid communication with a source of untreated water, and the prefiltration unit is designed to produce a prefiltered water from the untreated water. The pump is in fluid communication with the prefiltration unit. The membrane element is in fluid communication with the pump via a first line, and the membrane element is designed to produce a permeate stream. The one or more valves are designed to regulate a first flow of the prefiltered water and a second flow of the permeate stream. The remineralization system is in fluid communication with the membrane element, and the remineralization system provides a remineralization material to the permeate stream to produce a remineralized water stream. The first sensor is in fluid communication with the remineralization system, wherein the first sensor is positioned downstream of the remineralization system and is designed to measure a first characteristic of the remineralized water stream.

In some instances, the remineralization material is selected from the group consisting of a calcium carbonate compound, a magnesium carbonate compound, a magnesium oxide compound, a calcium oxide compound, a sodium carbonate compound, a sodium bicarbonate compound, dolomite, a magnesium oxysulfate compound, a potassium carbonate compound, a potassium bicarbonate compound, and combinations thereof.

In certain cases, the water treatment system further includes a tank in fluid communication with the membrane element and the prefiltration unit. In addition, the tank is designed to store the prefiltered water provided from the prefiltration unit and the permeate stream provided from the membrane element. In some such cases, the remineralization material is disposed within the tank. In further such cases, the remineralization material is provided in the form of a solid block.

In certain instances, the remineralization material is provided in the form of an aqueous solution.

In some cases, the remineralization system further includes a reservoir provided in the form of a remineralization cartridge designed to store the remineralization material. In some such instances, the remineralization cartridge is positioned in-line with an outlet feed line or in-line with a membrane permeate line of the water treatment system.

In some instances, the remineralization system further includes a remineralization pump designed to dose the permeate stream with the remineralization material.

In certain cases, a second sensor is positioned upstream of the remineralization system and the second sensor is provided in the form of a pH sensor designed to monitor a pH level of the permeate stream. In addition, the remineralization material released by the remineralization system is designed to alter the pH level of the permeate stream and remineralize the permeate stream.

In certain instances, the water treatment system further includes a blend back valve in fluid communication with the prefiltration unit and the permeate stream, wherein the blend back valve is designed to provide a metered amount of prefiltered water to the permeate stream to achieve a desired parameter in the permeate stream, and the desired parameter is selected from the group consisting of a target TDS value, a target alkalinity value, a target pH value, and combinations thereof.

In some cases, the permeate stream is imparted with a first concentration of solutes, the remineralized water stream is imparted with a second concentration of solutes that is greater than the first concentration of solutes. In addition, the first concentration of solutes is less than about 60 ppm and the second concentration of solutes is more than about 60 ppm.

In another aspect, a water treatment system is disclosed. The water treatment system includes an inlet in fluid communication with a source of inlet water, a pump, a membrane element, a remineralization system, and a first sensor. The pump is in fluid communication with the inlet and is also in fluid communication with the membrane element via a first line. The membrane element produces a membrane permeate water imparted with a first concentration of solutes and a membrane retentate water imparted with a second concentration of solutes that is greater than the first concentration of solutes, and a membrane permeate line is designed to carry the membrane permeate water produced by the membrane element. An outlet feed line is provided in fluid communication with the membrane permeate line and an outlet. The remineralization system is in fluid communication with the membrane element and is positioned downstream of the membrane element. The first sensor is in communication with the outlet feed line and measures a TDS concentration of the membrane permeate water. An output water stream provided from the outlet is imparted with a third concentration of solutes.

In certain cases, the remineralization system introduces a remineralization material to the membrane permeate water before the membrane permeate water exits the outlet, and the remineralization material is selected from the group consisting of a calcium-containing compound, a magnesium-containing compound, a carbonate-containing compound, a bicarbonate-containing compound, and combinations thereof.

In certain instances, the third concentration of solutes is greater than the first concentration of solutes and is also less than the second concentration of solutes.

In some cases, the water treatment system further includes a tank and a tank line that are in fluid communication with the membrane permeate line. The tank is designed to store the membrane permeate water provided from the membrane element, the tank line is in fluid communication with a top portion of the tank and the outlet feed line, and a reservoir of the remineralization system is located downstream of the membrane element and is in fluid communication with the tank line.

In a further aspect, a method of treating water is provided. The method includes providing a water treatment system including a membrane element and a prefiltration unit positioned upstream of the membrane element, passing inlet water through the prefiltration unit to produce a prefiltered water, filtering the prefiltered water with the membrane element to produce a permeate water stream and a retentate water stream, and providing the permeate water stream to a remineralization system. The method also includes sensing, via a first sensor, a first characteristic of the permeate water stream, determining an action based on the first characteristic, and initiating the action. The action includes at least one of maintaining a normal operating condition of the water treatment system, adding a first amount of a mineral solution to the permeate water stream via a remineralization pump, passing the permeate water stream through a remineralization unit, adding a second amount of the prefiltered water to the permeate water stream via a blend back valve, and/or providing the permeate water stream to an outlet feed line and subsequent end user.

In some instances, the method further includes determining a recovery of the membrane element, wherein the action further includes adjusting a flow of the retentate water stream to modify the recovery of the membrane element.

In certain cases, the method further includes recirculating the permeate water stream through the remineralization unit before providing the permeate water stream to the outlet feed line.

In certain instances, the blend back valve is configured to blend the second amount of the prefiltered water into the permeate water stream to achieve a target TDS value and a target alkalinity value, and the second amount of the prefiltered water added to the permeate water stream via the blend back valve is determined by measurements obtained from at least one of a TDS sensor and a pH sensor.

These and other aspects and advantages of the present disclosure will become apparent to those skilled in the art after considering the following detailed description in connection with the accompanying drawings.

### BRIEF DESCRIPTION OF DRAWINGS

FIG. 1 is a schematic diagram of an embodiment of a saltless water treatment system;

FIG. 2 is a schematic diagram of another embodiment of a saltless water treatment system;

FIG. 3A is a partial isometric view of a front, right side, and top view of a saltless water treatment system;

FIG. 3B is a front isometric view of the saltless water treatment system of FIG. 3A;

FIG. 3C is a back isometric view of the saltless water treatment system of FIG. 3A;

FIG. 4A is a schematic diagram of an embodiment of a saltless water treatment system;

FIG. 4B is a schematic diagram of another embodiment of the saltless water treatment system of FIG. 4A;

FIG. 4C is a schematic diagram of another embodiment of the saltless water treatment system of FIG. 4A;

FIG. 4D is a schematic diagram of another embodiment of the saltless water treatment system of FIG. 4A;

FIG. 4E is a schematic diagram of another embodiment of the saltless water treatment system of FIG. 4C;

FIG. 4F is a schematic diagram of another embodiment of the saltless water treatment system of FIG. 4A;

FIG. 5 is a schematic block diagram of an embodiment of a control system for a saltless water treatment system;

FIG. 6 is another embodiment of the water treatment system of FIG. 3A;

FIG. 7 is a schematic diagram of an embodiment of an operational cycle of the saltless water treatment systems of FIGS. 2, 3A-3C, and 4A-4F;

FIG. 8 is a flowchart of an embodiment of a method of treating water using the saltless water treatment systems of FIGS. 1, 2, 3A-3C, and 4A-4F;

FIG. 9 is flowchart of another embodiment of a method of treating water using the saltless water treatment systems of FIGS. 1, 2, 3A-3C, and 4A-4F;

FIG. 10 is a graph representing gallons of water processed by a membrane system versus permeate TDS values, the graph illustrating failure points of the membrane system when various polyphosphate compounds are used as anti-scalants;

FIG. 11 is a graph representing performance of a membrane element and comparing the performance of the membrane element when treated with consistent permeate flushes versus the performance of the membrane element when treated with inconsistent permeate flushes; and

FIG. 12 is a graph representing performance of another membrane element and comparing the performance of the membrane element when treated with consistent permeate flushes versus when no membrane flushes were provided.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein may be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features may be used with the described systems and methods, and that the discussed devices and features are used to provide examples of possible embodiments, without being limited.

At a high level, embodiments of the water treatment systems disclosed herein may include multiple system components that may be located at various locations or points within the water treatment systems. Although other fluids may be processed by the water treatment systems disclosed herein, for purposes of discussion and illustration, the present disclosure will refer to all possible fluids simply as water.

Some embodiments of the water treatment systems disclosed herein may include one or more pipes, conduits, tubing, or other feed or fluid transfer lines, which may connect system components and form a fluid circuit and/or fluid flow path, and allow water to flow from an inlet, through the water treatment system, to an outlet.

Some embodiments of the water treatment systems may include one or more valves to control and regulate water flow into, through, and out of the water treatment system. For example, in some embodiments, the valves may be provided in the form of a gate valve, a check valve, or an actuated ball valve. Some embodiments of the water treatment systems may include one or more prefiltration units to remove sediment, certain chemicals, organics, and other undissolved impurities from inlet water. For example, in some embodiments, the prefiltration units may include a sediment filter or carbon filter. Some embodiments of the water treatment systems may include one or more sensors to measure, monitor, or sense variations in the water at different points in the system including dissolved sediment levels, water conductivity, water flow rates, water temperature, water pressure, water clarity, water volume, ion concentration, or water alkalinity. For example, in some embodiments, the sensors may be provided in the form of a total dissolved solids (TDS) sensor or probe, a flowmeter, a temperature sensor, a pressure sensor or transducer, an oxidation reduction potential (ORP) probe, a colorimeter sensor, an ion-selective electrode sensor, a volume-based batching sensor, and/or a pH sensor.

Some embodiments of the water treatment systems may include one or more membrane elements to remove hardness minerals, micropollutants, bacteria, viruses, and other contaminants from the water. In some embodiments, the membrane elements may be provided in the form of an RO membrane or an NF membrane. Some embodiments of the water treatment systems may include one or more feeders for introducing chemical additives to the water. Some embodiments of the water treatment systems may include one or more pumps to control or regulate water pressure in the system. Some embodiments of the water treatment systems may include one or more storage or retention tanks for holding or storing water that may have been filtered by a prefiltration unit or treated by a membrane element. Some embodiments of the water treatment systems may include one or more valves or capillary flow restrictors to regulate the flow of retentate exiting the system. Furthermore, some embodiments of the water treatment systems may include one or more control systems that may include a controller for monitoring, controlling, and communicating with one or more system components including the valves, sensors, feeders, or pumps. The control system may also include one or more display panels or screens for providing information about the water treatment system to a user.

Embodiments of the water treatment systems disclosed herein may be self-mediating in that the flow of water through the water treatment systems may be controlled or regulated by the physical equilibrium of hydrodynamic forces such that actuated valves, pumps, or flow controllers may not be needed depending on flow conditions. More specifically, water pressure in the various lines of the water treatment system may be retained such that as water flows out of one area of the water treatment system, the pressure in such area may decrease. Water in other areas may then flow toward the area with lower pressure until an equilibrium of pressure within the system is reached. In some embodiments, a pressurized retention tank may be filled with water and the flow of water into and out of a retention tank may be automatic such that actuated valves or flow controllers may not be required or may be omitted for certain operations.

Embodiments of the water treatment systems disclosed herein may include processes for extending the lifetime of the membrane element. Such processes may include using a permeate flush and soak, and/or a forward membrane flush at a high flow rate, and the other membrane cleaning processes described herein. The process of ions forming scale on the membrane surface is not instantaneous. If the concentrated solution is rinsed off the membrane quickly, ions in the solution may not have time to precipitate and form scale. Various systems and methods are provided in which the membrane is flushed with water imparted with a low mineral concentration or water dosed with a chemical additive to help prevent scale formation. In addition, high velocity of the water may be used to further encourage displacement of unwanted foulants.

Embodiments of the water treatment systems disclosed herein may include physical and/or chemical cleaning processes in the form of mechanical and/or time-based cleaning techniques. For example, the physical cleaning processes may include membrane flush, rinse, and/or soak processes, said processes utilizing inlet water or permeate water. Chemical processes may include a membrane flush, rinse, soak, or clean-in-place processes, the processes utilizing a chemical additive.

Embodiments of the water treatment systems disclosed herein may include adding a chemical additive (e.g., a chelation agent, a polyphosphate compound, and/or an acidic compound) before the water is provided to the membrane element as a rinse or soak.

Embodiments of a water treatment system disclosed herein provide several advantages over current water treatment systems. One advantage of the water treatment systems disclosed provide for a simplified saltless water treatment system. For example, the water treatment systems may operate with only a single pump and tank. Another advantage of the unique design of the water treatment systems disclosed is that the water treatment systems enable a continuous supply of water to a point of use in a residential or commercial property. For example, the tank may be in fluid communication with inlet water via a prefiltration unit such that prefiltered water may flow through the tank directly to an outlet, rather than having to first go through a membrane element. Providing the storage tank in parallel with the membrane element enables the water treatment system to always provide water to a point of use within a residential or commercial property even during high-demand periods. Further, the water treatment systems disclosed herein use physical equilibrium of hydrodynamic forces to help ensure that water may always be supplied to a point of use, even if there is a power outage, unless the water source is a well. Furthermore, the water treatment system utilizes a prefiltration unit such that the residential or commercial property will always have at least some level of filtered water flowing to a point of use, even if the inlet water is not provided to the membrane element before being provided to the point of use.

Another advantage of the embodiments of a water treatment system disclosed herein is that the unique design of the water treatment system enables the membrane element to operate at least about an 80% recovery rate, at least about an 85% recovery rate, or at least about a 90% recovery rate or greater, which minimizes the amount of wastewater produced. To enable such a high recovery rate, the water treatment systems disclosed may use, for example, a prefiltration unit to remove larger particulates (e.g., particulates with a diameter of greater than about 5 microns) from the inlet water to minimize the clogging of pores in the membrane element. In addition, in some embodiments of the water treatment system disclosed herein, a permeate flush, e.g., low TDS water, may be used to clean the membrane element. Low TDS water may be any water imparted with a TDS concentration lower than the TDS concentration of the inlet water provided to the system. Additionally, or alternatively, low TDS water may be water imparted with a TDS concentration of less than about 3.5 grains per gallon (60 milligrams per liter). Low TDS water may be water imparted with a TDS concentration of less than about 60 ppm. Using a permeate flush to clean the membrane as part of the operational cycle of the water treatment system minimizes the build-up of scale on the membrane element because the surface of the membrane element may not be habitually exposed to water with a high TDS content. High TDS water may be water imparted with a TDS concentration that is about equal to or greater than the TDS concentration of the inlet water entering the system. Additionally, or alternatively, high TDS water may be water imparted with a TDS concentration greater than about 3.5 grains per gallon (60 milligrams per liter). Additionally, or alternatively, high TDS water may be water imparted with a TDS concentration greater than about 60 ppm. Furthermore, in some embodiments of the water treatment systems disclosed herein, a chemical additive released by a feeder may be used to maintain membrane element health.

In some embodiments, the water treatment system disclosed herein may include a remineralization system positioned downstream of the membrane element. The remineralization system may be designed to increase the mineral or TDS content of the permeate water before providing the permeate water to a point of use. In certain instances, the remineralization system may be positioned in-line in the water treatment system. In other instances, the remineralization system may not be positioned in-line in the water treatment system and instead be placed in fluid communication with the water treatment system via a dosing mechanism or pump. In other instances, the remineralization system may be disposed within the tank. In some instances, the remineralization system may be associated with a blend back valve that is designed to provide prefiltered water to the permeate water stream. In yet other instances, the remineralization system may be provided with additional components and otherwise provided in the water treatment system than described herein.

A further advantage of the embodiments of a water treatment system disclosed herein is the use of one or more sensors that may be in communication with a control system that may be Internet of Things compatible. Thus, the water treatment system may allow for remote monitoring, control, and troubleshooting, and enable connection and communication with other user devices (e.g., a mobile phone). In some embodiments, the water treatment system may use one or more sensors to detect potential operational or component issues and self-diagnose. For example, the measurements provided by the one or more sensors may be used by the control system in combination with another sensor of the same type (e.g., one or more TDS sensors) or a sensor of a different type (e.g., a flowmeter in combination with a pressure sensor) to monitor the health of a membrane element, to trigger the pump on or off, and/or to detect a condition (e.g., an increase in the amount of high TDS water in the tank).

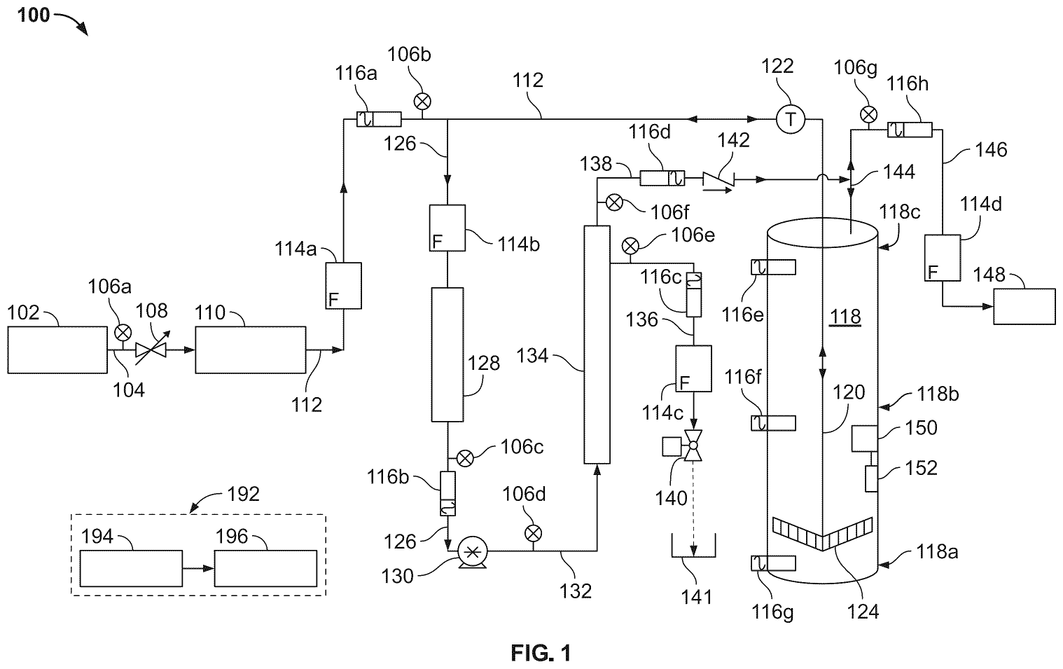

FIG. 1 illustrates an embodiment of a water treatment system 100. The water treatment system 100 may include an inlet 102 through which inlet water (e.g., hard water) enters the water treatment system 100. The inlet water may pass through a prefiltration unit 110, where the inlet water may be filtered, and sediment or other contaminants may be removed. The prefiltered water may flow into a tank 118 where the prefiltered water is stored for future processing by a membrane element 134 of the water treatment system 100. The prefiltered water may also flow into and through the tank 118 to an outlet 148 of the water treatment system 100 for immediate use. Alternatively, or additionally, the prefiltered water may flow toward a membrane element 134 after passing through the prefiltration unit 110. As the prefiltered water flows toward the membrane element 134, the prefiltered water may pass a feeder 128, which may be designed to add a chemical additive to the prefiltered water. In some instances, the feeder 128 may be positioned elsewhere in the system 100 (e.g., downstream of the pump 130 or downstream of the membrane element 134). After passing the feeder 128, the prefiltered water may flow through the membrane element 134. A pump 130 located on a feed side of the membrane element 134 may be used to direct the prefiltered water toward the membrane element 134. The membrane element 134 may further filter the prefiltered water to remove hardness minerals and other impurities. The membrane filtered water may flow from the membrane element 134 to the tank 118 for storage or may flow directly out of the outlet 148 of the water treatment system 100 to a point of use (POU).

Water with hardness minerals and other impurities that do not pass through the membrane element 134 may be discharged from the membrane element 134 via a retentate line 136.

The water treatment system 100 may have one or more sensors (e.g., sensors 106a-106g, 114a-114d, 116a-116h, 122) that may be disposed at various points in the water treatment system 100 to measure or monitor a characteristic of the water (e.g., pressure, flow rate, conductivity, total dissolved solids, etc.) and provide data to a controller 194. Furthermore, one or more valves (e.g., 108, 140, 142) may be included at various points of the water treatment system 100 to control the flow of water into, through, and out of the water treatment system 100.

Still referring to FIG. 1, the inlet 102 of the water treatment system 100 may be in fluid communication with an inlet line 104. The inlet water may be provided from an inlet water source (not shown). The inlet water source may be, for example, a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 100 may include one or more pressure sensors 106. In some embodiments, the one or more pressure sensors 106 may be defined by a gauge pressure transmitter, a differential pressure transmitter, an absolute pressure transmitter, a multivariate pressure transmitter, or a submersible pressure transmitter.

A first pressure sensor 106a may be in fluid communication with the inlet line 104. The first pressure sensor 106a may measure, monitor, or sense the pressure of the inlet water in the inlet line 104.

The water treatment system 100 may include a first valve 108. The first valve 108 may be in fluid communication with the inlet line 104. In some instances, the first valve 108 is positioned upstream of the pressure sensor 106a, although the first valve 108 may be positioned downstream of the pressure sensor 106a. In some embodiments, the first valve 108 may be a gate valve. In some embodiments, the first valve 108 may be a bypass valve, a solenoid valve, a butterfly valve, a ball valve, a globe valve, a pressure relief valve, or a check valve.

The first valve 108 may control or regulate the amount of inlet water entering the water treatment system 100. The first valve 108 may open, either partially or fully, to enable the flow or increase the amount of inlet water entering the water treatment system 100 through the inlet 102. The first valve 108 may close, either partially or fully, to stop or decrease the flow or amount of inlet water entering the water treatment system 100. In addition, in some embodiments, the water treatment system 100 may be provided with a manual bypass valve (not illustrated) that is configured to decrease, substantially stop, or completely stop the flow of inlet water into the water treatment system 100. The amount of inlet water entering the water treatment system 100 may increase or decrease the water pressure in the water treatment system 100.

The water treatment system 100 may include the prefiltration unit 110. The prefiltration unit 110 may be provided in the form of one or more prefilter elements having one or more filter media. The prefiltration unit 110 may be in fluid communication with the inlet line 104 and a prefiltered water line 112. Inlet water may enter the prefiltration unit 110 via the inlet line 104 and exit the prefiltration unit 110 via the prefiltered water line 112. When inlet water passes through the prefiltration unit 110, the prefiltration unit 110 may remove sediment, particulates, certain chemicals and other contaminants from the inlet water, producing a prefiltered water that may flow out of the prefiltration unit 110 via the prefiltered water line 112.

In some embodiments, the prefiltration unit 110 may include a sediment filter. The sediment filter may remove sediments, such as sand, silt, dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some such embodiments, the sediment filter may include a depth media, woven fabric, or nonwoven fabric.

In some embodiments, the prefiltration unit 110 may include an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, or the like. In some embodiments, a non-carbon-based media, such as clay or an ion exchange media, may be used in place of the activated carbon media.

By removing sediment, chlorine, chloramine, and other contaminants, the prefiltration unit 110 may provide prefiltered water that may have substantially no odor and have an improved taste compared to the inlet water. In addition, by removing sediment, chlorine, chloramine, and other contaminants, the prefiltration unit 110 may protect the downstream membrane element 134 from sediment fouling or oxidation.

In some embodiments, the prefiltration unit 110 may be defined by a series of prefilter elements (e.g., two or more sediment filters) or may be comprised of a combination of prefilter elements (e.g., one or more sediment filters and one or more activated carbon filters). One of ordinary skill in the art would understand that the one or more prefilter elements that comprise the prefiltration unit 110 may be retained within a single prefiltration element or may be separate and distinct prefiltration elements that are in fluid communication with one another. In some embodiments, the prefiltration unit 110 may be a PENTAIR® EVERPURE® filter. In other embodiments, the prefiltration unit 110 may be a PENTAIR® PENTEK® BIG BLUE® filter.

The water treatment system 100 may include one or more flowmeters 114. In some embodiments, the one or more flowmeters 114 may be provided as a mechanical flowmeter or an ultrasonic flowmeter. In some embodiments, the one or more flowmeters may include a ⅜ inch (0.95 centimeter) F-nut inflow connector, a ⅜ inch (0.95 centimeter) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 114 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 114a-114d may be the same type of flowmeter or may each be a different type of flowmeter.

A first flowmeter 114a may be positioned within or otherwise in fluid communication with the prefiltered water line 112. The first flowmeter 114a may measure, monitor, or sense the flow rate of the prefiltered water through the prefiltered water line 112.

The water treatment system 100 may include one or more TDS sensors 116. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about ±10% Full Scale (25° C.). In some embodiments, the one or more TDS sensors 116 may be a TDS sensor having a TDS measurement range of at least about 0 to about 3000 ppm or greater than about 3000 ppm. In other embodiments, the TDS sensor may be a flexible TDS probe as described in U.S. patent application Ser. No. 17/657,916 owned by Pentair Residential Filtration, LLC, and incorporated herein by reference. One of ordinary skill in the art would understand that each of the one or more TDS sensors 116a-116h may be the same type of TDS sensor or may each be a different type of TDS sensor.

A first TDS sensor 116a may be in fluid communication with the prefiltered water line 112. The first TDS sensor 116a may measure, monitor, or sense the conductivity of the prefiltered water to determine a concentration or an amount of dissolved solids in the prefiltered water (e.g., inlet water that has passed through the prefiltration unit 110).

The water treatment system 100 may include a second pressure sensor 106b that may be in fluid communication with the prefiltered water line 112. The second pressure sensor 106b may measure, monitor, or sense the pressure of the prefiltered water in the prefiltered water line 112.

The water treatment system 100 may include a temperature sensor 122 that may be in fluid communication with the prefiltered water line 112. The temperature sensor 122 may be designed to measure, monitor, or sense the temperature of the prefiltered water. In some embodiments, the temperature sensor 122 may be a thermistor, a thermocouple, a semiconducting material, or any other mechanical or electronic sensor that may respond to a change in temperature. In some embodiments, additional temperature sensors may be included in the water treatment system 100. In some embodiments, an additional temperature sensor may be optionally placed on or within the inlet line 104.

The water treatment system 100 may include the tank 118, which may be used to store prefiltered water from the prefiltration unit 110 and permeate from the membrane element 134. The tank 118 may be in fluid communication with the prefiltration unit 110 and the membrane element 134. The tank 118 may be defined by a housing having a bottom portion 118a, a center portion 118b, and a top portion 118c. In some instances, each of the portions 118a, 118b, 118c may be separated by a physical barrier (e.g., if the tank 118 is provided as a bladder tank), although in preferred embodiments no physical barrier is positioned between the portions 118a, 118b, 118c. In some embodiments, the tank 118 may be a flow through tank, which may allow for the seamless delivery of water to a POU. In some embodiments, the tank 118 may be a pressurized tank. In some embodiments, the tank 118 may be a fiberglass reinforced plastic (FRP) tank. In some embodiments, the tank 118 may range in size from about 24 gallons (91 liters) to about 200 gallons (757 liters). In other embodiments, multiple tanks 118 of any size may be connected in series. In further embodiments, existing water vessels within the residential or commercial property (e.g., a water heater) may be used for additional storage capacity.

The tank 118 may include a riser tube 120 that extends vertically from the bottom portion 118a of the tank 118 to the top portion 118c of the tank 118, or vice versa. The riser tube 120 may be in fluid communication with the prefiltered water line 112. In some embodiments, the riser tube 120 may be provided as PVC tubing.

The tank 118 may further include a flow distributor 124, which may be attached or coupled to the riser tube 120. The flow distributor 124 may prevent or reduce the mixing of higher TDS water that may be stored in the bottom portion 118a of the tank 118 with lower TDS water that may be stored in the top portion 118c of the tank 118. In some embodiments, the flow distributor 124 may be a dome flow distributor. In some embodiments, multiple flow distributors 124 may be used.

Additionally, or alternatively, the tank 118 may include baffles and external plumbing (e.g., flow distributors) to reduce the mixing of higher TDS water that may be stored in the bottom portion 118a of the tank 118 with lower TDS water that may be stored in the top portion 118c of the tank 118.

In some embodiments, the high TDS water is added to the bottom portion 118a of the tank 118, and the low TDS water is added to the top portion 118c of the tank 118. Advantageously, adding the high TDS water and the low TDS water to the tank 118 in this manner may help maintain the separation between the high TDS water and the low TDS water in the tank 118, which in turn may help ensure that low TDS water is provided to a point of use during operation of the tank 118.

The water treatment system 100 may include an additive line 126. The additive line 126 may be physically connected to or otherwise in fluid communication with the prefiltered water line 112.

A second flowmeter 114b may be positioned within or otherwise in fluid communication with the additive line 126. The second flowmeter 114b may measure, monitor, or sense the flow rate of the prefiltered water through the additive line 126.

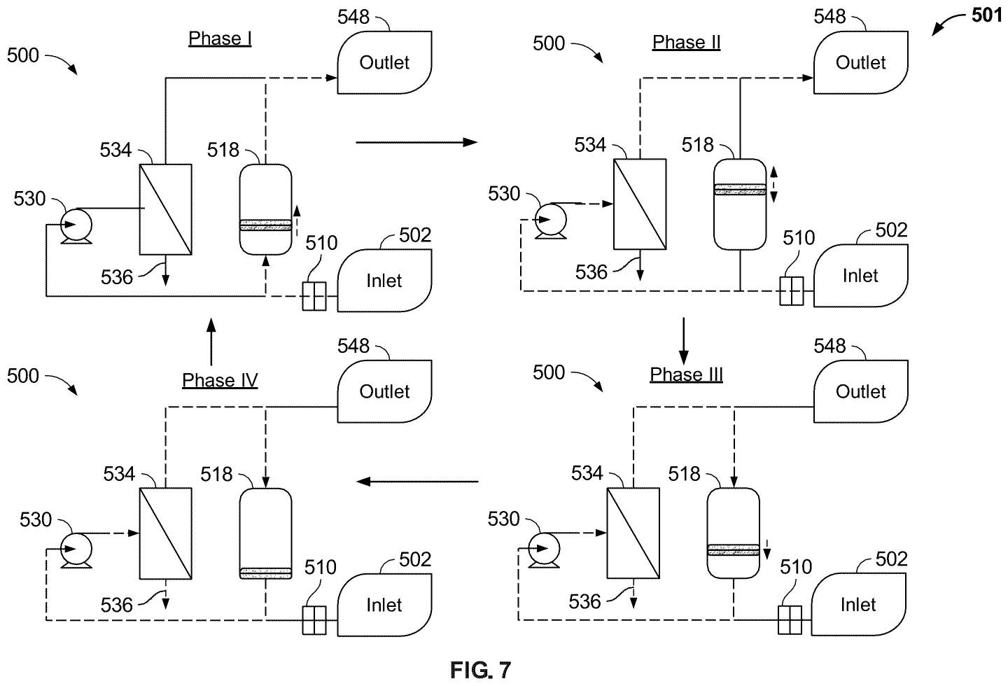

The prefiltered water may have a fluid flow path through the water treatment system 100. In some embodiments, depending on the flow conditions when the water treatment system 100 is in use, the prefiltered water may flow in different directions, as described in more detail below (see, e.g., FIG. 7). For example, during some flow conditions, the prefiltered water may flow directly from the prefiltration unit 110 through the prefiltered water line 112, down the riser tube 120, and into the bottom portion 118a of the tank 118. The prefiltered water may be stored in the tank 118. During other flow conditions, the prefiltered water may flow from the prefiltration unit 110 via the prefiltered water line 112 toward the membrane element 134 via the additive line 126 and a membrane feed line 132. During further flow conditions, the prefiltered water may flow from the bottom portion 118a of the tank 118, up the riser tube 120, and through the prefiltered water line 112 toward the membrane element 134 via the additive line 126 and the membrane feed line 132.

The water treatment system 100 may include the feeder 128 that is in fluid communication with the additive line 126. The feeder 128 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate.

In some embodiments, when the prefiltered water flows through or passes by the feeder 128, the chemical additive may be added or introduced to the prefiltered water. The chemical additive may dissolve or otherwise degrade in the prefiltered water. In some embodiments, as further detailed herein, the feeder 128 may impart the water flowing through the feeder 128 with a chemical additive concentration of at least about 0.01 ppm to at least about 10 ppm, or at least 0.01 ppm to at least 10 ppm. In other embodiments, the feeder 128 may impart the water flowing through the feeder 128 with a chemical additive concentration of less than 0.01 ppm or greater than 10 ppm of the chemical additive.

The water treatment system 100 may include a third pressure sensor 106c that may be in fluid communication with the additive line 126. The third pressure sensor 106c may measure, monitor, or sense the pressure of the prefiltered water with additive in the additive line 126. Alternatively, if a chemical additive is not added by the feeder 128, the third pressure sensor 106c may measure, monitor, or sense the pressure of the prefiltered water in the additive line 126.

The water treatment system 100 may include a second TDS sensor 116b. The second TDS sensor 116b may be in fluid communication with the additive line 126. The second TDS sensor 116b may measure, monitor, or sense the conductivity of the prefiltered water to determine an amount or concentration of dissolved solids in the prefiltered water (with or without additive). The prefiltered water with additive may have a higher TDS than the prefiltered water without additive.

The water treatment system 100 may include the pump 130. An inlet side (not shown) of the pump 130 may be in fluid communication with the additive line 126, and an outlet side (not shown) of the pump 130 may be in fluid communication with the membrane feed line 132. In some embodiments, the pump 130 may be a single-phase booster pump. For example, the pump 130 may be a PENTAIR® STA-RITE™ single-phase 115 volt, ¾ horsepower pump. In some embodiments, the pump 130 may be a multi-phase booster pump. In some embodiments, the pump 130 may boost differential pressure in the membrane feed line 132 to 120-250 pounds per square inch (827-1725 kilopascals) at a flow rate of 1.0-7.0 gallons per minute (11-26 liters per minute) or at a preferable flow rate of 2.0-5.0 gallons per minute (7.5-19 liters per minute).

The membrane feed line 132 may be in fluid communication with a fourth pressure sensor 106d. The fourth pressure sensor 106d may measure, monitor, or sense the pressure of the prefiltered water (with or without additive) in the membrane feed line 132.

The water treatment system 100 may include the membrane element 134. The membrane element 134 may be designed to remove solutes from the prefiltered water and produce a permeate stream imparted with a first concentration of solutes and a retentate stream imparted with a second concentration of solutes, wherein the first concentration of solutes may be less than the second concentration of solutes. In some embodiments, the membrane element 134 may be a reverse osmosis (RO) membrane. In some embodiments, the RO membrane may be spiral wound and may include feed spacers imparted with a certain thickness and/or structure. In some embodiments, the RO membrane may be a spiral wound RO membrane (e.g., a spiral wound 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 134 may be a nanofiltration (NF) membrane, an ultrafiltration (UF) membrane, a microfiltration (MF) membrane, or a particulate membrane. In some embodiments, the membrane element 134 may be a hollow fiber NF membrane. In other embodiments, the membrane element 134 may be an electrodialysis membrane system.

In some embodiments, the membrane element 134 may comprise a combination of one or more of an RO membrane, an NF membrane, a UF membrane, an MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

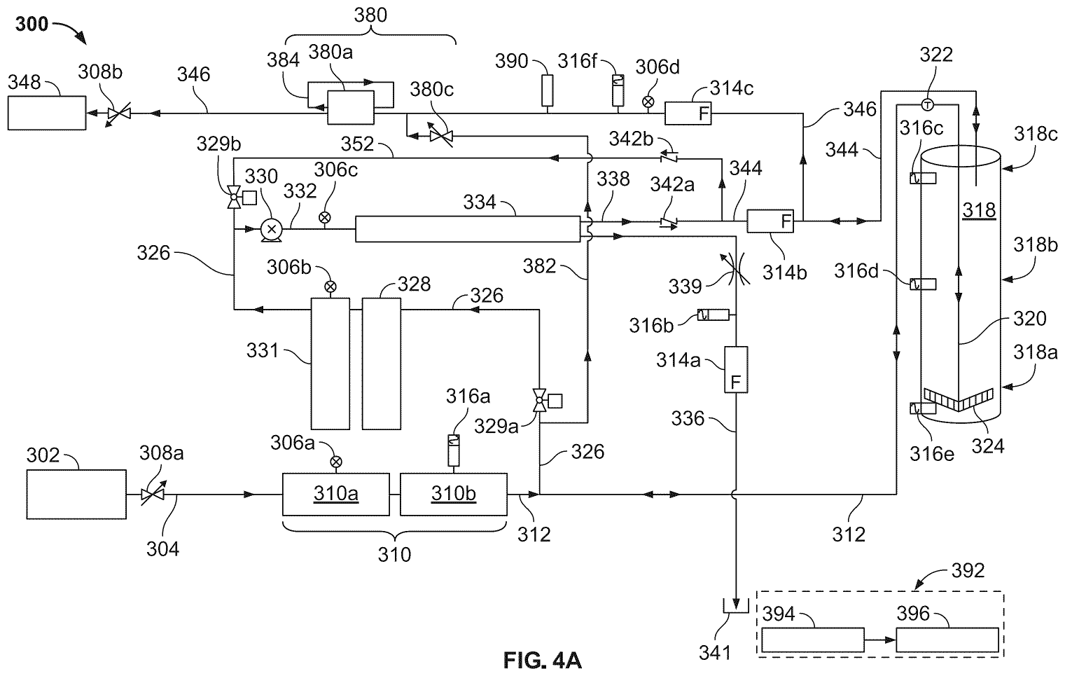

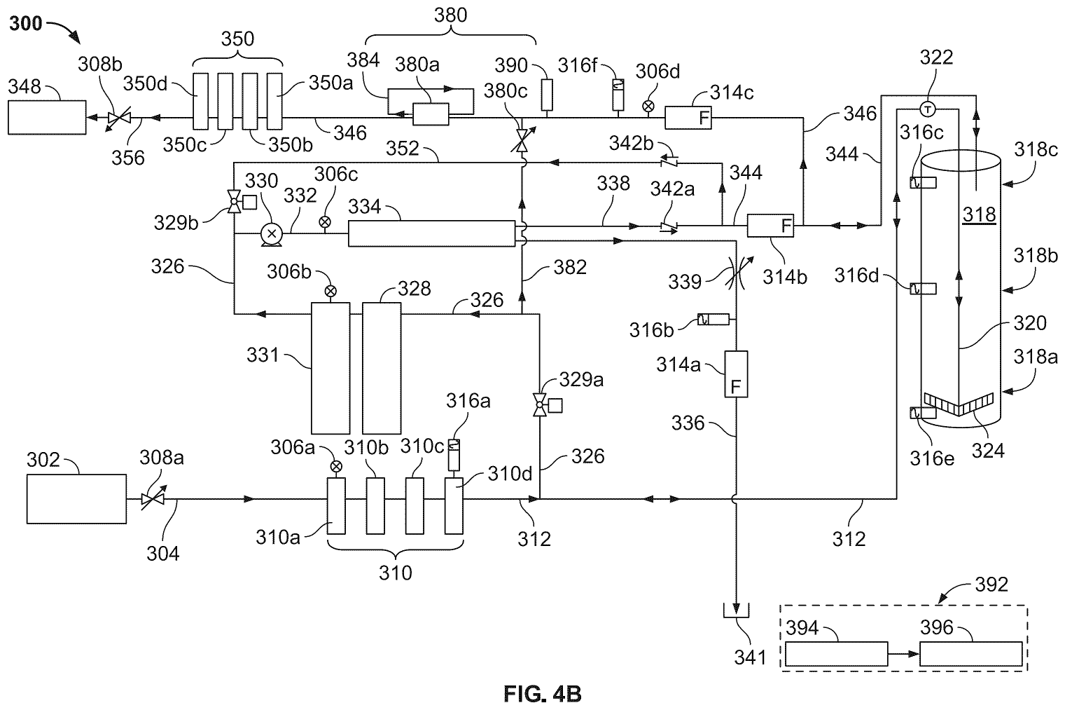

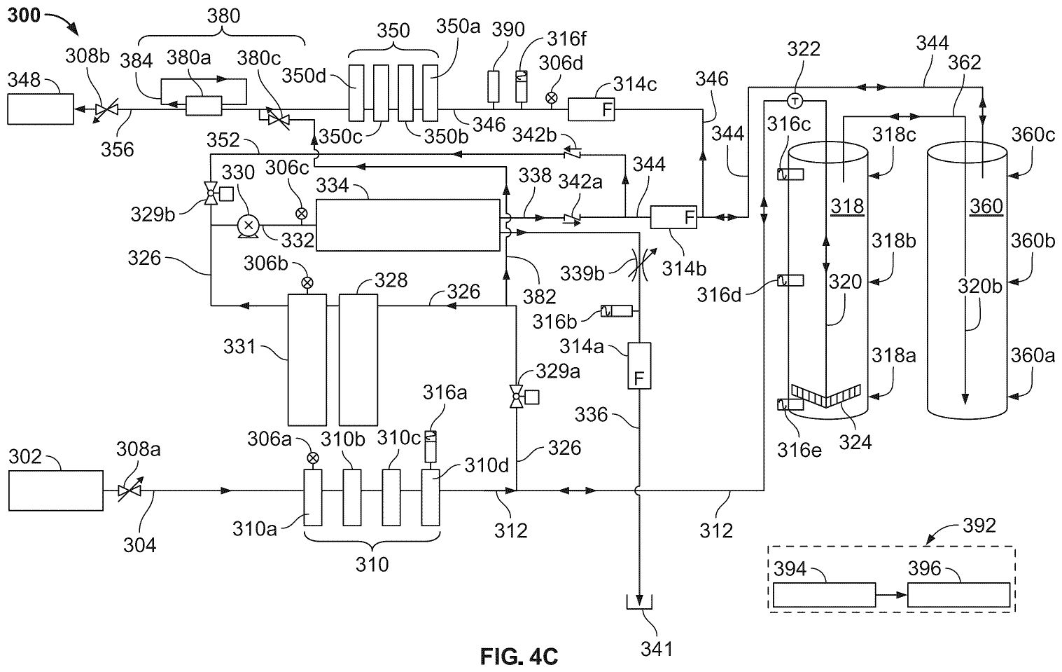

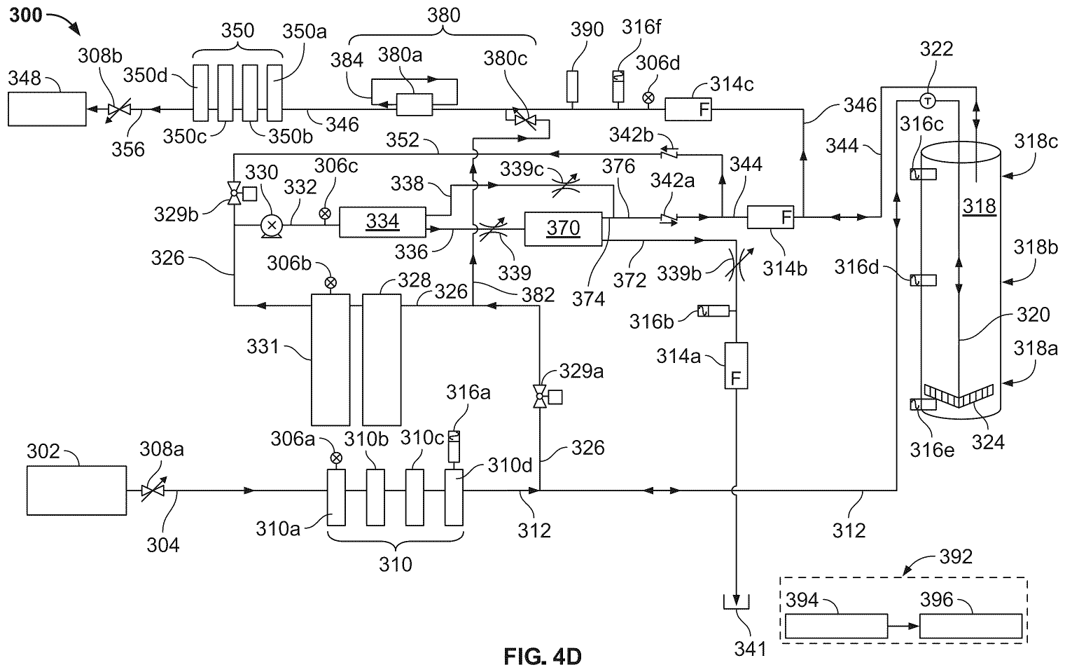

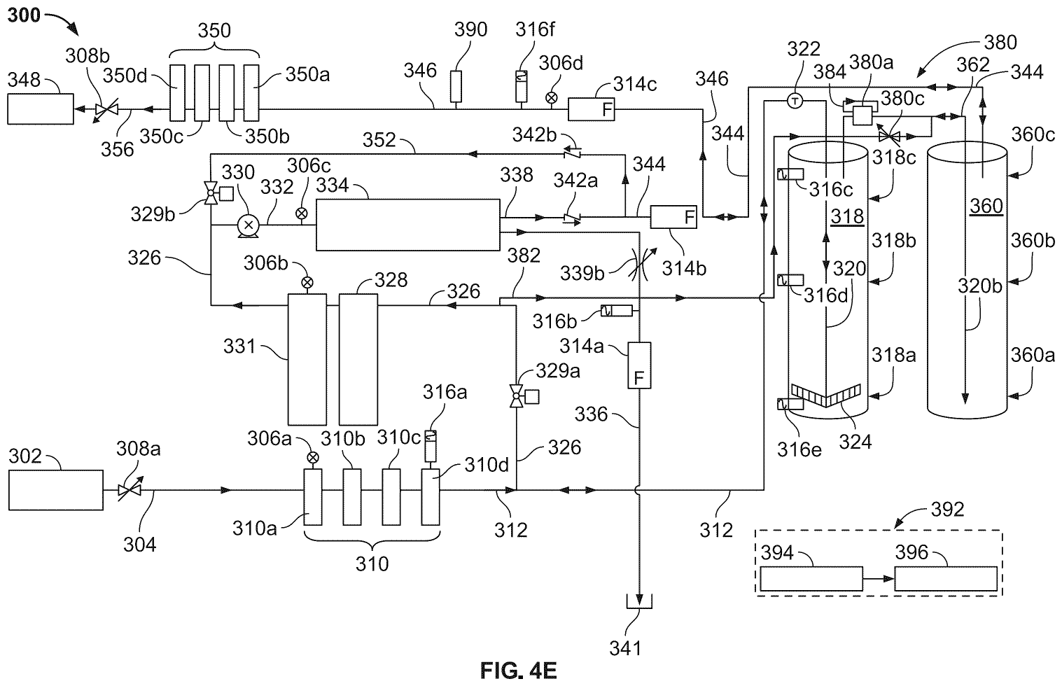

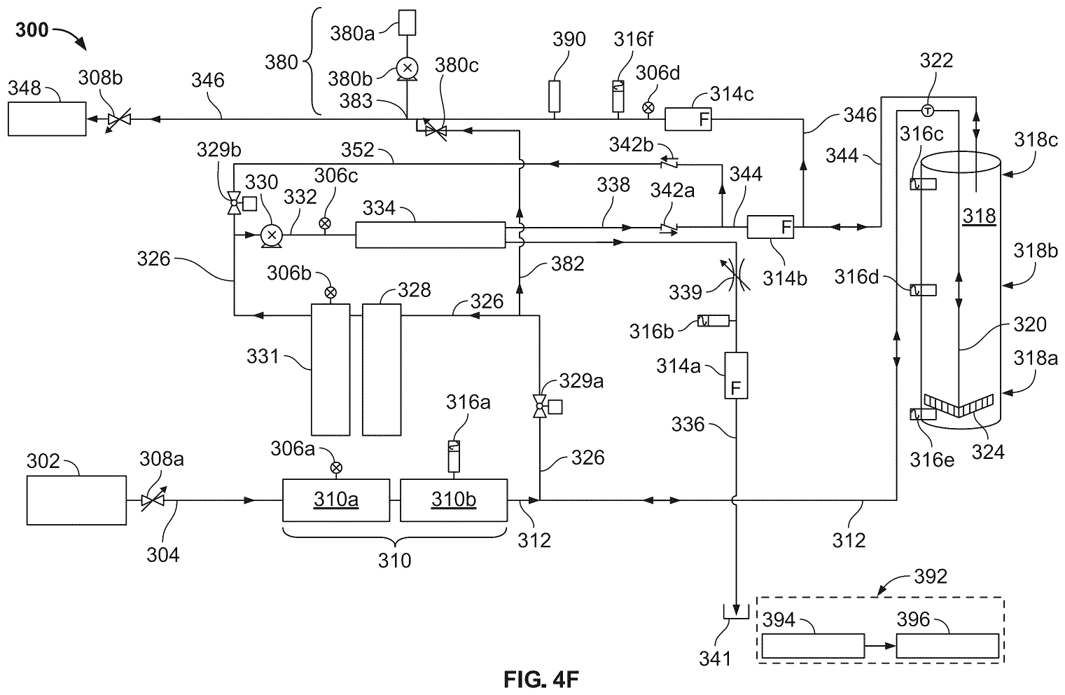

In further embodiments, the membrane element 134 may include two or more RO membranes, NF membranes, UF membranes, MF membranes, particulate membranes, and/or electrodialysis membranes, which may be disposed in parallel or in series. In some embodiments, the membrane element 134 may be a series of membranes of the same type (e.g., two or more RO membranes) but of a different size. For example, the membrane element 134 may include a first membrane imparted with a first diameter and a second membrane imparted with a second diameter that is different from the first diameter (e.g., the second diameter may be less than the first diameter). In some embodiments, the first membrane may be a spiral wound 4040 RO membrane, and the second membrane may be a spiral wound 2540 RO membrane. The two or more membranes may be contained within a single housing, in separate housings (e.g., as shown in FIG. 4D), or a combination thereof.

Varying the membrane type and/or size may be used to optimize the level of permeate production, allowing for enhanced water recovery, while at the same time balancing factors such as a particular permeate water chemistry and/or membrane health. For example, in some embodiments, including at least one NF membrane as a first or second membrane in series may allow for higher total permeate output as compared to utilizing two RO membranes. In other embodiments, including two or more RO membranes in series, for example, may help maintain a higher velocity on the feed side of the individual membranes, which in turn may reduce ion concentration at the membrane surface of each membrane. In addition, including two or more RO membranes in series may enable the operation of the individual RO membranes at different membrane recoveries, which may help optimize permeate production as dissolved mineral content increases.

In further embodiments, using a smaller membrane as a second membrane in a series of membranes, where the first membrane is imparted with a diameter that is larger than the diameter of the second membrane, may allow the water entering the second membrane to have a higher velocity, which may boost overall water recovery. For instance, in some embodiments, if the water treatment system 100 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 100 may be increased to at least about a 94% recovery.

The membrane element 134 may be in fluid communication with the membrane feed line 132 on a feed side (not shown) of the membrane element 134. The membrane element 134 also may be in fluid communication with the retentate line 136 on the feed side of the membrane element 134. The membrane element 134 may be in fluid communication with a membrane permeate line 138 on a permeate side (not shown) of the membrane element 134.

In some embodiments, as the prefiltered water (with or without additive) enters the feed side of the membrane element 134, the membrane element 134 may allow a solvent (e.g., water) in the prefiltered water to pass through a surface of a membrane (not shown) retained within the membrane element 134. The solvent that passes through the surface of the membrane may exit from the permeate side of the membrane element 134 as membrane permeate via the membrane permeate line 138. Solutes (e.g., dissolved minerals and ions and various organic compounds) in the prefiltered water may not pass through the membrane and may be retained at the surface of the membrane. The solutes may be discharged from the feed side of the membrane element 134 as retentate via the retentate line 136.

In some embodiments, when the pump 130 is activated, the pump 130 may increase the rate at which water flows into the membrane feed line 132 toward the membrane element 134. Increasing the flow rate of water into the membrane feed line 132 may increase pressure in the membrane feed line 132. The increased pressure may in turn aid in pushing solvent in the membrane feed line 132 through the pores formed within the surface of the membrane retained within the membrane element 134.

The water treatment system 100 may include a fifth pressure sensor 106e that may be in fluid communication with the retentate line 136. The fifth pressure sensor 106e may measure, monitor, or sense the pressure of the retentate in the retentate line 136.

The water treatment system 100 may include a third TDS sensor 116c that may be in fluid communication with the retentate line 136. The third TDS sensor 116c may measure, monitor, or sense the conductivity of the retentate to determine an amount or concentration of dissolved solids in the retentate.

The water treatment system 100 may include a third flowmeter 114c. The third flowmeter 114c may be positioned within or otherwise in fluid communication with the retentate line 136. The third flowmeter may measure, monitor, or sense the flow rate of the retentate in the retentate line 136.

The water treatment system 100 may include a second valve 140. The second valve 140 may be in fluid communication with the retentate line 136. In some embodiments, the second valve 140 may be an actuated ball valve. In some embodiments, the second valve 140 may be a gate valve, a butterfly valve, a globe valve, a pressure relief valve, a check valve, a needle valve, a flow control valve, or a pressure regulator.

The second valve 140 may be used to control or regulate the amount of retentate leaving the water treatment system 100 via the retentate line 136 into a drain 141. The second valve 140 may open, either partially or fully, to enable the flow or increase the amount of retentate flowing through the retentate line 136 into the drain 141. The second valve 140 may close, either partially or fully, to stop or decrease the flow or amount of retentate flowing through the retentate line 136. In some embodiments, a flow restrictor tube may be used instead of or in combination with the second valve 140. The amount of retentate exiting the water treatment system 100 into the drain 141 may increase or decrease the water pressure in the water treatment system 100.

The water treatment system 100 may include a sixth pressure sensor 106f that may be in fluid communication with the membrane permeate line 138. The sixth pressure sensor 106f may measure, monitor, or sense the pressure of the membrane permeate in the membrane permeate line 138.

The water treatment system 100 may include a fourth TDS sensor 116d that may be in fluid communication with the membrane permeate line 138. The fourth TDS sensor 116d may measure, monitor, or sense the conductivity of the membrane permeate to determine an amount or concentration of dissolved solids in the membrane permeate.

The membrane permeate line 138 may be connected to or otherwise in fluid communication with a tank line 144. The tank line 144 may be in fluid communication with the top portion 118c of the tank 118. The tank line 144 also may be connected to or otherwise in fluid communication with an outlet feed line 146. The outlet feed line 146 may be in fluid communication with the outlet 148 and designed to provide the outlet 148 with prefiltered, remineralized water from the water treatment system 100.

In some embodiments, depending on the flow conditions when the water treatment system 100 is in use, the membrane permeate may flow from the permeate side of the membrane element 134 through the membrane permeate line 138 and the tank line 144 into the top portion 118c of the tank 118. The membrane permeate may be stored in the tank 118. The membrane permeate may also flow from the membrane permeate line 138 to the tank line 144, into the outlet feed line 146 (thereby bypassing the tank 118), and out of the outlet 148. By enabling the flow of membrane permeate from the membrane element 134 directly to the outlet 148, membrane permeate may be provided to a POU in real time.

Due to the amount of dissolved ions in high TDS water, high TDS water tends to have a higher density than low TDS water. By sending higher TDS water (e.g., the prefiltered water) to the bottom portion 118a of the tank 118 and lower TDS water (e.g., the membrane permeate) to the top portion 118c of the tank 118, the chances of water with different TDS amounts or concentrations mixing inside the tank 118 may be minimized. Thus, when membrane permeate is drawn from the top portion 118c of the tank 118, low TDS water may be provided to a point of use. Sending higher TDS water to the bottom of the tank 118 and lower TDS water to the top of the tank 118 may also create a sharp TDS profile along the vertical height of the tank 118, where the amount or concentration of TDS at the bottom portion 118a of the tank 118 is the highest (e.g., a TDS concentration of more than about 3.5 grains per gallon (60 milligrams per liter)), and the amount or concentration of TDS at the top portion 118c of the tank 118 is the lowest (e.g., a TDS concentration of less than about 3.5 grains per gallon (60 milligrams per liter)). Creating and maintaining this sharp TDS profile may be aided by the density difference between the high TDS water and the low TDS water.

The water treatment system 100 may include a third valve 142 that may be in fluid communication with the membrane permeate line 138 to regulate flow of the prefiltered water and the permeate. In some embodiments, the third valve 142 may be a check valve. In some embodiments, the third valve may be a gate valve, a butterfly valve, a globe valve, a pressure relief valve, or a ball valve.

The third valve 142 may be used to control or regulate the amount of membrane permeate entering or flowing through the membrane permeate line 138 into the tank line 144 and into the top portion 118c of the tank 118 or out of the outlet 148 via the outlet feed line 146. The third valve 142 may open, either partially or fully, to enable or increase the flow or the amount of membrane permeate flowing through the membrane permeate line 138 to the tank line 144, and into the top portion 118c of the tank 118 or into the outlet feed line 146 and out of the outlet 148. The third valve 142 may close, either partially or fully, to stop or decrease the amount of membrane permeate flowing through the membrane permeate line 138 and the tank line 144, into the top portion 118c of the tank 118 or into the outlet feed line 146 and out of the outlet 148. The amount of membrane permeate entering or flowing through the membrane permeate line 138 and into the tank 118 or out of the outlet 148 may increase or decrease the water pressure in the water treatment system 100. In some instances, the third valve 142 may be a check valve that is used to prevent backflow through the tank line 144, which in turn may help protect the membrane element 134.

In some embodiments, the tank 118 may include a fifth TDS sensor 116e disposed in the top portion 118c, a sixth TDS sensor 116f disposed in the center portion 118b of the tank 118, and/or a seventh TDS sensor 116g disposed in the bottom portion 118a of the tank 118. The fifth TDS sensor 116e may measure, monitor, or sense the conductivity of the water in the top portion 118c of the tank 118 to determine an amount or concentration of dissolved solids in the water located in the top portion 118c of the tank 118. The sixth TDS sensor 116f may measure, monitor, or sense the conductivity of the water in the center portion 118b of the tank 118 to determine an amount or concentration of dissolved solids in the water located in the center portion 118b of the tank 118. The seventh TDS sensor 116g may measure, monitor, or sense the conductivity of the water in the bottom portion 118a to determine an amount or concentration of dissolved solids in the water located in the bottom portion 118a of the tank 118. The fifth, sixth, and seventh TDS sensors (116e, 116f, and 116g, respectively) may create a profile of the TDS levels or concentrations of the water in the tank 118.

In some embodiments, the tank 118 may include zero, one, two, or more TDS sensors disposed in, or otherwise associated with, each of the top, center, or bottom portions of the tank 118. For example, in some embodiments, a TDS sensor may only be disposed in the center portion 118b of the tank, not the top portion 118c or the bottom portion 118a. In other embodiments, a TDS sensor may be disposed in each of the top portion 118c and the bottom portion 118a of the tank 118, but not the center portion 118b. In further embodiments, zero TDS sensors may be disposed in the tank 118.

The water (i.e., membrane permeate (lower TDS) or the prefiltered water (higher TDS)) that may be stored in the tank 118 may flow through the tank line 144 and the outlet feed line 146 out of the outlet 148. The outlet 148 may be in fluid communication with various appliances, fixtures, and plumbing of the residential or commercial property. In some embodiments, the outlet 148 may be in fluid communication with a water heater, faucets, fixtures, or toilets via one or more pipes or tubes.

The water treatment system 100 may include a seventh pressure sensor 106g in communication with the outlet feed line 146. The seventh pressure sensor 106g may measure, monitor, or sense the pressure of the water in the outlet feed line 146.

The water treatment system 100 may include an eighth TDS sensor 116h in communication with the outlet feed line 146. The eighth TDS sensor 116h may measure, monitor, or sense the conductivity of the water in the outlet feed line 146 to determine an amount or concentration of the dissolved solids in the water in the outlet feed line 146.

The water treatment system 100 may include a fourth flowmeter 114d that may be positioned within or otherwise in communication with the outlet feed line 146. The fourth flowmeter 114d may measure, monitor, or sense the flow rate of the water in the outlet feed line 146.

The water treatment system 100 may include an optional remineralization system (such as a remineralization system 380 of FIG. 4) containing a remineralization material. The remineralization material may be provided as a calcium-containing compound or a magnesium-containing compound, although other ionic compounds could also be used to increase the mineral or TDS concentration of the water provided by the system 100 to a point of use. The remineralization material may be, for example, a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In each example, the remineralization material may be provided in the form of a solid, an aqueous solution, a combination of solids (e.g., if more than one remineralization material is provided), and a combination of aqueous solutions (e.g., if more than one remineralization material is provided). In some instances, the remineralization compound may be selected from the group consisting of a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In instances where the remineralization material includes a calcium carbonate compound, the calcium carbonate may be provided in the form of calcite. In some instances, the remineralization material as described herein may be provided in the form of a solid, such as a solid block or a powder, or as an aqueous solution.

In some embodiments, the system 100 may include a remineralization system. In some embodiments of the remineralization system, the remineralization material may be provided in a device including an inlet and an outlet through which water passes. For example, the remineralization system may include a reservoir (see, e.g., a remineralization unit or reservoir 380a in FIG. 4A) designed to store the remineralization material. In some cases, the reservoir and/or the remineralization material may be replaced when the remineralization material is depleted. In some embodiments, the reservoir may be provided in the form of a bed or cartridge. The reservoir may be disposed on a line (e.g., the outlet feed line 146) or another system component of the water treatment system 100, which water passes by but does not flow through. In various cases, the remineralization system may be provided in-line with the membrane permeate line 138 or an outlet line of the water treatment system 100. In other embodiments, the remineralization system may be provided as a remineralization system including a cementitious material as described in U.S. patent application Ser. No. 17/061,830 owned by Pentair Residential Filtration, LLC, and incorporated herein by reference.

In some instances, the reservoir may take the form of a cylinder, although in other embodiments the reservoir may be provided in the form of a different three-dimensional shape (e.g., as a cube, rectangular prism, pyramid, cone, etc.). In some embodiments, the reservoir may include one or more end caps, such as a first end cap coupled to a first end of the reservoir, and a second end cap coupled to a second end of the reservoir that is opposite the first end. In such instances, the first end cap may define the inlet of the reservoir and thus define a flow path for incoming nonmineralized water. Remineralized water may exit the reservoir via an outlet provided in the second end cap.

In some embodiments, at least one of the first end cap and the second end cap may be integrally formed with and thus irremovable from the reservoir. In such instances, upon depletion of the remineralization material, the reservoir may need to be replaced with a new reservoir containing a fresh source of remineralization material, whether in a powder, a block, or an aqueous form. In other instances, the reservoir may be removable from one or more of the end caps and may thereby be removed or replaced upon depletion of the remineralization material. In such instances, the reservoir may be refilled with a fresh stock of the powder, the block, or the aqueous form of the remineralization material and reused in the remineralization system.

In some embodiments, the reservoir may include one or more internal sensors for detecting a filled volume, an amount of remineralization material, and/or a water level of the reservoir. In some cases, the remineralization system may include one or more external sensors designed to determine when the remineralization material has been depleted. In such cases, the determination may be based on whether the TDS value of the remineralized water stream or the solution provided from the remineralization system is at or above a threshold TDS value. The one or more sensors (whether internal or external of the remineralization unit) may be in electronic communication with the controller 194 and indicate when the reservoir may need to be refilled and/or replaced. For example, in some instances, the one or more sensors may be set to produce an alert or notification when at least about 80% of the remineralization material has been depleted. In other instances, the one or more sensors may be set to produce an alert or notification when about at least 20%, or at least about 25%, or at least about 30%, or at least about 40%, or at least about 45%, or at least about 50%, or at least about 60%, or at least about 70%, or at least about 75%, or at least about 85%, or at least about 90%, or at least about 95%, or at least about 99% of the remineralization material has been depleted. In yet other instances, the one or more sensors may be set to produce an alert or notification when at least 20%, or at least 25%, or at least 30%, or at least 40%, or at least 45%, or at least 50%, or at least 60%, or at least 70%, or at least 75%, or at least 80%, or at least 85%, or at least 90%, or at least 95%, or at least 99% of the remineralization material has been depleted.

The remineralization inlet may be configured to place the reservoir of the remineralization system in fluid communication with the line to which the remineralization system is coupled. In general, the remineralization system may be configured to place the entering water stream in contact with the remineralization material to generate a remineralized water stream (also referred to as a “remineralized stream”) that is discharged from the remineralization system through the remineralization outlet. As used herein, the term “remineralized stream” may refer to a permeate stream that has become enriched in, dosed with, or otherwise provided with various minerals and/or additives. The remineralized stream may thus be imparted with a TDS content that is greater than that of the permeate stream. As the permeate stream contacts and/or flows through the remineralization material, the remineralization material may be designed to degrade or dissolve within the remineralization system over time, resulting in a remineralized stream enriched in minerals and additives.

The remineralization system may generally be disposed on or coupled to various system components or lines of the system 100 that are positioned downstream of the membrane element 134. In some embodiments, the remineralization system may be disposed on or coupled to the outlet feed line 146 upstream of the outlet 148. The remineralization system may introduce the remineralization material to the membrane permeate before the membrane permeate exits the water treatment system 100 via the outlet 148. In some embodiments, the remineralization system may be disposed on the membrane permeate line 138 or the tank line 144. For example, the remineralization system may be disposed on the membrane permeate line 138 or the tank line 144 so that the membrane permeate is introduced to the remineralization material before the membrane permeate flows into the top portion 118c of the tank 118.

In other embodiments, the remineralization system may be disposed within a top portion 118c of the tank 118 so that the membrane permeate is introduced to the remineralization material as the membrane permeate flows into or out of the top portion 118c of the tank 118. In further embodiments, the remineralization system may be disposed within a top portion 118c of the tank 118 so that the membrane permeate contacts the remineralization material in the remineralization system while the membrane permeate is stored in the tank 118, including during periods when there is no flow of membrane permeate into or out of the tank 118. In some such instances, the remineralization system may be disposed within the top portion 118c of the tank 118 by coupling the reservoir to an internal surface of the tank 118. In addition, the reservoir may be removably or irremovably coupled to the internal surface using one or more direct attachment means (such as welding of the reservoir to the internal surface) or indirect attachment means (such as with use of a mounting bracket).

In embodiments where the remineralization material is provided as a solid block (e.g., as a block of calcite), the remineralization material may be coupled to one of the lines or another system component of the water treatment system 100 without an outer reservoir or cartridge. For example, a solid block 150 may be disposed within the tank 118 via coupling to an internal surface of the tank 118 using one or more indirect attachment means (i.e., a mounting bracket or holding mechanism). In such instances, water may be directed to pass through or proximate to the solid block 150 of the remineralization material upon entering the tank 118, increasing the contact time between the water and solid block 150 of the remineralization material (e.g., during no flow situations). Furthermore, removing the cartridge surrounding the solid block 150 of the remineralization material may additionally contribute to reducing the overall footprint of the system 100. While the solid block 150 of the remineralization material of FIG. 1 is positioned near the center portion 118b of the tank 118, it is to be understood that the solid block 150 of the remineralization material may be positioned elsewhere in the tank 118 (e.g., the top portion 118c of the tank, the bottom portion 118a of the tank 118) when the solid block 150 of the remineralization material is provided as a solid block. In addition, the solid block 150 of the remineralization material may be provided in the tank 118 without the use of a coupling means when the solid block 150 of the remineralization material is provided as a solid block. Furthermore, the solid block of the solid block 150 of the remineralization material may be provided in any shape, including regular three-dimensional shapes (e.g., a cube, a rectangular prism) and irregular three-dimensional shapes.

In embodiments where the remineralization material is provided as an aqueous solution, the remineralization system may be coupled to one of the lines or another system component of the water treatment system 100. In some cases, the remineralization system may be in fluid communication with a remineralization pump and/or a dosing mechanism designed to dose the remineralization material (e.g., a mineral solution) to the permeate water. For example, in some cases, as illustrated with reference to FIG. 4A, the remineralization system may be positioned in-line with an outlet feed line. The outlet feed line may be designed to deliver remineralized water to the outlet of the system 100. In other cases, as further described with reference to FIG. 4F, a remineralization pump may dose water with the remineralization material to a specified mixing point positioned on the outlet feed line. In some instances, the remineralization pump may be designed to add specific concentrations and/or amounts of the remineralization material (e.g., in the form of aqueous solutions) to the permeate water. In some instances, the system 100 may include a bypass conduit that routes at least a portion of the permeate water around the remineralization system. In some such instances, a bypass valve may be coupled to the bypass conduit to control the flow of fluid through the bypass conduit.

In some embodiments, the remineralization pump may be a single-phase or a multi-phase booster pump. In other embodiments, the remineralization pump may be defined by a diaphragm pump, a peristaltic pump, a piston pump, or a solenoid-driven pump. The pump may be in electronic communication with the controller 194 and may be actuated upon receipt of a command from the controller 194.

In some instances, sodium bicarbonate (or another remineralization material including, but not limited to, a calcium chloride compound, a magnesium chloride compound, a sodium chloride compound, a potassium chloride compound, a magnesium citrate compound, a sodium hydroxide compound, a potassium hydroxide compound, a calcium sulfate compound, a magnesium sulfate compound, a calcium carbonate compound, a magnesium carbonate compound, a magnesium oxide compound, a calcium oxide compound, and dolomite) may be added via the remineralization system to the permeate water before, after, and/or when the system is processing water through the membrane element 134. In other instances, the remineralization system may be provided as or include a blend back valve (see, e.g., a blend back valve 380c in FIG. 4A) that may provide an amount of prefiltered water to the permeate stream to achieve a target TDS value, a target alkalinity value, and/or a target pH value based on the characteristics of the feed water. In one non-limiting case, the blend back valve may be positioned between an additive line (see, e.g., an additive line 326 in FIG. 4A) and an outlet feed line (see, e.g., an outlet feed line 346 in FIG. 4A). In another non-limiting case, the blend back valve may be positioned between a membrane feed line (see, e.g., a membrane feed line 332 in FIG. 4A) and a membrane permeate line (see, e.g., a membrane permeate line 338 in FIG. 4A). In yet another non-limiting case, the blend back valve may be positioned on or proximate to a blend back conduit (see, e.g., the blend back conduit 382 in FIG. 4A), where the blend back conduit is positioned between the additive line (see, e.g., the additive line 326 in FIG. 4A) and either upstream or downstream of a valve coupled to the additive line (see, e.g., a second valve 329a in FIG. 4A).

The remineralization material introduced or otherwise provided by the remineralization system via the reservoir, block of remineralization material, and/or remineralization pump or dosing mechanism may change at least one quality or characteristic of the membrane permeate such as the pH level and/or the TDS level. Changing at least one quality or characteristic of the membrane permeate may improve the aesthetics (e.g., taste) of the membrane permeate and/or reduce the possible corrosion of metal plumbing and appliances downstream from the water treatment system 100. Generally, one or more TDS sensors and/or one or more pH sensors may be positioned upstream and/or downstream of the remineralization system. In some embodiments, one or more TDS sensors may be disposed proximate to, adjacent to, and/or in fluid communication with the remineralization system to monitor the TDS level of the membrane permeate before and/or after the membrane permeate passes by or through the remineralization system. In some cases, the one or more TDS sensors may be provided in the form of ion-selective electrodes. The ion-selective electrodes may be designed to detect one or more ions in a water stream that may impact a measured TDS or alkalinity value. For example, the one or more TDS sensors may be provided in the form of an ion-selective electrode designed to detect calcium ions, an ion-selective electrode designed to detect magnesium ions, an ion-selective electrode designed to detect alkalinity values, and the like. Additionally, or alternatively, one or more pH sensors may be disposed proximate to, adjacent to, and/or in fluid communication with the remineralization system to monitor the pH level of the membrane permeate before and/or after the membrane permeate passes by or through the remineralization system. The one or more pH sensors may be fluidly coupled to a particular line and be positioned downstream of the remineralization system. For example, as shown in FIG. 1, a pH sensor 152 may be in fluid communication with the remineralization material positioned within the tank 118 (e.g., the solid block 150). Further, the system 100 may include one or more additional sensors adapted to measure a different quality or characteristic of the remineralized or prefiltered water.

In various instances of the system 100, after the permeate stream is provided to the remineralization system, the permeate stream may be imparted with a third concentration of solutes that is greater than the first concentration of solutes of the permeate stream. In some instances, the first concentration of solutes of the permeate stream may be less than 60 ppm, although the first concentration of solutes may be somewhat less or greater than these values. The remineralized membrane permeate that exits the remineralization system or that is created when the membrane permeate passes by or through the remineralization system may be imparted with a third concentration of at least about 50 ppm to at least about 500 ppm, or at least about 100 ppm to at least about 400 ppm. In some instances, the remineralized water may be imparted with a TDS concentration of at least about 50 ppm (or at least 50 ppm).

In other embodiments, the remineralized membrane permeate that exits the remineralization system or that is created when the membrane permeate passes by or through the remineralization system may be imparted with a third concentration of at least 50 ppm to at least 500 ppm, or at least 100 ppm to at least 400 ppm. In some instances, the remineralized membrane permeate that exits the remineralization system or that is created when the membrane permeate passes by or through the remineralization system may be imparted with a TDS concentration of less than 50 ppm or greater than 500 ppm.

In some embodiments, the remineralized membrane permeate may be imparted with a third concentration of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the remineralized membrane permeate may be imparted with a third concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In some instances, the system 100 may target a particular TDS value (a “target TDS value”) for the remineralized water stream by taking one or more actions. For example, the controller 194 may direct the opening or closing of one or more valves associated with a remineralization system, direct an amount of a remineralization material to be provided from a remineralization pump, and/or direct a predetermined amount of water to flow past a remineralization material. In various cases, the target TDS value may be imparted with a value of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more. In various instances, the target TDS value may be imparted with a value of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In further embodiments, the remineralized membrane permeate may be imparted with a pH value within drinkable limits (e.g., about 6.5 to about 10, or 6.5 to 10). In some embodiments, the remineralized membrane permeate may be imparted with a pH value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the remineralized membrane permeate may be imparted with a pH value of 6.5, or at least 6.5, or at least 6.6, or at least 6.7, or at least 6.8, or at least 6.9, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

In some instances, the system 100 may target a particular pH value (a “target pH value”) for the remineralized water stream by taking one or more actions. For example, the controller 194 may direct the opening or closing of one or more valves associated with a remineralization system and/or may direct a predetermined amount of water to flow past a remineralization material. In various cases, the target pH value may be imparted with a value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In various instances, the target pH value may be imparted with a value of 6.5, or at least 6.5, or at least 6.6, or at least 6.7, or at least 6.8, or at least 6.9, or at least 7, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

The water treatment system 100 may include and be in communication with a control system 190. The control system 190 may include the controller 194 and a display 196. As shown in FIG. 4, the controller 194 may be electronically connected to and may be in electronic communication with the display 196. The controller 194 also may be electronically connected to and may be in electronic communication with one or more of the water treatment system components including the one or more sensors (106a-106g, 114a-114d, 116a-116h, and 122), the first, second, or third valves (108, 140, and 142, respectively), the feeder 128, and/or the pump 130.

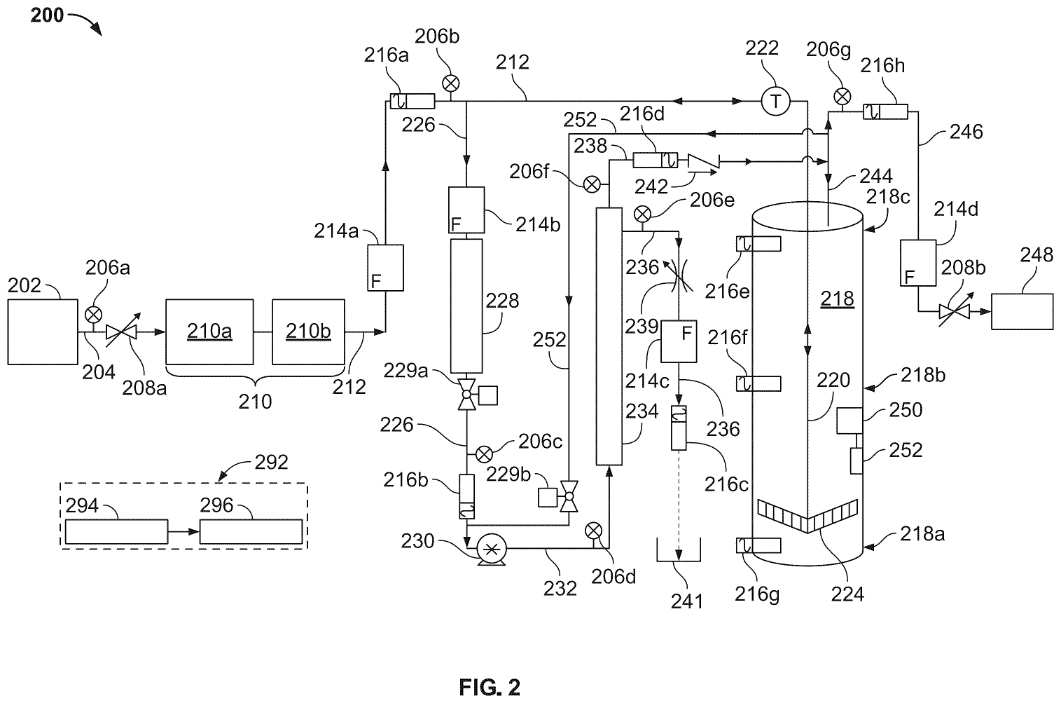

FIG. 2 illustrates another embodiment of a water treatment system 200. The water treatment system 200 may have the same types of system components as the water treatment system 100 of FIG. 1 (wherein similar components have like reference numbers) but may have fewer system components and/or system components in a different configuration than the water treatment system 100 of FIG. 1. In particular, the water treatment system 200 may further include a permeate flush line designed to recirculate membrane permeate to clean one or more membrane elements.

The water treatment system 200 may include an inlet 202 through which inlet water (e.g., hard water) may enter the water treatment system 200. The inlet water may pass through a prefiltration unit 210, where the inlet water may be filtered, and sediment or other contaminants are removed. The prefiltered water may flow into a tank 218 where the prefiltered water may be stored for future processing by a membrane element 234 of the water treatment system 200. The prefiltered water may also flow into and through the tank 218 to an outlet 248 of the water treatment system 200 for immediate use. Alternatively, or additionally, the prefiltered water may flow toward the membrane element 234 after passing through the prefiltration unit 210. As the prefiltered water flows toward the membrane element 234, the prefiltered water may pass a feeder 228, which may be designed to add a chemical additive to the prefiltered water. In some instances, the feeder 228 may be positioned elsewhere in the system 200 (e.g., downstream of the pump 230 or downstream of the membrane element 234). After passing the feeder 228, the prefiltered water may flow through the membrane element 234. A pump 230 located on a feed side of the membrane element 234 may be used to direct the prefiltered water toward the membrane element 234. The membrane element 234 may further filter the prefiltered water to remove hardness minerals and other impurities. The membrane filtered water may flow from the membrane element 234 to the tank 218 for storage or may flow directly out of the outlet 248 of the water treatment system 200 to a point of use.

Water with hardness minerals and other impurities that do not pass through the membrane element 234 may be discharged from the membrane element 234 via a retentate line 236.

The membrane filtered water stored in the tank 218 may also flow from the tank 218 toward an inlet side of the pump 230. The membrane filtered water may be directed toward the membrane element 234 via the pump 230 and may be used to clean the membrane element 234. Additionally, the water treatment system 200 may have one or more sensors (e.g., 206a-206g, 214a-214d, 216a-216h, 222) that may be disposed at various points in the water treatment system 200 to measure or monitor a characteristic of the water (e.g., pressure, flow rate, conductivity, total dissolved solids, etc.) and provide data to a controller 294. Furthermore, one or more valves or flow restrictor tubes (e.g., 208a, 208b, 229a, 229b, 239, 242) may be included at various points of the water treatment system 200 to control the flow of water into, through and out of the water treatment system 200.

Still referring to FIG. 2, the inlet 202 of the water treatment system 200 may be in fluid communication with an inlet line 204. The inlet water may be from an inlet water source (not shown). The inlet water source may be provided from a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 200 may include one or more pressure sensors 206. In some embodiments, the one or more pressure sensors 206 may be defined by a gauge pressure transmitter, a differential pressure transmitter, an absolute pressure transmitter, a multivariate pressure transmitter, or a submersible pressure transmitter.

A first pressure sensor 206a may be in fluid communication with the inlet line 204. The first pressure sensor 206a may measure, monitor, or sense the pressure of the inlet water in the inlet line 204.

The water treatment system 200 may include a first valve 208a. The first valve 208a may be in fluid communication with the inlet line 204. In some instances, the first valve 208 may be positioned upstream of the pressure sensor 206a, although the first valve 208 may be positioned downstream of the pressure sensor 206a. In some embodiments, the first valve 208a may be a gate valve. In some embodiments, the first valve 208a may be a bypass valve, a solenoid valve, a butterfly valve, a ball valve, a globe valve, a pressure relief valve, or a check valve.

The first valve 208a may control or regulate the amount of inlet water entering the water treatment system 200. The first valve 208a may open, either partially or fully, to enable the flow or increase the amount of inlet water entering the water treatment system 200 through the inlet 202. The first valve 208a may close, either partially or fully, to stop or decrease the flow or amount of inlet water entering the water treatment system 200. In addition, in some embodiments, the water treatment system 200 may be provided with a manual bypass valve (not illustrated) that may be configured to decrease, substantially stop, or completely stop the flow of inlet water into the water treatment system 200. The amount of inlet water entering the water treatment system 200 may increase or decrease the water pressure in the water treatment system 200.

The water treatment system 200 may include the prefiltration unit 210. The prefiltration unit 210 may be provided in the form of one or more prefilter elements having one or more filter media. The prefiltration unit 210 may include a first prefilter element 210a and a second prefilter element 210b. The first prefilter element 210a may be in fluid communication with the inlet line 204 and the second prefilter element 210b. The second prefilter element 210b may be in fluid communication with the first prefilter element 210a and a prefiltered water line 212. Alternatively, the second prefilter element 210b may be in fluid communication with the inlet line 204 and the first prefilter element 210a, and the first prefilter element 210a may be in fluid communication with the second prefilter element 210b and the prefiltered water line 212.

Inlet water may enter the prefiltration unit 210 via the inlet line 204 and exit the prefiltration unit 210 via the prefiltered water line 212. When inlet water passes through the prefiltration unit 210, the prefiltration unit 210, via the first prefilter element 210a and the second prefilter element 210b, may remove sediment, particulates, certain chemicals and other contaminants from the inlet water, producing a prefiltered water that may flow out of the prefiltration unit 210 via the prefiltered water line 212.

In some embodiments, the first prefilter element 210a may be provided in the form of a sediment filter. The sediment filter may remove sediments, such as sand, silt, dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, the second prefilter element 210b may be provided in the form of an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 210 may provide prefiltered water that may have substantially no odor and have an improved taste compared to the inlet water. In addition, by removing sediment, chlorine, chloramine, and other contaminants, the prefiltration unit 210 may protect the downstream membrane element 234 from sediment fouling or oxidation.

In some embodiments, the prefiltration unit 210 may be defined by a series of prefilter elements (e.g., two or more sediment filters) or may be comprised of a combination of prefilter elements (e.g., one or more sediment filters and one or more activated carbon filters). One ordinary skilled in the art would understand that the one or more prefilter elements that comprise the prefiltration unit 210 may be retained within a single prefiltration element or may be separate and distinct prefilter elements (as shown in FIG. 2) that are in fluid communication with one another. In some embodiments, the prefiltration unit 210 may be a PENTAIR® EVERPURE® filter. In other embodiments, the prefiltration unit 210 may be a PENTAIR® PENTEK® BIG BLUE® filter.

The water treatment system 200 may include one or more flowmeters 214. In some embodiments, the one or more flowmeters 214 may be provided as a mechanical flowmeter or an ultrasonic flowmeter. In some embodiments, the one or more flowmeters may include a ⅜ inch (0.95 centimeters) F-nut inflow connector, a ⅜ inch (0.95 centimeters) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 214 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 214a-214d may be the same type of flowmeter or may each be a different type of flowmeter.

A first flowmeter 214a may be positioned within or otherwise in fluid communication with the prefiltered water line 212. The first flowmeter 214a may measure, monitor, or sense the flow rate of the prefiltered water through the prefiltered water line 212.

The water treatment system 200 may include one or more TDS sensors 216. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about ±10% Full Scale (25° C.). In some embodiments, the one or more TDS sensors 216 may be a TDS sensor having a TDS measurement range of at least about 0 to about 3000 ppm or greater than about 3000 ppm. One of ordinary skill in the art would understand that each of the one or more TDS sensors 216a-216h may be the same type of TDS sensor or may each be a different type of TDS sensor.

A first TDS sensor 216a may be in fluid communication with the prefiltered water line 212. The first TDS sensor 216a may measure, monitor, or sense the conductivity of the prefiltered water to determine the concentration or amount of dissolved solids in the prefiltered water.

The water treatment system 200 may include a second pressure sensor 206b that may be in fluid communication with the prefiltered water line 212. The second pressure sensor 206b may measure, monitor, or sense the pressure of the prefiltered water in the prefiltered water line 212.

The water treatment system 200 may include a temperature sensor 222 that may be in fluid communication with the prefiltered water line 212. The temperature sensor 222 may be designed to measure, monitor, or sense the temperature of the prefiltered water. In some embodiments, the temperature sensor 222 may be thermistor, a thermocouple, a semiconducting material, and any other mechanical or electronic sensor that may respond to a change in temperature. In some embodiments, additional temperature sensors may be included in the water treatment system 200. For example, an additional temperature sensor may be optionally placed on or within the inlet line 204.

The water treatment system 200 may include the tank 218. The tank 218 may be used to store water. The tank 218 may be defined by a housing having a bottom portion 218a, a center portion 218b, and a top portion 218c. In some instances, each of the portions 218a, 218b, 218c may be separated by a physical barrier (e.g., if the tank 218 is provided as a bladder tank), although in preferred embodiments no physical barrier is positioned between the portions 218a, 218b, 218c. In some embodiments, the tank 218 may be a flow through tank, which may allow for the seamless delivery of water to a point of use (POU). In some embodiments, the tank 218 may be a pressurized tank. In some embodiments, the tank 218 may be a fiberglass reinforced plastic (FRP) tank. In some embodiments, the tank 218 may range in size from about 24 gallons (91 liters) to about 200 gallons (757 liters). In other embodiments, multiple tanks 218 of any size may be connected in series. In further embodiments, existing water vessels within the residential or commercial property (e.g., a water heater) may be used for additional storage capacity.

The tank 218 may include a riser tube 220 that extends vertically from the bottom portion 218a of the tank 218 to the top portion 218c of the tank 218, or vice versa. The riser tube 220 may be in fluid communication with the prefiltered water line 212. In some embodiments, the riser tube 220 may be provided as PVC tubing.

The tank 218 may further include a flow distributor 224, which may be attached or coupled to the riser tube 220. The flow distributor 224 may prevent or reduce the mixing of higher TDS water that may be stored in the bottom portion 218a of the tank 218 with lower TDS water that may be stored in the top portion 218c of the tank 218. In some embodiments, the flow distributor 224 may be a dome flow distributor. In some embodiments, multiple flow distributors 224 may be used.

Additionally, or alternatively, the tank 218 may include baffles and external plumbing (e.g., flow distributors) to reduce the mixing of higher TDS water that may be stored in the bottom portion 218a of the tank 218 with lower TDS water that may be stored in the top portion 218c of the tank 218.

In some embodiments, the high TDS water may be added to the bottom portion 218a of the tank 218, and the low TDS water may be added to the top portion 218c of the tank 218. Advantageously, adding the high TDS water and the low TDS water to the tank 218 in this manner may help maintain the separation between the high TDS water and the low TDS water in the tank 218, which in turn may help ensure that low TDS water is provided to a point of use during operation of the tank 218.

The water treatment system 200 may include an additive line 226. The additive line 226 may be physically connected to or otherwise in fluid communication with the prefiltered water line 212.

A second flowmeter 214b may be positioned within or otherwise in fluid communication with the additive line 226. The second flowmeter 214b may measure, monitor, or sense the flow rate of the prefiltered water through the additive line 226.

The prefiltered water may have a fluid flow path through the water treatment system 200. In some embodiments, depending on the flow conditions when the water treatment system 200 is in use, the prefiltered water may flow in different directions, as described in more detail below (see, e.g., FIG. 7). For example, during some flow conditions, the prefiltered water may flow directly from the prefiltration unit 210 through the prefiltered water line 212, down the riser tube 220, and into the bottom portion 218a of the tank 218. The prefiltered water may be stored in the tank 218. During other flow conditions, the prefiltered water may also flow from the prefiltration unit 210 via the prefiltered water line 212 toward the membrane element 234 via the additive line 226. During further flow conditions, the prefiltered water may flow from the bottom portion 218a of the tank 218, up the riser tube 220, and through the prefiltered water line 212 toward the membrane element 134 via the additive line 226.

The water treatment system 200 may include the feeder 228 that is in fluid communication with the additive line 226. The feeder 228 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate.

In some embodiments, when the prefiltered water flows through or passes the feeder 228, the chemical additive may be added or introduced to the prefiltered water. The chemical additive may dissolve or otherwise degrade in the prefiltered water. In some embodiments, as further detailed herein, the feeder 228 may impart the water flowing through the feeder 228 with a chemical additive concentration of at least 0.01 ppm to at least 10 ppm, or 0.01 ppm to 10 ppm. In other embodiments, the feeder 228 may impart the water flowing through the feeder 228 with a chemical additive concentration of less than 0.01 ppm or greater than 10 ppm of the chemical additive.

The water treatment system 200 may include a second valve 229a. The second valve 229a may be in fluid communication with the additive line 226. In some embodiments, the second valve 229a may be an actuated ball valve. In some embodiments, the second valve 229a may be a gate valve, a butterfly valve, a globe valve, a pressure relief valve, or a check valve. In some embodiments, the second valve 229a may be positioned upstream of the feeder 228 or downstream of the pump 230.

The second valve 229a may be used to control or regulate the amount of prefiltered water (with or without additive) flowing through the additive line 226. The second valve 229a may open, either partially or fully, to enable the flow or increase the amount of prefiltered water (with or without additive) flowing through the additive line 226 toward the pump 230. The second valve 229a may close, either partially or fully, to stop or decrease the flow or amount of prefiltered water (with or without additive) flowing through the additive line 226 toward the pump 230.

The water treatment system 200 may include a third pressure sensor 206c that may be in fluid communication with the additive line 226. The third pressure sensor 206c may measure, monitor, or sense the pressure of the prefiltered water with additive in the additive line 226. Alternatively, if a chemical additive is not added by the feeder 228, the third pressure sensor 206c may measure, monitor, or sense the pressure of the prefiltered water in the additive line 226.

The water treatment system 200 may include a second TDS sensor 216b. The second TDS sensor 216b may be in fluid communication with the additive line 226. The second TDS sensor 216b may measure, monitor, or sense the conductivity of the prefiltered water (with or without additive) to determine an amount or concentration of dissolved solids in the prefiltered water (with or without additive). The prefiltered water with additive may have a higher TDS than the prefiltered water without additive.

The water treatment system 200 may include the pump 230. An inlet side (not shown) of the pump 230 may be in fluid communication with the additive line 226, and an outlet side (not shown) of the pump 230 may be in fluid communication with a membrane feed line 232. In some embodiments, the pump 230 may be a single-phase booster pump. For example, the pump 230 may be a PENTAIR® STA-RITE™ single phase 115 volt, ¾ horsepower pump. In some embodiments, the pump 230 may be a multi-phase booster pump. In some embodiments, the pump 230 may boost differential pressure in the membrane feed line 232 to 120-250 pounds per square inch (827-1725 kilopascals) at a flow rate of 1.0-7.0 gallons per minute (3.5-26 liters per minute) or at a preferable flow rate of 2.0-5.0 gallons per minute (7.5-19 liters per minute).

The membrane feed line 232 may be in fluid communication with a fourth pressure sensor 206d. The fourth pressure sensor 206d may measure, monitor, or sense the pressure of the prefiltered water (with or without additive) in the membrane feed line 232.

The water treatment system 200 may include the membrane element 234. In some embodiments, the membrane element 234 may be a reverse osmosis (RO) membrane. In some embodiments, the RO membrane may be spiral wound and may include feed spacers imparted with a certain thickness and/or structure. In some embodiments, the RO membrane may be a spiral wound RO membrane (e.g., a spiral wound 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 234 may be a nanofiltration (NF) membrane, an ultrafiltration (UF) membrane, a microfiltration (MF) membrane, or a particulate membrane. In some embodiments, the membrane element 234 may be a hollow fiber NF membrane. In other embodiments, the membrane element 234 may be an electrodialysis membrane system.

In some embodiments, the membrane element 234 may comprise a combination of one or more of an RO membrane, an NF membrane, a UF membrane, an MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

In further embodiments, the membrane element 234 may include two or more RO membranes, NF membranes, UF membranes, MF membranes, particulate membranes, and/or electrodialysis membranes, which may be disposed in parallel or in series. In some embodiments, the membrane element 234 may be a series of membranes of the same type (e.g., two or more RO membranes) but of a different size. For example, the membrane element 234 may include a first membrane imparted with a first diameter and a second membrane imparted with a second diameter that is different from the first diameter (e.g., the second diameter may be less than the first diameter). In some embodiments, the first membrane may be a spiral wound 4040 RO membrane, and the second membrane may be a spiral wound 2540 RO membrane. The two or more membranes may be contained within a single housing, in separate housings (e.g., as shown in FIG. 4D), or a combination thereof.

Varying the membrane type and/or size may be used to optimize the level of permeate production, allowing for enhanced water recovery, while at the same time balancing factors such as a particular permeate water chemistry and membrane health. For example, in some embodiments, including at least one NF membrane as a first or second membrane in a series may allow for higher total permeate output as compared to utilizing two RO membranes. In other embodiments, including two or more RO membranes in series, for example, may help maintain a higher velocity on the feed side of the individual membranes, which in turn may reduce ion concentration at the membrane surface of each membrane. In addition, including two or more RO membranes in series may enable the operation of the individual RO membranes at different membrane recoveries, which may help optimize permeate production as dissolved mineral content increases.

In further embodiments, using a smaller membrane as a second membrane in a series of membranes, where the first membrane has a larger diameter than the diameter of the second membrane, may allow the water entering the second membrane to have a higher velocity, which may boost overall water recovery. For instance, in some embodiments, if the water treatment system 200 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 200 may be increased to at least about a 94% recovery.

The membrane element 234 may be in fluid communication with the membrane feed line 232 on a feed side (not shown) of the membrane element 234. The membrane element 234 also may be in fluid communication with the retentate line 236 on the feed side of the membrane element 234. The membrane element 234 may be in fluid communication with a membrane permeate line 238 on a permeate side (not shown) of the membrane element 234.

In some embodiments, as the prefiltered water (with or without additive) enters the feed side of the membrane element 234, the membrane element 234 may allow a solvent (e.g., water) in the prefiltered water to pass through a surface of a membrane (not shown) retained within the membrane element 234. The solvent that passes through the surface of the membrane may exit from the permeate side of the membrane element 234 as membrane permeate via the membrane permeate line 238. Solutes (e.g., dissolved minerals and ions and various organic compounds) in the prefiltered water may not pass through the membrane and may be retained at the surface of the membrane. The solutes may be discharged from the feed side of the membrane element 234 as retentate via the retentate line 236.

In some embodiments, when the pump 230 is activated, the pump 230 may increase the rate at which water flows into the membrane feed line 232 toward the membrane element 234. Increasing the flow rate of water into the membrane feed line 232 may increase pressure in the membrane feed line 232. The increased pressure in turn may aid in pushing solvent in the membrane feed line 232 through the pores formed within the surface of the membrane retained within the membrane element 234.

The water treatment system 200 may include a fifth pressure sensor 206e that may be in fluid communication with the retentate line 236. The fifth pressure sensor 206e may measure, monitor, or sense the pressure of the retentate in the retentate line 236.

The water treatment system 200 may include a flow restrictor tube 239 that may be in fluid communication with the retentate line 236. The flow restrictor tube 239 may be used to control or regulate the amount of retentate leaving the water treatment system 200 via the retentate line 236 into a drain 241. In some embodiments, the flow restrictor tube 239 may be a capillary tube imparted with an inner diameter of at least about 1/16 inches (at least about 1.6 mm) to no more than about ⅛ inches (no more than about 3.2 mm). In some embodiments, the flow restrictor tube 239 may be imparted with a length of at least about 1 inch (at least about 2.5 centimeters) to at least about 4 feet (at least about 122 cm). For example, the flow restrictor tube 239 may be imparted with a length of no less than 1 foot (30.5 centimeters) and no more than 3 feet (91.4 centimeters). In some embodiments, the flow restrictor tube 239 may be provided in the form of material that has a low energy surface to prevent the formation of scale on the surface of the flow restrictor tube 239, given that retentate may be beyond the saturation limit of the water. For example, the flow restrictor tube 239 may be made from polyethylene tubing. In further embodiments, a valve may be used instead of or in combination with the flow restrictor tube 239. The amount of retentate exiting the water treatment system 200 into the drain 241 may increase or decrease the water pressure in the water treatment system 200.

The water treatment system 200 may include a third flowmeter 214c. The third flowmeter 214c may be positioned within or otherwise in fluid communication with the retentate line 236. The third flowmeter may measure, monitor, or sense the flow rate of the retentate in the retentate line 236.

The water treatment system 200 may include a third TDS sensor 216c that may be in fluid communication with the retentate line 236 and the drain 241. The third TDS sensor 216c may measure, monitor, or sense the conductivity of the retentate to determine an amount or concentration of dissolved solids in the retentate.

The water treatment system 200 may include a sixth pressure sensor 206f that may be in fluid communication with the membrane permeate line 238. The sixth pressure sensor 206f may measure, monitor, or sense the pressure of the membrane permeate in the membrane permeate line 238.

The water treatment system 200 may include a fourth TDS sensor 216d that may be in fluid communication with the membrane permeate line 238. The fourth TDS sensor 216d may measure, monitor, or sense the conductivity of the membrane permeate to determine an amount or concentration of dissolved solids in the membrane permeate.

The membrane permeate line 238 may be connected to or otherwise in fluid communication with a tank line 244. The tank line 244 may be in fluid communication with the top portion 218c of the tank 218. The tank line 244 also may be connected to or otherwise in fluid communication with an outlet feed line 246. The outlet feed line 246 may be in fluid communication with the outlet 248 of the water treatment system 200.

In some embodiments, depending on the flow conditions when the water treatment system 200 is in use, the membrane permeate may flow from the permeate side of the membrane element 234 through the membrane permeate line 238 and the tank line 244 into the top portion 218c of the tank 218. The membrane permeate may be stored in the tank 218. The membrane permeate may also flow from the permeate side of the membrane element 234 through the membrane permeate line 238 to the tank line 244, into the outlet feed line 246 (thereby bypassing the tank 218), and out of the outlet 248. By enabling the flow of membrane permeate from the membrane element 234 directly to the outlet 248, membrane permeate may be provided to a point of use in real time.

Due to the amount of dissolved ions in high TDS water, high TDS water tends to have a higher density than low TDS water. By sending higher TDS water (e.g., the prefiltered water) to the bottom portion 218a of the tank 218 and lower TDS water (e.g., the membrane permeate) to the top portion 218c of the tank 218, the chances of water with different TDS amounts or concentrations mixing inside the tank 218 may be minimized. Thus, when water is later drawn from the top portion 218c of the tank 218, low TDS water may be provided to the point of use. Sending higher TDS water to the bottom of the tank 218 and lower TDS water to the top of the tank 218 may also create a sharp TDS profile along the vertical height of the tank 218, where the amount or concentration of TDS at the bottom portion 218a of the tank 218 is the highest (e.g., a TDS concentration of more than or about 3.5 grains per gallon (60 milligrams per liter)), and the amount or concentration of TDS at the top portion 218c of the tank 218 is the lowest (e.g., a TDS concentration of less than or about 3.5 grains per gallon (60 milligrams per liter)). Creating and maintaining this sharp TDS profile msy be aided by the density difference between the high TDS water and the low TDS water.

The water treatment system 200 may include a third valve 242 that may be in fluid communication with the membrane permeate line 238. In some embodiments, the third valve 242 may be a check valve. In some embodiments, the third valve may be a butterfly valve, a ball valve, a globe valve, a pressure relief valve, or a gate valve.

The third valve 242 may be used to control or regulate the amount of membrane permeate entering or flowing through the membrane permeate line 238 into the tank line 244 and into the top portion 218c of the tank 218 or out of the outlet 248 via the outlet feed line 246. The third valve 242 may open, either partially or fully, to enable or increase the flow or the amount of membrane permeate flowing through the membrane permeate line 238 to the tank line 244, and into the top portion 218c of the tank 218 or into the outlet feed line 246 and out of the outlet 248. The third valve 242 may close, either partially or fully, to stop or decrease the amount of membrane permeate flowing through the membrane permeate line 238 and the tank line 244, into the top portion 218c of the tank 218 or into the outlet feed line 246 and out of the outlet 248. The amount of membrane permeate entering or flowing through the membrane permeate line 238 and into the tank 218 or out of the outlet 248 may increase or decrease the water pressure in the water treatment system 200. In some instances, the third valve 242 may be a check valve that is used to prevent backflow through the tank line 244, which in turn may help protect the membrane element 234.

In some embodiments, the tank 218 may include a fifth TDS sensor 216e disposed in the top portion 218c, a sixth TDS sensor 216f disposed in the center portion 218b of the tank 218, and/or a seventh TDS sensor 216g disposed in the bottom portion 218a of the tank 218. The fifth TDS sensor 216e may measure, monitor, or sense the conductivity of the water in the top portion 218c of the tank 218 to determine an amount or concentration of dissolved solids in the water located in the top portion 218c of the tank 218. The sixth TDS sensor 216f may measure, monitor, or sense the conductivity of the water in the center portion 218b of the tank 218 to determine an amount or concentration of dissolved solids in the water located in the center portion 218b of the tank 218. The seventh TDS sensor 216g may measure, monitor, or sense the conductivity of the water in the bottom portion 218a of the tank 218 to determine an amount or concentration of dissolved solids in the water located in the bottom portion 218a of the tank 218. The fifth, sixth, and seventh TDS sensors (216e, 216f, and 216g, respectively) may create a profile of the TDS levels or concentrations of the water in the tank 218.

In some embodiments, the tank 218 may include zero, one, two, or more TDS sensors disposed in each of the top, center, or bottom portions of the tank 218. For example, in some embodiments, a TDS sensor may only be disposed in the center portion 218b of the tank, not the top portion 218c or the bottom portion 218a. In other embodiments, a TDS sensor may be disposed in each of the top portion 218c and the bottom portion 218a of the tank 218, but not the center portion 218b. In further embodiments, zero TDS sensors may be disposed in the tank 218.

The water (i.e., membrane permeate (lower TDS water) or the prefiltered water (higher TDS water)) that may be stored in the tank 218 may flow through the tank line 244 and the outlet feed line 246 out of the outlet 248. The outlet 248 may be in fluid communication with various appliances, fixtures, and plumbing of the residential or commercial property. In some embodiments, the outlet 248 may be in fluid communication with a water heater, faucets, fixtures, or toilets via one or more pipes or tubes.

The water treatment system 200 may include a seventh pressure sensor 206g in communication with the outlet feed line 246. The seventh pressure sensor 206g may measure, monitor, or sense the pressure of the water in the outlet feed line 246.

The water treatment system 200 may include an eighth TDS sensor 216h in communication with the outlet feed line 246. The eighth TDS sensor 216h may measure, monitor, or sense the conductivity of the water in the outlet feed line 246 to determine an amount or concentration of the dissolved solids in the water in the outlet feed line 246.

The water treatment system 200 may include a fourth flowmeter 214d may be positioned within or otherwise in communication with the outlet feed line 246. The fourth flowmeter 214d may measure, monitor, or sense the flow rate of the water in the outlet feed line 246.

The water treatment system 200 may include a fourth valve 208b that may be in fluid communication with the outlet feed line 246. In some embodiments, the fourth valve 208b may be a gate valve. In some embodiments, the fourth valve 208b may be a bypass valve, a solenoid valve, a butterfly valve, a ball valve, a globe valve, a pressure relief valve, or a check valve.

The fourth valve 208b may be used to control or regulate the amount of water (e.g., membrane permeate or prefiltered water) flowing from the tank 218, through the tank line 244, into the outlet feed line 246, and out of the outlet 248 or from the membrane element 234, through the tank line 244, into the outlet feed line 246, and out of the outlet 248. The fourth valve 208b may open, either partially or fully, to enable or increase the flow or the amount of water from the tank 218 or the membrane element 234, through the tank line 244, into the outlet feed line 246, and out of the outlet 248. The fourth valve 208b may close, either partially or fully, to stop or decrease the amount of water flowing from the tank 218 or the membrane element 234, through the tank line 244, into the outlet feed line 246 and out of the outlet 248. The amount of water flowing through the outlet feed line 246 and out of the outlet 248 may increase or decrease the water pressure in the water treatment system 200.

Preferably, the first valve 208a and the fourth valve 208b are provided as on/off valves that may substantially or completely stop the flow of water through the system 200. In such embodiments, the first valve 208a and the fourth valve 208b may be provided as ball valves, solenoid valves, or other similarly functioning valves.

The water treatment system 200 may include a permeate flush line 252. The permeate flush line 252 may be physically connected to or otherwise in fluid communication with the tank line 244 and the additive line 226. In some embodiments, the permeate flush line 252 may be physically connected to or otherwise in fluid communication with the tank line 244 and the pump 230. In some embodiments, the permeate flush line 252 may be connected or coupled to any conduit of the water treatment system 200 that is downstream of the second valve 229a (e.g., the membrane feed line 232).

The water treatment system 200 may include a fifth valve 229b that may be in fluid communication with the permeate flush line 252. In some embodiments, the fifth valve 229b may be an actuated ball valve. In some embodiments, the fifth valve 229b may be a gate valve, a butterfly valve, a globe valve, a pressure relief valve, or a check valve.

The fifth valve 229b may be used to control or regulate the amount of membrane permeate entering or flowing through the permeate flush line 252 from the tank line 244 and into the membrane feed line 232 and, eventually, to the retentate line 236 via the membrane element 234. The fifth valve 229b may open, either partially or fully, to enable or increase the flow or the amount of membrane permeate flowing from the top portion 218c of the tank 218, into the tank line 244, through the permeate flush line 252, and into the membrane feed line 232 and the retentate line 236 via the membrane element 234. The fifth valve 229b may close, either partially or fully, to stop or decrease the amount of membrane permeate flowing from the top portion 218c of the tank 218, into the tank line 244, through the permeate flush line 252, and into the membrane feed line 232 and the retentate line 236 via the membrane element 234. The amount of membrane permeate entering or flowing through the permeate flush line 252 to the membrane feed line 232 and the retentate line 236 via the membrane element 234 may increase or decrease the water pressure in the water treatment system 200.

In some embodiments, depending on flow conditions, when the water treatment system 200 is in use, membrane permeate from the top portion 218c of the tank 218 may flow through the tank line 244 and the permeate flush line 252 into the membrane feed line 232 toward the membrane element 234. The membrane permeate may be recirculated through the membrane feed line 232 and into the feed side of the membrane element 234. The recirculation of the membrane permeate through the membrane feed line 232 may be aided by the pump 230 when activated or may be caused by pressure within the water treatment system 200 when the pump 230 is turned off. The membrane permeate may be used to clean the membrane element 234 by flushing solutes (e.g., ions) from the surface of the membrane element 234. The membrane permeate used to clean or flush the surface of the membrane element 234 may then be discharged through the retentate line 236.

In some embodiments, the second valve 229a may be closed and the fifth valve 229b may be opened. In such instances, the pump 230 may be activated such that membrane permeate from the membrane element 234 may flow directly from the membrane element 234 to the permeate flush line 252, through the membrane feed line 232 and into the membrane element 234 to clean or flush the surface of the membrane element 234.

The water treatment system 200 may include an optional remineralization system (such as the remineralization system 380 of FIG. 4) containing a remineralization material. The remineralization material may be provided as a calcium-containing compound or a magnesium-containing compound, although other ionic compounds could also be used to increase the mineral or TDS concentration of the water provided by the system 200 to a point of use. The remineralization material may be, for example, a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In each example, the remineralization material may be provided in the form of a solid, an aqueous solution, a combination of solids (e.g., if more than one remineralization material is provided), and a combination of aqueous solutions (e.g., if more than one remineralization material is provided). In some instances, the remineralization compound may be selected from the group consisting of a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In instances where the remineralization material includes a calcium carbonate compound, the calcium carbonate may be provided in the form of calcite. In some instances, the remineralization material as described herein may be provided in the form of a solid, such as a solid block or a powder, or as an aqueous solution.

In some embodiments, the system 200 may include a remineralization system. In some embodiments of the remineralization system, the remineralization material may be contained in a device including an inlet and an outlet through which water passes. For example, the remineralization system may include a reservoir (see, e.g., the remineralization unit or reservoir 380a in FIG. 4A) designed to store the remineralization material. In some cases, the reservoir and/or the remineralization material may be replaced when the remineralization material is depleted. In some embodiments, the reservoir may be provided in the form of a bed or cartridge. The reservoir may be disposed on a line (e.g., the outlet feed line 246) or another system component of the water treatment system 200, which water passes by but does not flow through. In other embodiments, the remineralization system may be provided as a remineralization system including cementitious material designed to remineralize a water stream.

In some instances, the reservoir may take the form of a cylinder, although in other embodiments the reservoir may be provided in the form of a different three-dimensional shape (e.g., as a cube, rectangular prism, pyramid, cone, etc.). In some embodiments, the reservoir may include one or more end caps, such as a first end cap coupled to a first end of the reservoir, and a second end cap coupled to a second end of the reservoir that is opposite the first end. In such instances, the first end cap may define the inlet of the reservoir and thus define a flow path for incoming nonmineralized water. Remineralized water may exit the reservoir via an outlet provided in the second end cap.

In some embodiments, at least one of the first end cap and the second end cap may be integrally formed with and thus irremovable from the reservoir. In such instances, upon depletion of the remineralization material, the reservoir may need to be replaced with a new reservoir containing a fresh source of remineralization material, whether in a powder, a block, or an aqueous form. In other instances, the reservoir may be removable from one or more of the end caps and may thereby be removed upon depletion of the remineralization material. In such instances, the reservoir may be refilled with a fresh stock of the powder, the block, or the aqueous form of the remineralization material and reused in the remineralization system.

In some embodiments, the reservoir may include one or more internal sensors for detecting a filled volume, an amount of remineralization material, and/or a water level of the reservoir. In some cases, the remineralization system may include one or more external sensors designed to determine when the remineralization material has been depleted. In such cases, the determination may be based on whether the TDS value of the remineralized water stream or the solution provided from the remineralization system is at or above a threshold TDS value. The one or more sensors (whether internal or external of the remineralization system) may be in electronic communication with the controller 294 and indicate when the reservoir may need to be refilled and/or replaced. For example, in some instances, the one or more sensors may be set to produce an alert or notification when at least about 80% of the remineralization material has been depleted. In other instances, the one or more sensors may be set to produce an alert or notification when about at least 20%, or at least about 25%, or at least about 30%, or at least about 40%, or at least about 45%, or at least about 50%, or at least about 60%, or at least about 70%, or at least about 75%, or at least about 85%, or at least about 90%, or at least about 95%, or at least about 99% of the remineralization material has been depleted. In yet other instances, the one or more sensors may be set to produce an alert or notification when at least 20%, or at least 25%, or at least 30%, or at least 40%, or at least 45%, or at least 50%, or at least 60%, or at least 70%, or at least 75%, or at least 80%, or at least 85%, or at least 90%, or at least 95%, or at least 99% of the remineralization material has been depleted.

The remineralization inlet may be configured to place the reservoir of the remineralization system in fluid communication with the line to which the remineralization system is coupled. In general, the remineralization system may be configured to place the entering water stream in contact with the remineralization material to generate a remineralized water stream (also referred to as a “remineralized stream”) that discharges from the remineralization system through the remineralization outlet. The remineralized stream may thus include a TDS content that is greater than the permeate stream. As the permeate stream contacts and/or flows through the remineralization material, the remineralization material may be designed to degrade or dissolve within the remineralization system over time, resulting in a remineralized stream enriched in minerals and additives.

The remineralization system may generally be disposed on or coupled to various system components or lines of the system 200 that are positioned downstream of the membrane element 234. In some embodiments, the remineralization system may be disposed on or coupled to the outlet feed line 246 upstream of the outlet 248. The remineralization system may introduce the remineralization material to the membrane permeate before the membrane permeate exits the water treatment system 200 via the outlet 248. In some embodiments, the remineralization system may be disposed on the membrane permeate line 238 or the tank line 244. For example, the remineralization system may be disposed on the membrane permeate line 238 or the tank line 244 so that the membrane permeate is introduced to the remineralization material before the membrane permeate flows into the top portion 218c of the tank 218.

In other embodiments, the remineralization system may be disposed within the top portion 218c of the tank 218 so that the membrane permeate is introduced to the remineralization material as the membrane permeate flows into or out of the top portion 218c of the tank 218. In further embodiments, the remineralization system may be disposed within a top portion 218c of the tank 218 so that the membrane permeate contacts the remineralization material in the remineralization system while the membrane permeate is stored in the tank 218, including during periods when there is no flow of membrane permeate into or out of the tank 218. In such instances, the remineralization system may be disposed within the top portion 218c of the tank 218 by coupling the reservoir to an internal surface of the tank 218. In addition, the reservoir may be removably or irremovably coupled to the internal surface using one or more direct attachment means (such as welding of the reservoir to the internal surface) or indirect attachment means (such as with use of a mounting bracket).

In embodiments where the remineralization material is provided as a solid block 250 (e.g., as a block of calcite), the remineralization material may be coupled to one of the lines or another system component of the water treatment system 200 without an outer reservoir or cartridge. The solid block 250 may be disposed within the tank 218 via coupling to an internal surface of the tank 218 using one or more indirect attachment means (i.e., a mounting bracket or holding mechanism). In such instances, water may be directed to pass through or proximate to the remineralization material upon entering the tank 218, increasing the contact time between the water and remineralization material (e.g., during no flow situations). Furthermore, removing the cartridge surrounding the remineralization material may additionally contribute to reducing the overall footprint of the system 200. While the remineralization material is provided proximate to the center portion 218b of the tank 218 in FIG. 2, it is to be understood that the remineralization material may be positioned in any portion of the tank 218 (e.g., the bottom portion 218a of the tank 218, the center portion 218b of the tank 218, the top portion 218c of the tank) when the remineralization material is provided as the solid block 250. In addition, the remineralization material may be provided in the tank 218 without the use of a coupling means when the remineralization material is provided as the solid block 250. Furthermore, the solid block 250 of the remineralization material may be provided in any shape, including regular three-dimensional shapes (e.g., a cube, a rectangular prism) and irregular three-dimensional shapes.

In embodiments where the remineralization material is provided as an aqueous solution, the remineralization system may be coupled to one of the lines or another system component of the water treatment system 200. In addition, the remineralization system may be in fluid communication with a remineralization pump and/or a dosing mechanism designed to dose the remineralization material (e.g., a mineral solution) to the permeate water. For example, in some cases, as illustrated with reference to FIG. 4A, the remineralization system may be positioned in-line with an outlet feed line (e.g., the outlet feed line 246). The outlet feed line may be designed to deliver remineralized water to the outlet 248 of the system 200. In other cases, as further described with reference to FIG. 4F, the remineralization pump may dose water with the remineralization material to a specified mixing point positioned on the outlet feed line 246. In some instances, the remineralization pump may be designed to add specific concentrations and/or amounts of the remineralization material (e.g., in the form of aqueous solutions) to the permeate water. In some instances, the system 200 may include a bypass conduit that routes at least a portion of the permeate water around the remineralization system.

In some embodiments, the remineralization pump may be a single-phase or a multi-phase booster pump. In other embodiments, the remineralization pump may be defined by a diaphragm pump, a peristaltic pump, a piston pump, or a solenoid-driven pump. The pump may be in electronic communication with the controller 294 and may be actuated upon receipt of a command from the controller 294.

In some instances, sodium bicarbonate (or another remineralization material including, but not limited to, a calcium chloride compound, a magnesium chloride compound, a sodium chloride compound, a potassium chloride compound, a magnesium citrate compound, a sodium hydroxide compound, a potassium hydroxide compound, a calcium sulfate compound, a magnesium sulfate compound, a calcium carbonate compound, a magnesium carbonate compound, a magnesium oxide compound, a calcium oxide compound, and dolomite) may be added via the remineralization system to the permeate water before, after, and/or when the system is processing water through the membrane element 234. In other instances, the remineralization system may be provided as or include a blend back valve (see, e.g., blend back valve 380c in FIG. 4A) that may provide an amount of prefiltered water to the permeate stream to achieve a target TDS value, a target alkalinity value, and/or a target pH value based on the characteristics of the feed water. In one non-limiting case, the blend back valve may be positioned between an additive line (see, e.g., the additive line 326 in FIG. 4A) and an outlet feed line (see, e.g., the outlet feed line 346 in FIG. 4A). In another non-limiting case, the blend back valve may be positioned between a membrane feed line (see, e.g., the membrane feed line 332 in FIG. 4A) and a membrane permeate line (see, e.g., the membrane permeate line 338 in FIG. 4A). In yet another non-limiting case, the blend back valve 380c may be positioned on or proximate to a blend back conduit (see, e.g., the blend back conduit 382 in FIG. 4A), where the blend back conduit is positioned between the additive line (see, e.g., the additive line 326 in FIG. 4A) and either upstream or downstream of a valve coupled to the additive line (see, e.g., the second valve 329a in FIG. 4A).

The remineralization material introduced or otherwise provided by the remineralization system via the reservoir, block of remineralization material, and/or remineralization pump or dosing mechanism may change at least one quality or characteristic of the membrane permeate such as the pH level and/or the TDS level. Changing at least one quality or characteristic of the membrane permeate may improve the aesthetics (e.g., taste) of the membrane permeate and/or reduce the possible corrosion of metal plumbing and appliances downstream from the water treatment system 200. Generally, one or more TDS sensors and/or one or more pH sensors may be positioned upstream and/or downstream of the remineralization system. In some embodiments, one or more TDS sensors may be disposed proximate to, adjacent to, and/or in fluid communication with the remineralization system to monitor the TDS level of the membrane permeate before and/or after the membrane permeate passes by or through the remineralization system. In some cases, the one or more TDS sensors may be provided in the form of ion-selective electrodes. The ion-selective electrodes may be designed to detect one or more ions in a water stream that may impact a measured TDS or alkalinity value. For example, the one or more TDS sensors may be provided in the form of an ion-selective electrode designed to detect calcium ions, an ion-selective electrode designed to detect magnesium ions, an ion-selective electrode designed to detect alkalinity values, and the like. Additionally, or alternatively, one or more pH sensors may be disposed proximate to, adjacent to, and/or in fluid communication with the remineralization system to monitor the pH level of the membrane permeate before and/or after the membrane permeate passes by or through the remineralization system. The one or more pH sensors may be fluidly coupled to a particular line and be positioned downstream of the remineralization system. Further, the system 200 may include one or more additional sensors adapted to measure a different quality or characteristic of the remineralized or prefiltered water.

In various instances of the system 200, after the permeate stream is provided to the remineralization system, the permeate stream may be imparted with a third concentration of solutes that is greater than the first concentration of solutes of the permeate stream. In some instances, the first concentration of solutes of the permeate stream may be less than 60 ppm, although the first concentration of solutes may be somewhat less or greater than these values. The remineralized membrane permeate that exits the remineralization system or that is created when the membrane permeate passes by or through the remineralization system may be imparted with a third concentration of at least about 50 ppm to at least about 500 ppm, or at least about 100 ppm to at least about 400 ppm. In some instances, the remineralized water may be imparted with a third concentration of at least about 50 ppm (or at least 50 ppm).

In other embodiments, the remineralized membrane permeate that exits the remineralization system or that is created when the membrane permeate passes by or through the remineralization system may be imparted with a third concentration of at least 50 ppm to at least 500 ppm, or at least 100 ppm to at least 400 ppm. In some instances, the remineralized membrane permeate that exits the remineralization system or that is created when the membrane permeate passes by or through the remineralization system may be imparted with a third concentration of less than 50 ppm or greater than 500 ppm.

In some embodiments, the remineralized membrane permeate may be imparted with a third concentration of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the remineralized membrane permeate may be imparted with a third concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In some instances, the system 200 may target a particular TDS value (a “target TDS value”) for the remineralized water stream by taking one or more actions. For example, the controller 294 may direct the opening or closing of one or more valves associated with a remineralization system, direct an amount of a remineralization material to be provided from a remineralization pump, and/or direct a predetermined amount of water to flow past a remineralization material. In various cases, the target TDS value may be imparted with a value of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more. In various instances, the target TDS value may be imparted with a value of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In further embodiments, the remineralized membrane permeate may be imparted with a pH value within drinkable limits (e.g., about 6.5 to about 10, or 6.5 to 10). In some embodiments, the remineralized membrane permeate may be imparted with a pH value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the remineralized membrane permeate may be imparted with a pH value of 6.5, or at least 6.5, or at least 6.6, or at least 6.7, or at least 6.8, or at least 6.9, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

In some instances, the system 200 may target a particular pH value (a “target pH value”) for the remineralized water stream by taking one or more actions. For example, the controller 294 may direct the opening or closing of one or more valves associated with a remineralization system, direct the amount of a remineralization material provided from a remineralization pump, and/or direct a predetermined amount of water to flow past a remineralization material. In various cases, the target pH value may be imparted with a value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In various instances, the target pH value may be imparted with a value of 6.5, or at least 6.5, or at least 6.6, or at least 6.7, or at least 6.8, or at least 6.9, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

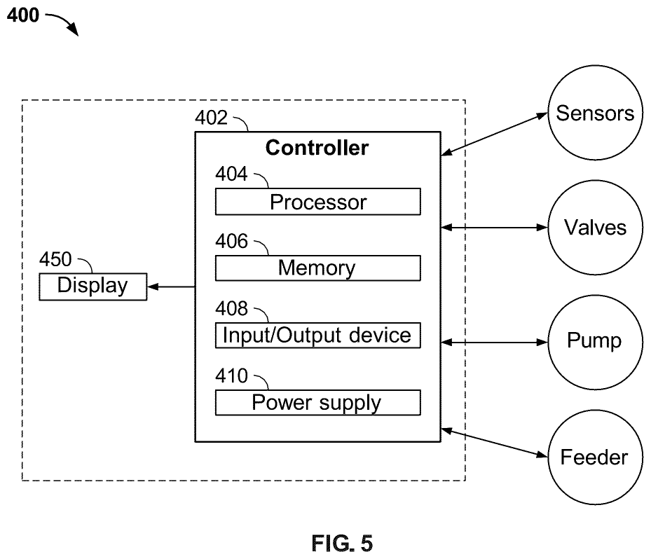

The water treatment system 200 may include and be in communication with a control system 292. The control system 292 may include the controller 294 and a display 296. As shown in FIG. 5, the controller 294 may be electronically connected to and may be in electronic communication with the display 296. The controller 294 also may be electronically connected to and may be in electronic communication with one or more of the water treatment system components including the one or more sensors (206a-206g, 214a-214d, 216a-216h, and 222), the first, second, third, fourth, or fifth valves (208a, 229a, 242, 208b, and 229b, respectively), the feeder 228, and/or the pump 230.

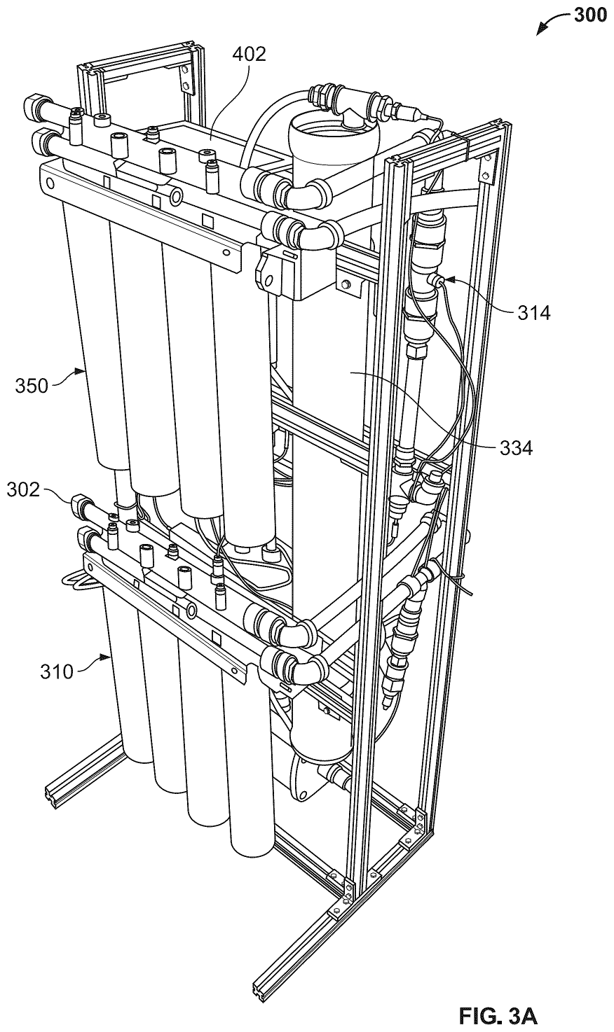

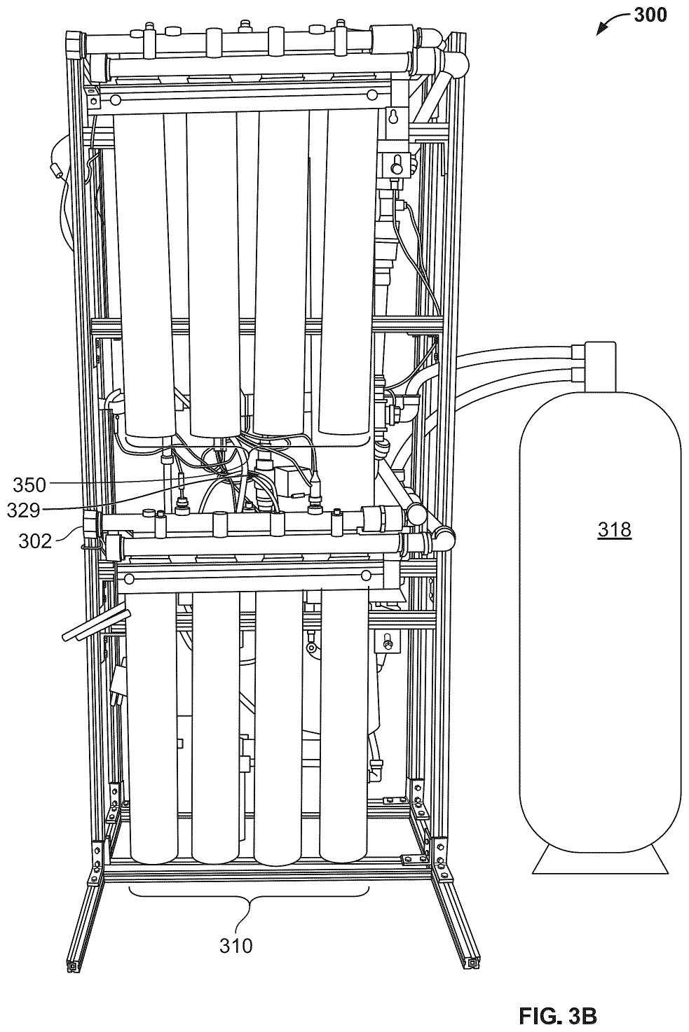

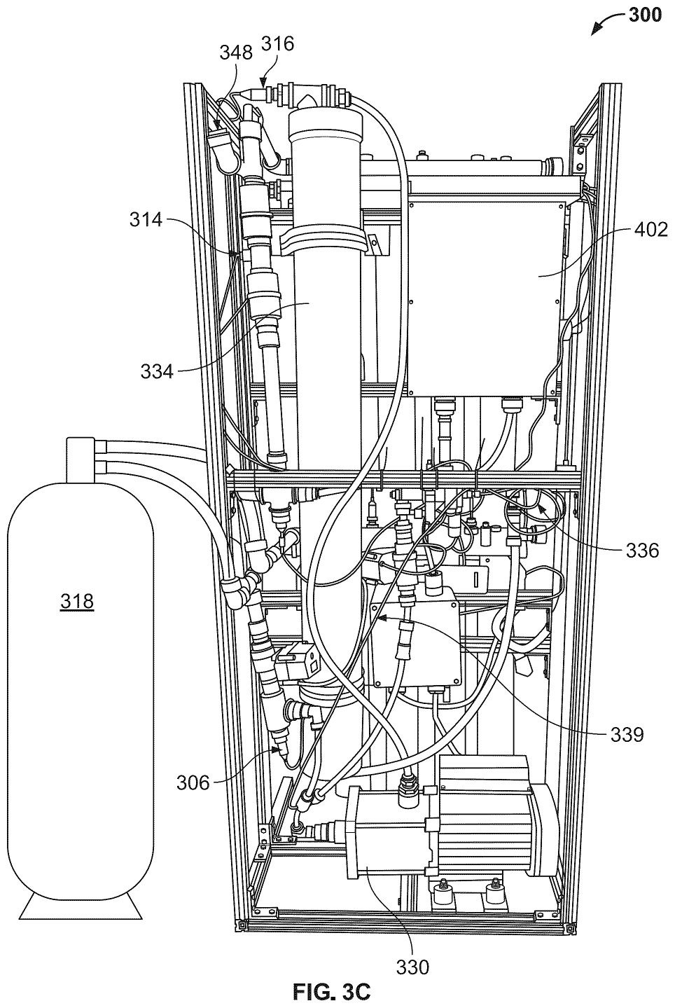

FIGS. 3A, 3B, and 3C illustrate an embodiment of a water treatment system 300. The water treatment system 300 may have the same types of system components as the water treatment system 100 of FIG. 1 and the water treatment system 200 of FIG. 2 (wherein similar components have like reference numbers), but the water treatment system 300 may have fewer system components and/or system components in a different configuration than the water treatment system 100 of FIG. 1 and the water treatment system 200 of FIG. 2. Similar to the water treatment system 200 of FIG. 2, the water treatment system 300 may include a permeate flush line. The water treatment system 300 may also include various configurations of prefiltration and post-filtration systems as described in more detail herein below.

The water treatment system 300 may include an inlet 302 through which inlet water (e.g., hard water) enters the water treatment system 300. The inlet water may pass through a prefiltration unit 310, where the inlet water may be filtered and sediment or other contaminants removed. The prefiltered water may flow into a tank 318 where the prefiltered water may be stored for future processing by a membrane element 334 of the water treatment system 300. The prefiltered water may also flow into and through the tank 318 to an outlet 348 (see FIG. 3C) of the water treatment system 300 for immediate use. Alternatively, or additionally, the prefiltered water may flow toward the membrane element 334. As the prefiltered water flows toward the membrane element 334, the prefiltered water may pass an optional feeder 328. If provided, in some instances, the feeder 328 may be positioned elsewhere in the system 300 (e.g., downstream of the pump 330 or downstream of the membrane element 334). The feeder 328 may add a chemical additive to the prefiltered water. A pump 330 located on a feed side of the membrane element 334 may be activated to direct the prefiltered water toward the membrane element 334. The membrane element 334 may further filter the prefiltered water to remove hardness minerals and other impurities.

Water with hardness minerals and other impurities that do not pass through the membrane element 334 may be discharged from the membrane element 334 via a retentate line 336 (see FIG. 3C).

The membrane filtered water may flow from the membrane element 334 to the tank 318 for storage or may flow toward the outlet 348 of the water treatment system 300 to a point of use. Before the membrane filtered water flows out of the outlet 348, the membrane filtered water may pass through a post-filtration unit 350, where the membrane filtered water may be further purified before exiting the water treatment system 300 via the outlet 348. The membrane filtered water may be stored in the tank 318. The membrane filtered water may also flow from the tank 318 toward an inlet side of the pump 330. The membrane filtered water may then be directed toward the membrane element 334 via the pump 330 and may be used to clean the membrane element 334.

The water treatment system 300 may have one or more sensors (e.g., 306a-306d, 314a-314c, 316a-316f, 322) that may be disposed at various points in the water treatment system 300 to measure or monitor a characteristic of the water (e.g., pressure, flow rate, conductivity, total dissolved solids, etc.) and provide data to a controller 394. Furthermore, one or more valves or flow restrictor tubes (e.g., 308a, 308b, 329a, 329b, 339, 342a, 342b) may be included at various points of the water treatment system 300 to control the flow of water into, through and out of the water treatment system 300.

Now turning to FIG. 4A, the inlet 302 of the water treatment system 300 may be in fluid communication with an inlet line 304. The inlet water may be from an inlet water source (not shown). The inlet water source may be, for example, a municipal water source, a well, or other influent water source. The inlet water may be imparted with a hardness value of about 1 grain per gallon (17.1 milligrams per liter) to about or above 10 grains per gallon (over 180 milligrams per liter).

The water treatment system 300 may include a first valve 308a. The first valve 308a may be in fluid communication with the inlet line 304. In some embodiments, the first valve 308a may be a gate valve. In some embodiments, the first valve 308a may be a bypass valve, a solenoid valve, a butterfly valve, a ball valve, a globe valve, a pressure relief valve, or a check valve.

The first valve 308a may control or regulate the amount of inlet water entering the water treatment system 300. The first valve 308a may open, either partially or fully, to enable the flow or increase the amount of inlet water entering the water treatment system 300 through the inlet 302. The first valve 308a may close, either partially or fully, to stop or decrease the flow or amount of inlet water entering the water treatment system 300. In addition, in some embodiments, the water treatment system 300 may be provided with a manual bypass valve (not illustrated) that is configured to decrease, substantially stop, or completely stop the flow of inlet water into the water treatment system 300. The amount of inlet water entering the water treatment system 300 may increase or decrease the water pressure in the water treatment system 300.

The water treatment system 300 may include the prefiltration unit 310. The prefiltration unit 310 may be provided in the form of one or more prefilter elements having one or more filter media. The prefiltration unit 310 may include a first prefilter element 310a and a second prefilter element 310b. The first prefilter element 310a may be in fluid communication with the inlet line 304 and the second prefilter element 310b. The second prefilter element 310b may be in fluid communication with the first prefilter element 310a and a prefiltered water line 312. Alternatively, the second prefilter element 310b may be in fluid communication with the inlet line 304 and the first prefilter element 310a, and the first prefilter element 310a may be in fluid communication with the second prefilter element 310b and the prefiltered water line 312.

Inlet water may enter the prefiltration unit 310 via the inlet line 304 and exit the prefiltration unit 310 via the prefiltered water line 312. When inlet water passes through the prefiltration unit 310, the prefiltration unit 310, via the first prefilter element 310a and the second prefilter element 310b, may remove sediment, particulates, certain chemicals, and other contaminants from the inlet water, producing a prefiltered water that may flow out of the prefiltration unit 310 via the prefiltered water line 312.

In some embodiments, the first prefilter element 310a may include a sediment filter. The sediment filter may remove sediments such as sand, silt, dirt, and other particulates such as rust from the inlet water. In some embodiments, the sediment filter may include a filter media including pores with a pore size of no more than 5 microns, or no more than about 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, the second prefilter element 310b may include an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like. In some embodiments, a non-carbon-based media, such as clay or an ion exchange media, may be used in place of the activated carbon media.

By removing sediment, chlorine, chloramine, and other contaminants, the prefiltration unit 310 may provide prefiltered water that may have substantially no odor and have an improved taste compared to the inlet water. In addition, by removing sediment, chlorine, chloramine, and other contaminants, the prefiltration unit 310 may protect the downstream membrane element 334 from sediment fouling or oxidation.

In some embodiments, the prefiltration unit 310 may be defined by a series of prefilter elements (e.g., two or more sediment filters) or may be comprised of a combination of prefilter elements (e.g., one or more sediment filters and one or more activated carbon filters). One of ordinary skill in the art would understand that the one or more prefilter elements that comprise the prefiltration unit 310 may be retained within a single prefiltration element or may be separate and distinct prefilter elements (as shown in FIGS. 3A, 3B, and 4A) that are in fluid communication with one another. In some embodiments, the prefiltration unit 310 may be a PENTAIR® EVERPURE® filter. In other embodiments, the prefiltration unit 310 may be a PENTAIR® PENTEK® BIG BLUE® filter.

The water treatment system 300 may include one or more pressure sensors 306. In some embodiments, the one or more pressure sensors 306 may be defined by a gauge pressure transmitter, a differential pressure transmitter, an absolute pressure transmitter, a multivariate pressure transmitter, or a submersible pressure transmitter.

Preferably, a first pressure sensor 306a may be in fluid communication with the inlet line 304. The first pressure sensor 306a may measure, monitor, or sense the pressure of the inlet water in the inlet line 304. Alternatively, the first pressure sensor 306a may be in fluid communication with inlet water within the first prefilter element 310a. The first pressure sensor 306a may measure, monitor, or sense the pressure of the inlet water within the first prefilter element 310a. In some embodiments, the first pressure sensor 306a may be coupled to the prefiltration unit 310. In some embodiments, the first pressure sensor 306a may be coupled to the first prefilter element 310a (as shown in FIG. 4A) or the second prefilter element 310b.

The water treatment system 300 may include one or more TDS sensors 316. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about ±10% Full Scale (25° C.). In some embodiments, the one or more TDS sensors 316 may be a TDS sensor having a TDS measurement range of at least about 0 to about 3000 ppm or greater than about 3000 ppm. One of ordinary skill in the art would understand that each of the one or more TDS sensors 316 may be the same type of TDS sensor or may each be a different type of TDS sensor.

A first TDS sensor 316a may be in fluid communication with the prefiltered water line 312. The first TDS sensor 316a may measure, monitor, or sense the conductivity of the prefiltered water to determine the concentration or amount of dissolved solids in the prefiltered water. Alternatively, the first TDS sensor 316a may be in fluid communication with water within the second prefilter element 310b. Preferably, the first TDS sensor may be coupled to the inlet line 304. The first TDS sensor may measure, monitor, or sense the conductivity of the inlet water or the water within the second prefilter element 310b to determine the concentration or amount of dissolved solids in the inlet water or the water within the second prefilter element 310b. In some embodiments, the first TDS sensor 316a may be coupled to the prefiltration unit 310. In some embodiments, the first TDS sensor 316a may be coupled to the second prefilter element 310b (as shown in FIG. 4A) or the first prefilter element 310a.

The water treatment system 300 may include a temperature sensor 322 that may be in fluid communication with the prefiltered water line 312. The temperature sensor 322 may be designed to measure, monitor, or sense the temperature of the prefiltered water. In some embodiments, the temperature sensor 322 may be thermistor, a thermocouple, a semiconducting material, or any other mechanical or electronic sensor that may respond to a change in temperature. In some embodiments, additional temperature sensors may be included in the water treatment system 300. In some embodiments, an additional temperature sensor may be optionally placed on or within the inlet line 304.

The water treatment system 300 may include the tank 318, which may be used to store water. The tank 318 may be defined by a housing having a bottom portion 318a, a center portion 318b, and a top portion 318c. In some instances, each of the portions 318a, 318b, 318c may be separated by a physical barrier (e.g., if the tank 318 is provided as a bladder tank), although in preferred embodiments no physical barrier is positioned between the portions 318a, 318b, 318c. In some embodiments, the tank 318 may be a flow through tank, which may allow for the seamless delivery of water to a point of use (POU). In some embodiments, the tank 318 may be a pressurized tank. In some embodiments, the tank 318 may be a fiberglass reinforced plastic (FRP) tank. In some embodiments, the tank 318 may range in size from about 24 gallons (91 liters) to about 200 gallons (757 liters). In some embodiments, multiple tanks 318 of any size may be connected in series. In further embodiments, existing water vessels within the residential or commercial property (e.g., a water heater) may be used for additional storage capacity.

The tank 318 may include a riser tube 320 that extends vertically from the bottom portion 318a of the tank 318 to the top portion 318c of the tank 318, or vice versa. The riser tube 320 may be in fluid communication with the prefiltered water line 312. In some embodiments, the riser tube 320 may be provided as PVC tubing.

The tank 318 may further include a flow distributor 324, which may be attached or coupled to the riser tube 320. The flow distributor 324 may prevent or reduce the mixing of higher TDS water that may be stored in the bottom portion 318a of the tank 318 with lower TDS water that may be stored in the top portion 318c of the tank 318. In some embodiments, the flow distributor 324 may be a dome flow distributor. In some embodiments, multiple flow distributors 324 may be used.

Additionally, or alternatively, the tank 318 may include baffles and external plumbing (e.g., flow distributors) to reduce the mixing of higher TDS water that may be stored in the bottom portion 318a of the tank 318 with lower TDS water that may be stored in the top portion 318c of the tank 318.

In some embodiments, the high TDS water is added to the bottom portion 318a of the tank 318 and the low TDS water is added to the top portion 318c of the tank 318. Advantageously, adding the high TDS water and the low TDS water to the tank 318 in this manner may help maintain the separation between the high TDS water and the low TDS water in the tank 318, which in turn may help ensure that low TDS water is provided to a point of use during operation of the tank 318.

The water treatment system 300 may include an additive line 326. The additive line 326 may be physically connected to or otherwise in fluid communication with the prefiltered water line 312.

The water treatment system 300 may include a second valve 329a. The second valve 329a may be in fluid communication with the additive line 326. In some embodiments, the second valve 329a may be an actuated ball valve. In some embodiments, the second valve 329a may be a gate valve, a butterfly valve, a globe valve, a pressure relief valve, or a check valve.

The second valve 329a may be used to control or regulate the amount of prefiltered water flowing through the additive line 326. The second valve 329a may open, either partially or fully, to enable the flow or increase the amount of prefiltered water flowing through the additive line 326 toward the pump 330. The second valve 329a may close, either partially or fully, to stop or decrease the flow or amount of prefiltered water (with or without additive) flowing through the additive line 326 toward the pump 330.

The prefiltered water may have a fluid flow path through the water treatment system 300. In some embodiments, depending on the flow conditions when the water treatment system 300 is in use, the prefiltered water may flow in different directions as described in more detail below (see, e.g., FIG. 7). For example, during some flow conditions, the prefiltered water may flow from the prefiltration unit 310 through the prefiltered water line 312, down the riser tube 320, and into the bottom portion 318a of the tank 318. The prefiltered water may be stored in the tank 318. During other flow conditions, the prefiltered water may also flow from the prefiltration unit 310 via the prefiltered water line 312 toward the membrane element 334 via the additive line 326. During further flow conditions, the prefiltered water may flow from the bottom portion 318a of the tank 318, up the riser tube 320, and through the prefiltered water line 312 toward the membrane element 334 via the additive line 326.

The water treatment system 300 may include the feeder 328 that may be in fluid communication with the additive line 326. The feeder 328 may introduce or add a chemical additive to the prefiltered water. In some embodiments, the chemical additive may be an anti-scaling agent to reduce corrosion or scale on a feed side of a membrane element. In some embodiments, the chemical additive may be a polyphosphate.

When the prefiltered water flows through or passes the feeder 328, the chemical additive may be added or introduced to the prefiltered water. The chemical additive may dissolve or otherwise degrade in the prefiltered water. In some embodiments, as further detailed herein, the feeder 328 may impart the water flowing through the feeder 328 with a chemical additive concentration of at least about 0.01 ppm to at least about 10 ppm, or 0.01 ppm to 10 ppm. In other embodiments, the feeder 328 may impart the water flowing through the feeder 328 with a chemical additive concentration of less than 0.01 ppm or greater than 10 ppm of the chemical additive.

In some embodiments, the water treatment system 300 may include an optional second prefiltration unit 331 (as shown in FIG. 4A). The second prefiltration unit 331 may be in fluid communication with the additive line 326.

The second prefiltration unit 331 may be provided in the form of one or more prefilter elements having one or more filter media. Inlet water may enter the prefiltration unit 310 via the inlet line 304 and exit the prefiltration unit 310 via the prefiltered water line 312. When inlet water passes through the prefiltration unit 310, via the first prefilter element 310a and the second prefilter element 310b, the prefiltration unit 310 may remove sediment, particulates, certain chemicals and other contaminants from the inlet water, producing a prefiltered water that may flow out of the prefiltration unit 310 via the prefiltered water line 312.

In some embodiments, the one or more prefilter elements of the second prefiltration unit 331 may include a sediment filter. The sediment filter may remove remaining sediment, such as sand, silt, dirt, and other particulates from the prefiltered water (with or without additive) that were not removed by the prefiltration unit 310. In some embodiments, the sediment filter may include a filter media including pores with a pore size of no more than 1 micron or no more than about 1 micron. For example, the sediment filter may include a filter media including pores with a pore size of no more than 1 micron, no more than 0.5 microns, or no more than 0.1 microns. As an additional example, the sediment filter may include a filter media including pores with a pore size of no more than about 1 micron, no more than about 0.5 microns, or no more than about 0.1 microns. In some embodiments, the sediment filter may include a depth media, woven fabric, or nonwoven fabric.

The water treatment system 300 may include a second pressure sensor 306b that may be in fluid communication with the additive line 326. The second pressure sensor 306b may measure, monitor, or sense the pressure of the prefiltered water with additive in the additive line 326. Specifically, if the feeder 328 is provided, the second pressure sensor 306b may determine the pressure after the chemical additive is provided and the water has passed through an optional sediment filter. Alternatively, if a chemical additive is not added by the feeder 328, the second pressure sensor 306b may measure, monitor, or sense the pressure of the prefiltered water in the additive line 326. In some embodiments, the second pressure sensor 306b may be coupled to the second prefiltration unit 331 (as shown in FIG. 4A). In some embodiments, the measurement from the second pressure sensor 306b may be used as an input by the control system 400 in determining whether the pump 330 should be activated or whether there is sufficient pressure within the water treatment system 300 such that the water treatment system 300 may operate without the pump 330 being activated.

The water treatment system 300 may include the pump 330. The inlet side (not shown) of the pump 330 may be in fluid communication with the additive line 326, and an outlet side (not shown) of the pump 330 may be in fluid communication with a membrane feed line 332. In some embodiments, the pump 330 may be a single-phase booster pump. For example, the pump 330 may be a PENTAIR® STA-RITE™ single phase 115 volt, ¾ horsepower pump. In some embodiments, the pump 330 may be a multi-phase booster pump. In some embodiments, the pump 330 may boost differential pressure in the membrane feed line 332 to 120-250 pounds per square inch (827-1725 kilopascals) at a flow rate of 1.0-7.0 gallons per minute (11-26 liters per minute) or at a preferable flow rate of 2.0-5.0 gallons per minute (7.5-19 liters per minute).

The membrane feed line 332 may be in fluid communication with a third pressure sensor 306c. The third pressure sensor 306c may measure, monitor, or sense the pressure of the prefiltered water (with or without additive) in the membrane feed line 332.

The water treatment system 300 may include the membrane element 334. In some embodiments, the membrane element 334 may be a reverse osmosis (RO) membrane. In some embodiments, the RO membrane may be spiral wound and may include feed spacers imparted with a certain thickness and/or structure. In some embodiments, the RO membrane may be a spiral wound RO membrane (e.g., a spiral wound 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membrane may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membrane may be a spiral wound RO membrane (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membrane may be a spiral wound RO membrane (e.g., a spiral wound 4040 RO membrane) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membrane may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membrane may be a spiral wound RO membrane (e.g., a spiral wound 4040 RO membrane) with feed spacers imparted with a thickness of at least 0.2 millimeters to no more than 1.1 millimeters. For example, the RO membrane may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In some embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the membrane element 334 may be a nanofiltration (NF) membrane, an ultrafiltration (UF) membrane, a microfiltration (MF) membrane, or a particulate membrane. In some embodiments, the membrane element 334 may be a hollow fiber NF membrane. In other embodiments, the membrane element 334 may be an electrodialysis membrane system.

In some embodiments, the membrane element 334 may comprise a combination of one or more of a RO membrane, an NF membrane, a UF membrane, an MF membrane, a particulate membrane, and/or an electrodialysis membrane, which may be disposed in parallel or in series. For example, in some embodiments, the combination of membranes may include at least one RO membrane and at least one NF membrane. The at least one RO membrane may be disposed in parallel with the at least one NF membrane, or the RO membrane may be disposed before or after the at least one NF membrane in series. In other embodiments, the combination of membrane elements may include at least one UF membrane and at least one MF membrane. The at least one UF membrane may be disposed in parallel with the at least one MF membrane, or the at least one UF membrane may be disposed before or after the at least one MF membrane in series. The one or more membranes in the combination of membranes may be contained within a single housing, in separate housings, or a combination thereof.

In further embodiments, the membrane element 334 may include two or more RO membranes, NF membranes, UF membranes, MF membranes, particulate membranes, and/or electrodialysis membranes, which may be disposed in parallel or in series. In some embodiments, the membrane element 334 may be a series of membranes of the same type (e.g., two or more RO membranes) but of a different size. For example, the membrane element 334 may include a first membrane imparted with a first diameter and a second membrane imparted with a second diameter that is different from the first diameter (e.g., the second diameter may be less than the first diameter). In some embodiments, the first membrane may be a spiral wound 4040 RO membrane, and the second membrane may be a spiral wound 2540 RO membrane. The two or more membranes may be contained within a single housing, in separate housings (e.g., as shown in FIG. 4D), or a combination thereof.

Membranes made of polyamides, such as RO and NF membranes, are susceptible to structural changes when exposed to corrosive agents such as chlorine-containing substances (including chloramine) and other corrosive agents, resulting in less salt removal by the membrane. By intentionally exposing the surface of the membrane to a chlorine-containing solution, a hypochlorite solution, and/or another corrosive agent, a desired permeance profile of the membrane may be achieved. In some cases, by exposing the membrane to a corrosive agent, a treated membrane or a treated membrane element can be provided that allows a predetermined percentage of minerals or other compounds (e.g., calcium ions, magnesium ions, carbonate ions, etc.) to pass through the membrane and into the permeate. Allowing a predetermined percentage of minerals or other compounds to pass through the membrane element 134 may be beneficial since this may reduce the need for remineralization downstream of the membrane element. For instance, the treated membrane or the treated membrane element may produce permeate imparted with a TDS content of about 25 ppm to about 300 ppm, or about 50 ppm to about 275 ppm, or about 75 ppm to about 250 ppm, or about 100 ppm to about 225 ppm, or about 100 ppm to about 200 ppm. In other instances, the treated membrane or the treated membrane element may produce permeate imparted with a TDS content of about 25 ppm to about 75 ppm, or about 50 to about 100 ppm, or about 75 ppm to about 125 ppm, or about 100 ppm to about 150 ppm, or about 125 ppm to about 175 ppm, or about 150 ppm to about 200 ppm, or about 175 ppm to about 225 ppm, or about 200 ppm to about 250 ppm, or about 225 ppm to about 275 ppm, or about 250 ppm to 300 ppm. In yet other instances, the treated membrane or the treated membrane element may produce permeate imparted with a TDS content of at least about 25 ppm, or at least about 50 ppm, or at least about 75 ppm, or at least about 100 ppm, or at least about 125 ppm, or at least about 150 ppm, or at least about 175 ppm, or at least about 200 ppm, or at least about 225 ppm, or at least about 250 ppm, or at least about 275 ppm, or at least about 300 ppm, or at least about 325 ppm, or at least about 350 ppm. In some embodiments, the treated membrane or the treated membrane element may produce permeate imparted with a TDS content of about 50 ppm to 100 ppm (e.g., for residential systems), while in other embodiments, the target range may be about 100 ppm to 200 ppm (e.g., for systems used in food and beverage preparation).

In some instances, the treated membrane or the treated membrane element may produce permeate imparted with a TDS content of 25 ppm to 300 ppm, or 50 ppm to 275 ppm, or 75 ppm to 250 ppm, or 100 ppm to 225 ppm, or 100 ppm to 200 ppm. In other instances, the treated membrane or the treated membrane element may produce permeate imparted with a TDS content of 25 ppm to 75 ppm, or 50 to 100 ppm, or 75 ppm to 125 ppm, or 100 ppm to 150 ppm, or 125 ppm to 175 ppm, or 150 ppm to 200 ppm, or 175 ppm to 225 ppm, or 200 ppm to 250 ppm, or 225 ppm to 275 ppm, or 250 ppm to 300 ppm. In yet other instances, the treated membrane or the treated membrane element may produce permeate imparted with a TDS content of at least 25 ppm, or at least 50 ppm, or at least 75 ppm, or at least 100 ppm, or at least 125 ppm, or at least 150 ppm, or at least 175 ppm, or at least 200 ppm, or at least 225 ppm, or at least 250 ppm, or at least 275 ppm, or at least 300 ppm, or at least 325 ppm, or at least 350 ppm. In some embodiments, the treated membrane or the treated membrane element may produce permeate imparted with a TDS content of 50 ppm to 100 ppm (e.g., for residential systems), while in other embodiments, the target range may be 100 ppm to 200 ppm (e.g., for systems used in food and beverage preparation).

It is to be understood that the treated membrane or the treated membrane element may also produce a permeate that is imparted with a TDS content that is less than or greater than the values recited herein.

In some embodiments, the membrane element 334 of the water treatment system 300 may be provided in the form of a nanofiltration (NF) membrane element or NF membrane module comprising a NF membrane. In some such embodiments, the NF membrane may enhance permeate production of the membrane element 334 while also producing a “balanced” permeate water imparted with a desired taste profile. The balanced permeate water may also mitigate the potential for scale formation downstream of the membrane element 334. In some embodiments, the NF membrane element may be spiral wound and may include feed spacers imparted with a certain thickness and/or structure. In some embodiments, the NF membrane element may have a specified diameter, for example, a 4-inch diameter, allowing for a desired amount and/or a desired surface area of NF membrane to be incorporated into the NF membrane element. In some cases, the NF membrane may be designed to provide one or more desired performance and/or separation characteristics, including, for example, total hardness rejection percentages, calcium rejection percentages, TDS rejection percentages, alkalinity rejection percentages, pollutant rejection percentages, permeate pH values, membrane permeance values, and permeate flow rates.

Various examples of the one or more desired performance and/or separation characteristics are provided. In some embodiments, the NF membrane may be designed to maximize membrane permeance. In some embodiments, the NF membrane may be designed such that the NF membrane element maximizes a production level of permeate flow. In some embodiments, the NF membrane may be designed to have a targeted range of total hardness rejection to impart a desired taste profile and/or a desired water chemistry, while also reducing or eliminating impacts associated with water hardness (e.g., scaling). In some embodiments, a total hardness of a permeate can be measured against standard indices, including, for example, a Langelier Saturation Index (LSI), a Calcite Precipitation Potential (CPP), a Larson-Skold Index, a Riddick Index, and a Feigenbaum Index. In some embodiments, the NF membrane may be designed to have a targeted range of calcium hardness rejection to reduce scaling potential while avoiding corrosion. In some embodiments, the NF membrane may be designed to have a targeted range of alkalinity rejection to reduce scaling potential while avoiding corrosion. In some embodiments, the NF membrane may be designed to have a targeted range of TDS rejection to impart a desired taste profile and/or desired water chemistry parameters. In some embodiments, the NF membrane may be designed to produce permeate having a targeted pH range to achieve a desired taste profile and/or desired water chemistry parameters while meeting drinking water standards.

In some embodiments, the NF membrane may provide desired separation characteristics while further removing pollutants, for example, micro-pollutants and/or heavy metals, from a feed stream. For example, the NF membrane may be designed to allow a predetermined amount of calcium and other dissolved solids to pass through the NF membrane while also preventing permeation of various micro-pollutants (e.g., large organic molecules, such as per- and polyfluoroalkyl substances (PFAS), commonly referred to as “forever chemicals”) and heavy metals.

In some cases, the NF membrane may have been treated or otherwise processed to provide one or more desired separation characteristics including, for example, calcium rejection percentages, TDS rejection percentages, alkalinity rejection percentages, permeate pH values, flux values, and permeate flow rates. For example, the NF membrane may have undergone treatment with one or more corrosive agents to tailor pore geometry and impart desired performance characteristics to the NF membrane. Thus, the NF membrane may be treated, processed, or designed to produce a permeate water with predetermined, defined, or desired characteristics.

In some embodiments, the NF membrane may provide desired separation characteristics that eliminate the need for post-filtration remineralization prior to consumption and/or use. This can be verified by the levels of various parameters in the permeate water such as, but not limited to, TDS, hardness, alkalinity, pH, LSI, and CPP. In such instances, the mineralization system 380 may be omitted from the water treatment system 300.

In some embodiments, the NF membrane may be treated, processed, or designed to provide a desired calcium rejection percentage. In some embodiments, the NF membrane may have a desired calcium rejection percentage of at least about 60% to no more than about 95%, although the desired calcium rejection percentage may be somewhat less or somewhat greater than these values. For example, the NF membrane may have a desired calcium rejection percentage of at least about 75% to no more than about 90%, or at least about 80% to no more than about 85%, or at least about 81% to no more than about 84%.

In some embodiments, the NF membrane may be treated, processed, or designed to provide a desired calcium rejection percentage that meets or exceeds a targeted rejection percentage. In some embodiments, the NF membrane may have a desired calcium rejection percentage of at least about 60%, or at least about 65%, or at least about 70%, or at least about 73%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

It is to be understood that, for different chemistries of the inlet water provided to the water treatment system 300, the NF membrane may reduce the calcium concentration of the inlet water by varying levels. For example, if the inlet water is moderately hard, about a 75% reduction in calcium concentration may be indicative of good or excellent membrane performance. As an additional example, if the inlet water is very hard, about a 90% reduction may be more appropriate.

In some embodiments, the NF membrane may be treated, processed, or designed to provide a desired calcium rejection percentage that does not exceed a targeted rejection percentage. In some embodiments, the NF membrane may have a desired calcium rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 70%.

It is to be appreciated that the desired calcium rejection percentage may be imparted with a discrete value, or range of values, falling within any minimum and maximum values or ranges recited herein with reference to the desired calcium rejection percentage.

In some embodiments, the NF membrane may be treated, processed, or designed to have a desired TDS rejection percentage. In some embodiments, the NF membrane may be imparted with a desired TDS rejection percentage of at least about 70% to no more than about 90%, although the desired TDS rejection percentage may be somewhat less or greater than these values. For example, the NF membrane may be treated, processed, or designed to have a desired TDS rejection percentage of at least about 75% to no more than about 90%, or at least about 80% to no more than about 85%, or at least about 81% to no more than about 84%.

In some embodiments, the NF membrane may be treated, processed, or designed to provide a desired TDS rejection percentage that meets or exceeds a targeted rejection percentage. In some embodiments, the NF membrane may have a desired TDS rejection percentage of at least about 70%, or at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

In some embodiments, the NF membrane may be treated, processed, or designed to provide a desired TDS rejection percentage that does not exceed a targeted rejection percentage. In some embodiments, the NF membrane may have a desired TDS rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 74%, or no more than about 73%, or no more than about 72%, or no more than about 71%, or no more than about 70%.

It is to be appreciated that the desired TDS rejection percentage may be imparted with a discrete value, or range of values, falling within any minimum and maximum values or ranges recited herein with reference to the desired TDS rejection percentage.

In some embodiments, the NF membrane may be treated, processed, or designed to have a desired alkalinity rejection percentage. In some embodiments, the NF membrane may be imparted with a desired alkalinity rejection percentage of at least about 70% to no more than about 90%, although the desired alkalinity rejection percentage may be somewhat less or somewhat greater than these values. For example, the NF membrane may be treated, processed, or designed to have a desired alkalinity rejection percentage of at least about 75% to no more than about 90%, or at least about 80% to no more than about 85%, or at least about 81% to no more than about 84%.

In some embodiments, the NF membrane may be treated, processed, or designed to provide a desired alkalinity rejection percentage that meets or exceeds a targeted rejection percentage. In some embodiments, the NF membrane may have a desired alkalinity rejection percentage of at least about 70%, or at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

In some embodiments, the NF membrane may be treated, processed, or designed so as to provide a desired alkalinity rejection percentage that does not exceed a targeted rejection percentage. In some embodiments, the NF membrane may have a desired alkalinity rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 74%, or no more than about 73%, or no more than about 72%, or no more than about 71%, or no more than about 70%.

It is to be appreciated that the alkalinity rejection percentage may be imparted with a discrete value, or range of values, falling within any minimum and maximum values or ranges recited herein with reference to the alkalinity rejection percentage.

In some embodiments, the NF membrane may be treated, processed, or designed to produce a permeate stream having a desired pH value. In some embodiments, the NF membrane may produce a permeate stream with a pH of at least about 6.2 to no more than about 8.5, although the pH value of the permeate stream may be somewhat less than or greater than these values. For example, the NF membrane may produce a permeate stream imparted with a pH of about 6.5 to about 8.5, or about 6.8 to about 8.0, or about 6.8 to about 7.5. In some embodiments, the NF membrane may produce a permeate stream having a minimum permeate pH of at least about 6.5. In some embodiments, the NF membrane may produce a permeate stream having a permeate pH of at least about 6.8 and no more than about 7.5.

In some embodiments, the NF membrane may be treated, processed, or designed to provide a permeate stream having a pH value that meets or exceeds a targeted pH value. In some embodiments, the NF membrane may provide a permeate stream having a desired pH value of at least about 6.2, or at least about 6.3, or at least about 6.4, or at least about 6.5, or at least about 6.6, or at least about 6.7, or at least about 6.8, or at least about 6.9, or at least about 7.0, or at least about 7.1, or at least about 7.2, or at least about 7.5, or at least about 7.8.

In some embodiments, the NF membrane may be treated, processed, or designed to provide a permeate stream having a pH value that does not exceed a targeted pH value. In some embodiments, the NF membrane may have a desired pH value of no more than about 7.2, or no more than about 7.1, or no more than about 7.0, or no more than about 6.9, or no more than about 6.8, or no more than about 6.7, or no more than about 6.6, or no more than about 6.5, or no more than about 6.4.

In some instances, the NF membrane may be treated, processed, or designed to produce a permeate water stream imparted with substantially the same pH value, or the same pH value, as the inlet water provided to the water treatment system 300. In some cases, the NF membrane may be treated, processed, or designed to produce a permeate water stream imparted with substantially the same pH value, or the same pH value, as the prefiltered water provided to the membrane element 334. In some embodiments, the NF membrane may be treated, processed, or designed to minimally alter the pH value of the water stream processed by the NF membrane. In other embodiments, the NF membrane may be treated, processed, or designed to produce a permeate water stream imparted with the same pH value as the water stream provided to the NF membrane.

It is to be appreciated that the targeted pH value may be imparted with a discrete value, or range of values, falling within any minimum and maximum values or ranges recited herein with reference to the targeted pH value.

In some embodiments, the NF membrane may be treated, processed, or designed to have a desired membrane permeance while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane material may be imparted with a membrane permeance of at least about 13 LMBH to about 20 LMBH, although the membrane permeance may be somewhat less than or even greater than these values. For example, the NF membrane may be imparted with a membrane permeance of about 15 LMBH to about 20 LMBH, or about 17 LMBH to about 20 LMBH. In some embodiments, the NF membrane is designed to achieve a maximum membrane permeance while achieving specified rejection rates, for example, a maximum membrane permeance at a calcium rejection percentage of at least about 75%, or a maximum membrane permeance at a calcium rejection percentage of at least about 90%.

In some embodiments, the NF membrane may be treated, processed, or designed to have a desired membrane permeance that meets or exceeds a targeted membrane permeance while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane material may have a desired membrane permeance of at least about 13 LMBH, or at least about 14 LMBH, or at least about 15 LMBH, or at least about 16 LMBH, or at least about 17 LMBH, or at least about 18 LMBH, or at least about 19 LMBH, or at least about 20 LMBH, or even greater.

It is to be appreciated that the targeted membrane permeance may be imparted with a discrete value, or range of values, falling within any minimum and maximum values or ranges recited herein with reference to the targeted membrane permeance.

In some embodiments, the NF membrane may be treated, processed, or designed to have a desired permeate flow rate while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). By way of non-limiting example, the NF membrane module may be constructed to have a 4-inch diameter, producing a permeate flow rate of 5 GPM to about 8 GPM, although the permeate flow rate may be somewhat less or even greater than these values. In various instances, the NF membrane module may produce a flow rate of greater than about 8 GPM. In some embodiments, the NF membrane may be treated, processed, or designed to have a desired permeate flow rate of at least about 14.5 GPM/ft³ of membrane.

In some embodiments, the NF membrane may be treated, processed, or designed to have a desired permeate flow rate that exceeds a targeted permeate flow rate while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane module may be constructed to have a 4-inch diameter producing a desired permeate flow rate of at least about 5 GPM, or at least about 6 GPM, or at least about 7 GPM, or at least about 8 GPM, or greater. In some embodiments, the NF membrane may be treated, processed, or designed to have a desired permeate flow rate of at least about 14.5 GPM/ft³ of membrane.

In some embodiments, the NF membrane may be treated, processed, or designed to have a desired membrane permeance while further achieving the disclosed TDS rejection percentage. In some embodiments, the NF membrane may have a membrane permeance of at least about 13 LMH/bar to no more than about 20 LMH/bar, or greater.

In some embodiments, the NF membrane may be treated, processed, or designed to have a desired membrane permeance that meets or exceeds a targeted membrane permeance while further achieving the disclosed TDS rejection percentage. In some embodiments, the NF membrane may have a desired membrane permeance that is at least about 13 LMBH, or at least about 14 LMBH, or at least about 15 LMBH, or at least about 16 LMBH, or at least about 17 LMBH, or at least about 18 LMBH, or at least about 19 LMBH, or at least about 20 LMBH, or even greater.

In some embodiments, the NF membrane may be treated, processed, or designed to have a desired permeate flow rate while further achieving the disclosed TDS rejection percentage. In some embodiments, the NF membrane may have a permeate flow rate of at least about 5 GPM to no more than about 8 GPM, although the permeate flow rate may be somewhat less or even greater than these values.

In some embodiments, the NF membrane may be treated, processed, or designed to have a desired permeate flow rate that meets or exceeds a targeted permeate flow rate while further achieving the disclosed TDS rejection percentage. In some embodiments, the NF membrane may have a desired permeate flow rate of at least about 5 GPM, or at least about 6 GPM, or at least about 7 GPM, or at least about 8 GPM, or greater.

In some embodiments, the NF membrane element including the above-described NF membrane may produce a permeate water stream imparted with desired parameters or characteristics (e.g., a balanced permeate water or a balanced permeate stream). For example, the permeate water stream may be imparted with a calcium ion concentration that is about 60% to about 90% less than a calcium ion concentration of the inlet water provided to the water treatment system 300, a total hardness level that is about 75% to about 90% less than a total hardness level of the inlet water provided to the water treatment system 300, a TDS level that is about 70% to about 90% less than the TDS level of the inlet water provided to the water treatment system 300, an alkalinity value that is about 75% to about 90% less than the alkalinity value of the inlet water provided to the water treatment system 300, and/or a pH level of about 6.2 to about 8.5. As an additional example, the permeate water may be imparted with a calcium ion concentration that is about 81% to about 84% less than a calcium ion concentration of the inlet water provided to the water treatment system 300, a total hardness level that is about 81% to about 84% less than a total hardness level of the inlet water provided to the water treatment system 300, a TDS level that is about 81% to about 84% less than the TDS level of the inlet water provided to the water treatment system 300, an alkalinity value that is about 81% to about 84% less than the alkalinity value of the inlet water provided to the water treatment system 300, and/or a pH level of about 6.5 to about 7.0. In some such instances, the NF membrane may be treated, processed, or designed to have a desired membrane permeance of about 13 LMBH to about 20 LMBH, or about 17 LMBH to about 20 LMBH while also producing the balanced permeate water, although the desired membrane permeance may be greater than these values. In further such instances, the permeate water stream provided from the membrane element 334 may be imparted with a permeate flow rate of about 5 GPM to about 8 GPM, although the flow rate may be even greater than these values.

Further tuning of the water chemistry of water provided from the water treatment system 300 (e.g., an outlet water stream) may be accomplished through other means in conjunction with the NF membrane. By way of non-limiting example, further tuning or adjusting of the water chemistry of the outlet water stream may be accomplished via remineralization, dosing a chemical compound to the permeate water stream or the outlet water stream, and/or feed blending.

In some embodiments, the NF membrane may be treated, processed, or designed to remove pollutants (e.g., micro-pollutants, heavy metals, etc.), while further achieving one or more of the disclosed calcium rejection percentage, total hardness rejection percentage, TDS rejection percentage, alkalinity rejection percentage, permeate stream pH value, and calculated LSI/CPP values (and/or other index values). In some embodiments, the NF membrane may remove micro-pollutants including, for example, per- and polyfluoroalkyl substances (PFAS), commonly referred to as “forever chemicals.” Representative PFAS compounds that may be removed with the NF membrane may include perfluorobutane sulfonate (PFBS), perfluorohexanesulfonic acid (PFHxS), perfluorooctanoic acid (PFOA), perfluorooctane sulfonic acid (PFOS), perfluorodecanoic acid (PFDA), perfluoroheptanoic acid (PFHpA), and/or perfluorononanoic acid (PFNA). The NF membrane may be treated, processed, or designed to remove at least about 95% to about 100% of total PFAS compounds present in the inlet water provided to the water treatment system 300. In other instances, the NF membrane may be treated, processed, or designed to remove at least about 95% to about 100% of total PFAS compounds present in the prefiltered water provided to the membrane element 334. For example, the NF membrane may be treated, processed, or designed to remove at least about 95%, or at least about 96%, or at least about 97%, or at least about 98%, or at least about 99%, or at least about 99.5%, or at least about 99.9%, or about 100% of total PFAS compounds present in the inlet water and/or the prefiltered water provided to the membrane element 334.

In some embodiments, the NF membrane may be treated, processed, or designed to remove pollutants, for example, heavy metals, while further achieving one or more of the disclosed calcium rejection percentage, total hardness rejection percentage, TDS rejection percentage, alkalinity rejection percentage, permeate stream pH value, and calculated LSI/CPP values (and/or other index values). In some embodiments, the NF membrane may remove heavy metals including, for example, copper, lead, arsenic, chromium, and iron. The NF membrane may be treated, processed, or designed to remove at least about 70%, or at least about 80%, or at least about 85%, or at least about 90%, or more than 95% of the heavy metals present in the inlet water provided to the water treatment system 300. The NF membrane may be treated, processed, or designed to remove at least about 70%, or at least about 80%, or at least about 85%, or at least about 90%, or more than 95% of the heavy metals present in the prefiltered water provided to the membrane element 334. In further instances, the NF membrane may be treated, processed, or designed to remove substantially all or all of the heavy metals from a water stream provided to the NF membrane. For example, the NF membrane may be treated, processed, or designed to remove or at least about 70%, or at least about 75%, or at least about 80%, or at least about 85%, or at least about 90%, or at least about 95%, or at least about 96%, or at least about 97%, or at least about 98%, or at least about 99%, or about 100% of the heavy metals present in the water provided to the membrane element 334 (e.g., the prefiltered water or the inlet water provided to the water treatment system 300).

In some embodiments, operation of the water treatment system 300 may be tailored to provide desired permeate characteristics when the membrane element 334 comprises the disclosed NF membrane. In some cases, rejection characteristics of the membrane element 334 may be selectively adjusted, for example, by adjusting a recovery of the water treatment system 300 with the flow restrictor tube 339 and/or an adjustable flow retentate valve (e.g., a needle valve). Generally, by selectively increasing a recovery percentage of the water treatment system 300, levels of calcium, total hardness levels (e.g., Ca²⁺ and Mg²⁺ ion concentrations), and/or a TDS level may be increased to a desired level to achieve a desired balance for the permeate stream (e.g., a permeate water imparted with a desired taste, a permeate water exhibiting reduced or no scale formation downstream of the membrane element 334). Representative, non-limiting examples for operating water treatment system 300 using a transmembrane pressure differential of 150 psi are illustrated in the Table below.

TABLE 2
Recovery Percentage vs. TDS Rejection Percentage

| | Flow Rate | Recovery | TDS Rejection |
|---|---|---|---|
| Example | (gpm @ 25° C.) | Percentage | Percentage |
| 1 | 4.72 | 49.71 | 89.81 |
| 2 | 4.38 | 79.72 | 73.74 |
| 3 | 4.07 | 90.51 | 61.99 |

Thus, as shown in Table 2, the performance of the treated, processed, or designed NF membrane element may be further tailored when used in the water treatment system 300, such that a balanced or desired permeate water stream can be produced.

In embodiments of the water treatment system 300 in which the membrane element 334 comprises the disclosed NF membrane, various design changes may be incorporated into the water treatment system 300 to reduce system complexity and cost of the water treatment system 300. In some embodiments of the water treatment system 300 utilizing the treated, processed, or designed NF membrane, various post-treatment elements may no longer be desired or necessary. For example, when the NF membrane has been treated to provide the disclosed calcium, total hardness and/or TDS rejection percentages, the resulting permeate stream may be imparted with taste characteristics that reduce or eliminate the need for a post-filtration remineralization unit (e.g., the mineralization unit 380 may be omitted from the water treatment system 300). This may especially be true in instances where the source water is an aquifer that may have naturally elevated levels of calcium and TDS.

In other embodiments, when the NF membrane has been treated, processed, or designed to provide a desired pH range for the permeate stream, post-treatment pH adjustment for the permeate stream may be lessened or completely eliminated. In some embodiments, when the NF membrane has been treated to provide a desired membrane permeance and/or permeate flow rate, the membrane element 334 may be constructed with a lower membrane surface area and/or a smaller overall footprint, thereby reducing manufacturing costs of the membrane element 334 and casing the installation of the membrane element 334 in residential settings. In some embodiments, the NF membrane may allow for use of a smaller pump and/or lower pump pressure in the water treatment system 300, while still producing similar water output compared to an RO system.

It is to be understood that, while the treated, processed, or designed NF membrane discussed above has been described with reference to the membrane element 334 and the water treatment system 300, the NF membrane element may be used as part of any of the membrane elements and water treatment systems (e.g., the water treatment systems 100, 200), and variations thereof, described herein.

In addition, the treated, processed, or designed NF membrane described above may be used in other membrane filtration systems that do not utilize flow-through tanks. For instance, said NF membranes may be used in membrane filtration systems that utilize atmospheric storage tanks or bladder tanks. Additionally, the NF membrane can be utilized in systems that do not utilize permeate storage tanks, which are also known as “tankless” systems.

Varying the membrane type, the membrane size, treatments applied to the membrane, processing applied to the membrane, and/or the design of the membrane may be used to optimize the level of permeate production, allowing for enhanced water recovery, while at the same time balancing factors such as providing a permeate stream imparted with a particular permeate water chemistry (whereby a “balanced” permeate water may be produced) and health of the membrane. For example, in some embodiments, including at least one NF membrane as a first or second membrane in a series may allow for higher total permeate output as compared to utilizing two RO membranes. In other embodiments, including two or more RO membranes in series may help maintain a higher velocity on the feed side of the individual membranes, which in turn may reduce ion concentration at the membrane surface of each membrane. In addition, including two or more RO membranes in series may enable operation of the individual RO membranes at different membrane recoveries, which may help optimize permeate production as dissolved mineral content increases.

In further embodiments, using a smaller membrane as a second membrane in a series of membranes, where the first membrane has a larger diameter than the diameter of the second membrane, may allow the water entering the second membrane to have a higher velocity, which may boost overall water recovery. For instance, in some embodiments, if the water treatment system 300 is operating at an approximately 80% recovery, and a spiral wound 4040 RO membrane is used as the first membrane in a series of membranes and a spiral wound 2540 RO membrane is used as a second membrane in the series of membranes, the total water recovery of the water treatment system 300 may be increased to at least about a 94% recovery.

The membrane element 334 may be in fluid communication with the membrane feed line 332 on a feed side (not shown) of the membrane element 334. The membrane element 334 also may be in fluid communication with the retentate line 336 on the feed side of the membrane element 334. The membrane element 334 may be in fluid communication with a membrane permeate line 338 on a permeate side (not shown) of the membrane element 334.

In some embodiments, as the prefiltered water (with or without additive) enters the feed side of the membrane element 334, the membrane element 334 may allow a solvent (e.g., water) in the prefiltered water to pass through a surface of a membrane (not shown) retained within the membrane element 334. The solvent that passes through the surface of the membrane may exit from the permeate side of the membrane element 334 as membrane permeate via the membrane permeate line 338. Solutes (e.g., dissolved minerals and ions and various organic compounds) in the prefiltered water may not pass through the membrane and may be retained at the surface of the membrane. The solutes may be discharged from the feed side of the membrane element 334 as retentate via the retentate line 336.

In some embodiments, when the pump 330 is activated, the pump 330 may increase the rate at which water flows into the membrane feed line 332 toward the membrane element 334. Increasing the flow rate of water into the membrane feed line 332 may increase pressure in the membrane feed line 332. The increased pressure may in turn aid in pushing solvent in the membrane feed line 332 through the pores formed within the surface of the membrane retained within the membrane element 334.

The water treatment system 300 may include a flow restrictor tube 339 that may be in fluid communication with the retentate line 336. The flow restrictor tube 339 may be used to control or regulate the amount of retentate leaving the water treatment system 300 via the retentate line 336 into a drain 341. In some embodiments, the flow restrictor tube 339 may be a capillary tube imparted with an inner diameter of at least about 1/16 inches (at least about 1.6 mm) to no more than about ⅛ inches (no more than about 3.2 mm). In some embodiments, the flow restrictor tube 339 may be imparted with a length of at least about 1 inch (at least about 2.5 centimeters) to at least about 4 feet (at least about 122 cm). For example, the flow restrictor tube 339 may be imparted with a length of no less than 1 foot (30.5 centimeters) and no more than 3 feet (91.4 centimeters). In some embodiments, the flow restrictor tube 339 may be provided in the form of material that has a low energy surface to prevent the formation of scale on the surface of the flow restrictor tube 339, given that retentate may be beyond the saturation limit of the water. For example, the flow restrictor tube 339 may be made from polyethylene tubing. In further embodiments, a valve may be used instead of or in combination with the flow restrictor tube 339. The amount of retentate exiting the water treatment system 300 into the drain 341 may increase or decrease the water pressure in the water treatment system 300.

The water treatment system 300 may include a second TDS sensor 316b that may be in fluid communication with the retentate line 336. The second TDS sensor 316b may measure, monitor, or sense the conductivity of the retentate to determine an amount or concentration of dissolved solids in the retentate.

The water treatment system 300 may include one or more flowmeters 314. In some embodiments, the one or more flowmeters 314 may be provided as a mechanical flowmeter or an ultrasonic flowmeter. In some embodiments, the one or more flowmeters may include a ⅜ inch (0.95 centimeters) F-nut inflow connector, a ⅜ inch (0.95 centimeters) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 314 may be a 0.26-16 GPM turbine flowmeter, a 0.26-7.9 GPM turbine flowmeter, or a 0.26-0.65 turbine flowmeter. One of ordinary skill in the art would understand that each of the one or more flowmeters 314a-314c may be the same type of flowmeter or may each be a different type of flowmeter.

The water treatment system 300 may include a first flowmeter 314a. The first flowmeter 314a may be positioned within or otherwise in fluid communication with the retentate line 336 and the drain 341. The third flowmeter may measure, monitor, or sense the flow rate of the retentate in the retentate line 336.

The membrane permeate line 338 may be connected to or otherwise in fluid communication with a tank line 344. The tank line 344 may be in fluid communication with the top portion 318c of the tank 318. The tank line 344 also may be connected to or otherwise in fluid communication with an outlet feed line 346. The outlet feed line 346 may be in fluid communication with the outlet 348 of the water treatment system.

In some embodiments, depending on flow conditions when the water treatment system 300 is in use, the membrane permeate may flow directly from the permeate side of the membrane element 334 through the membrane permeate line 338 and the tank line 344 into the top portion 318c of the tank 318. The membrane permeate may be stored in the tank 318. The membrane permeate may also flow from the permeate side of the membrane element 334 through the membrane permeate line 338 to the tank line 344, into the outlet feed line 346 (thereby bypassing the tank 318), and out of the outlet 348. By enabling the flow of membrane permeate from the membrane element 334 directly to the outlet 348, membrane permeate may be provided to a point of use in real time.

Due to the amount of dissolved ions in high TDS water, high TDS water tends to have a higher density than low TDS water. By sending higher TDS water (e.g., the prefiltered water) to the bottom portion 318a of the tank 318 and lower TDS water (e.g., the membrane permeate) to the top portion 318c of the tank 318, the chances of water with different TDS amounts or concentrations mixing inside the tank 318 may be minimized. Thus, when water is later drawn from the top portion 318c of the tank 318, low TDS water may be provided to a point of use. Sending higher TDS water to the bottom of the tank 318 and lower TDS water to the top of the tank 318 may also create a sharp TDS profile along the vertical height of the tank 318, where the amount or concentration of TDS at the bottom portion 318a of the tank 318 is the highest (e.g., a TDS concentration of more than or about 3.5 grains per gallon (60 milligrams per liter)), and the amount or concentration of TDS at the top portion 318c of the tank 318 is the lowest (e.g., a TDS concentration of less than or about 3.5 grains per gallon (60 milligrams per liter)). Creating and maintaining this sharp TDS profile may be aided by the density difference between the high TDS water and the low TDS water.

The water treatment system 300 may include a third valve 342a that may be in fluid communication with the membrane permeate line 338. In some embodiments, the third valve 342a may be a check valve. In some embodiments, the third valve may be a butterfly valve, a ball valve, a globe valve, a pressure relief valve, or a gate valve.

The third valve 342a may be used to control or regulate the amount of membrane permeate entering or flowing through the membrane permeate line 338 into the tank line 344 and into the top portion 318c of the tank 318 or out of the outlet 348 via the outlet feed line 346. The third valve 342a may open, either partially or fully, to enable or increase the flow or the amount of membrane permeate flowing through the membrane permeate line 338 to the tank line 344, and into the top portion 318c of the tank 318 or into the outlet feed line 346 and out of the outlet 348. The third valve 342a may close, either partially or fully, to stop or decrease the amount of membrane permeate flowing through the membrane permeate line 338 and the tank line 344, into the top portion 318c of the tank 318 or into the outlet feed line 346 and out of the outlet 348. The amount of membrane permeate entering or flowing through the membrane permeate line 338 and into the tank 318 or out of the outlet 348 may increase or decrease the water pressure in the water treatment system 300. In some instances, the third valve 342a may be a check valve that is used to prevent backflow through the tank line 344, which in turn may help protect the membrane element 334.

A second flowmeter 314b may be positioned within or otherwise in fluid communication with the tank line 344. The second flowmeter 314b may measure, monitor, or sense the flow rate of the prefiltered water through the tank line 344.

In some embodiments, the tank 318 may include a third TDS sensor 316c disposed in the top portion 318c, a fourth TDS sensor 316d disposed in the center portion 318b of the tank 318, and/or a fifth TDS sensor 316e disposed in the bottom portion 318a of the tank 318. The third TDS sensor 316c may measure, monitor, or sense the conductivity of the water in the top portion 318c of the tank 318 to determine an amount or concentration of dissolved solids in the water located in the top portion 318c of the tank 318. The fourth TDS sensor 316d may measure, monitor, or sense the conductivity of the water in the center portion 318b in the tank 318 to determine an amount or concentration of dissolved solids in the water located in the center portion 318b of the tank 318. The fifth TDS sensor 316e may measure, monitor, or sense the conductivity of the water in the bottom portion 318a of the tank 318 to determine an amount or concentration of dissolved solids in the water located in the bottom portion 318a of the tank 318. The third, fourth, and fifth TDS sensors (316c, 316d, and 316e, respectively) may create a profile of the TDS levels or concentrations of the water in the tank 318.

In some embodiments, the tank 318 may include zero, one, two, or more TDS sensors disposed in each of the top, center, or bottom portions of the tank 318. For example, in some embodiments, a TDS sensor may only be disposed in the center portion 318b of the tank, not the top portion 318c or the bottom portion 318a. In other embodiments, a TDS sensor may be disposed in each of the top portion 318c and the bottom portion 318a of the tank 318, but not the center portion 318b. In further embodiments, zero TDS sensors may be disposed in the tank 318.

The water (i.e., membrane permeate (lower TDS) or the prefiltered water (higher TDS)) that may be stored in the tank 318 may flow through the tank line 344 and the outlet feed line 346 out of the outlet 348. The outlet 348 may be in fluid communication with various appliances, fixtures, and plumbing of the residential or commercial property. In some embodiments, the outlet 348 may be in fluid communication with a water heater, faucets, fixtures, or toilets via one or more pipes or tubes.

The water treatment system 300 may include a third flowmeter 314c positioned within or otherwise in communication with the outlet feed line 346. The third flowmeter 314c may measure, monitor, or sense the flow rate of the water in the outlet feed line 346.

The water treatment system 300 may include a fourth pressure sensor 306d in communication with the outlet feed line 346. The fourth pressure sensor 306d may measure, monitor, or sense the pressure of the water in the outlet feed line 346.

The water treatment system 300 may include a sixth TDS sensor 316f in communication with the outlet feed line 346. The sixth TDS sensor 316f may measure, monitor, or sense the conductivity of the water in the outlet feed line 346 to determine an amount or concentration of the dissolved solids in the water in the outlet feed line 346.

The water treatment system 300 may include a fourth valve 308b that may be in fluid communication with the outlet feed line 346. In some embodiments, the fourth valve 308b may be a gate valve. In some embodiments, the fourth valve 308b may be a bypass valve, a solenoid valve, a butterfly valve, a ball valve, a globe valve, a pressure relief valve, or a check valve.

The fourth valve 308b may be used to control or regulate the amount of water (e.g., membrane permeate or prefiltered water) flowing from the tank 318, through the tank line 344, into the outlet feed line 346, and out of the outlet 348 or from the membrane element 334, through the tank line 344, into the outlet feed line 346, and out of the outlet 348. The fourth valve 308b may open, either partially or fully, to enable or increase the flow or the amount of water from the tank 318 or the membrane element 334, through the tank line 344, into the outlet feed line 346, and out of the outlet 348. The fourth valve 308b may close, either partially or fully, to stop or decrease the amount of water flowing from the tank 318 or the membrane element 334, through the tank line 344, into the outlet feed line 346, and out of the outlet 348. The amount of water flowing through the outlet feed line 346 and out of the outlet 348 may increase or decrease the water pressure in the water treatment system 300.

Preferably, the first valve 308a and the fourth valve 308b are provided as on/off valves that may substantially or completely stop the flow of water through the system 300. In such embodiments, the first valve 308a and the fourth valve 308b may be provided as ball valves, solenoid valves, or other similarly functioning valves.

The water treatment system 300 may include a permeate flush line 352. The permeate flush line 352 may be physically connected to or otherwise in fluid communication with the tank line 344 and the additive line 326. In some embodiments, the permeate flush line 352 may be physically connected to or otherwise in fluid communication with the tank line 344 and the pump 330. In some embodiments, the permeate flush line 352 may be in fluid communication with the membrane permeate line 338. In some embodiments, the permeate flush line 352 may be connected or coupled to any conduit of the water treatment system 300 that is downstream of the second valve 329a (e.g., the membrane feed line 332).

The water treatment system 300 may include an optional fifth valve 342b that may be in fluid communication with the permeate flush line 352. In some embodiments, the fifth valve 342b may be a check valve. In some embodiments, the fifth valve 342b may be a butterfly valve, a ball valve, a globe valve, a pressure relief valve, or a gate valve.

The optional fifth valve 342b may be used to control or regulate the amount of membrane permeate entering or flowing into and through the permeate flush line 352 from the tank line 344. The fifth valve 342b may open, either partially or fully, to enable or increase the flow or the amount of membrane permeate flowing from the top portion 318c of the tank 318, into the tank line 344, and through the permeate flush line 352. The fifth valve 342b may close, either partially or fully, to stop or decrease the amount of membrane permeate flowing from the top portion 318c of the tank 318, into the tank line 344, and through the permeate flush line 352. The amount of membrane permeate entering or flowing through the permeate flush line 352 may increase or decrease the water pressure in the water treatment system 300.

The water treatment system 300 may include a sixth valve 329b that may be in fluid communication with the permeate flush line 352. In some embodiments, the sixth valve 329b may be an actuated ball valve. In some embodiments, the sixth valve 329b may be a gate valve, a butterfly valve, a globe valve, a pressure relief valve, or a check valve.

The sixth valve 329b may be used to control or regulate the amount of membrane permeate flowing through the permeate flush line 352 and into the membrane feed line 332 and, eventually, to the retentate line 336 via the membrane element 334. The sixth valve 329b may open, either partially or fully, to enable or increase the flow or the amount of membrane permeate flowing from the permeate flush line 352 into the membrane feed line 332 and the retentate line 336 via the membrane element 334. The sixth valve 329b may close, either partially or fully, to stop or decrease the amount of membrane permeate flowing from the permeate flush line 352 into the membrane feed line 332 and the retentate line 336 via the membrane element 334. The amount of membrane permeate flowing through the permeate flush line 352 to the membrane feed line 332 and the retentate line 336 via the membrane element 334 may increase or decrease the water pressure in the water treatment system 300.

In some embodiments, depending on flow conditions, when the water treatment system 300 is in use, membrane permeate from the top portion 318c of the tank 318 may flow through the tank line 344 and the permeate flush line 352 into the membrane feed line 332 toward the membrane element 334. The membrane permeate may be recirculated through the membrane feed line 332 and into the feed side of the membrane element 334. The recirculation of the membrane permeate through the membrane feed line 332 may be aided by the pump 330 when activated or may be caused by pressure within the water treatment system 300 when the pump 330 is turned off. The membrane permeate may be used to clean the membrane element 334 by flushing solutes (e.g., ions) from the surface of the membrane element 334. The membrane permeate used to clean or flush the surface of the membrane element 334 may then be discharged through the retentate line 336.

In some embodiments, the second valve 329a may be closed and the optional fifth valve 342b and the sixth valve 329b may be opened. In such instances, the pump 330 could be activated such that membrane permeate from the membrane element 334 may flow directly from the membrane element 334 to the permeate flush line 352, through the membrane feed line 332 and into the membrane element 334 to clean or flush the surface of the membrane element 334.

The water treatment system 300 may include an optional remineralization system 380 containing a remineralization material. The remineralization material may be provided as a calcium-containing compound or a magnesium-containing compound, although other ionic compounds could also be used to increase the mineral or TDS concentration of the water provided by the system 300 to a point of use. The remineralization material may be, for example, a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In each example, the remineralization material may be provided in the form of a solid, an aqueous solution, a combination of solids (e.g., if more than one remineralization material is provided), and a combination of aqueous solutions (e.g., if more than one remineralization material is provided). In some instances, the remineralization compound may be selected from the group consisting of a calcium chloride compound (CaCl₂)), a magnesium chloride compound (MgCl₂), a sodium chloride compound (NaCl), a potassium chloride compound (KCl), a magnesium citrate compound, a sodium hydroxide compound (NaOH), a potassium hydroxide compound (KOH), a magnesium sulfate compound (MgSO₄), a calcium sulfate compound (MgSO₄), a calcium carbonate compound (CaCO₃), a magnesium carbonate compound (MgCO₃), a magnesium oxide compound (MgO), a calcium oxide compound (CaO), a sodium carbonate compound (Na₂CO₃), a sodium bicarbonate compound (NaHCO₃), a potassium carbonate compound (K₂CO₃), a potassium bicarbonate compound (KHCO₃), dolomite (CaMg(CO₃)₂), a magnesium oxysulfate cement, other substances with similar chemical and physical properties, and combinations thereof. In instances where the remineralization material includes a calcium carbonate compound, the calcium carbonate may be provided in the form of calcite. In some instances, the remineralization material as described herein may be provided in the form of a solid, such as a solid block or a powder, or as an aqueous solution.

In some embodiments, the remineralization material may be contained in a device including an inlet and an outlet through which water passes. For example, the remineralization system 380 may include a remineralization unit 380a (also referred to as a reservoir 380a) that is designed to store the remineralization material. In some cases, the reservoir 380a and/or the remineralization material may be replaced when the remineralization material is depleted. In some embodiments, the reservoir 380a may be provided in the form of a bed or cartridge. The reservoir 380a may be disposed on a line (e.g., outlet feed line 346) or another system component of the water treatment system 300, which water passes by but does not flow through.

The reservoir 380a may take the form of a cylinder, although in other embodiments the reservoir 380a may be provided in the form of a different three-dimensional shape (e.g., as a cube, rectangular prism, pyramid, conc, etc.). In some embodiments, the reservoir 380a may include one or more end caps, such as a first end cap coupled to a first end of the reservoir 380a, and a second end cap coupled to a second end of the reservoir 380a opposite the first end. In such instances, the first end cap may define the inlet of the reservoir 380a and thus define a flow path for incoming nonmineralized water, which may exit from an outlet defined in the second end cap.

In some embodiments, at least one of the first end cap and the second end cap may be integrally formed with and thus irremovable from the reservoir 380a. In such instances, upon depletion of the remineralization material, the reservoir 380a may need to be replaced with a new reservoir 380a containing a fresh source of remineralization material, whether in a powder, block, or aqueous form. In other instances, the reservoir 380a may be removable from one or more of the end caps and may thereby be removed upon depletion of the remineralization material. In such instances, the reservoir 380a may be refilled with a fresh stock of the powder, block, or aqueous form of the remineralization material and reused in the remineralization system 380.

In some embodiments, the reservoir 380a may include one or more internal sensors for detecting a filled volume, an amount of remineralization material, and/or a water level of the reservoir 380a. The one or more sensors may be in electronic communication with the controller 394 and indicate when the reservoir 380a may need to be refilled and/or replaced. For example, in some instances, the one or more sensors may be set to produce an alert or notification when at least about 80% of the remineralization material has been depleted. In other instances, the one or more sensors may be set to produce an alert or notification when about at least 20%, or at least about 25%, or at least about 30%, or at least about 40%, or at least about 45%, or at least about 50%, or at least about 60%, or at least about 70%, or at least about 75%, or at least about 85%, or at least about 90%, or at least about 95%, or at least about 99% of the remineralization material has been depleted. In yet other instances, the one or more sensors may be set to produce an alert or notification when at least 20%, or at least 25%, or at least 30%, or at least 40%, or at least 45%, or at least 50%, or at least 60%, or at least 70%, or at least 75%, or at least 80%, or at least 85%, or at least 90%, or at least 95%, or at least 99% of the remineralization material has been depleted.

The remineralization inlet may be configured to place the reservoir 380a of the remineralization system 380 in fluid communication with the line to which the remineralization system 380 is coupled. In general, the remineralization system 380 may be configured to place the entering water stream in contact with the remineralization material to generate a remineralized water stream (also referred to as a “remineralized stream”) that discharges from the remineralization system 380 through the remineralization outlet. The remineralized stream may thus include a TDS content that is greater than the permeate stream. As the permeate stream contacts and/or flows through the remineralization material, the remineralization material may be designed to degrade or dissolve within the remineralization system 380 over time, resulting in a remineralized stream enriched in minerals and additives.

The remineralization system 380 may generally be disposed on or coupled to various system components or lines of the system 300 that are positioned downstream of the membrane element 334. In some embodiments, the remineralization system 380 may be disposed on or coupled to the outlet feed line 346 upstream of the outlet 348. The remineralization system 380 may introduce the remineralization material to the membrane permeate before the membrane permeate exits the water treatment system 300 via the outlet 348. In some embodiments, the remineralization system 380 may be disposed on the membrane permeate line 338 or the tank line 344. For example, the remineralization system 380 may be disposed on the membrane permeate line 338 or the tank line 344 proximate to the tank 318 so that the membrane permeate is introduced to the remineralization material before the membrane permeate flows into the top portion 318c of the tank 318. In other embodiments, the remineralization system 380 may be disposed within a top portion 318c of the tank 318 so that the membrane permeate is introduced to the remineralization material as the membrane permeate flows into or out of the top portion 318c of the tank 318. In further embodiments, the remineralization system 380 may be disposed within a top portion 318c of the tank 318 so that the membrane permeate contacts the remineralization material in the remineralization system 380 while the membrane permeate is stored in the tank 318, including during periods when there is no flow of membrane permeate into or out of the tank 318. In such instances, the remineralization system 380 may be disposed within the top portion 318c of the tank 318 by coupling the reservoir 380a to an internal surface of the tank 318. In such instances, the reservoir 380a may be removably or irremovably coupled to the internal surface using one or more direct attachment means (such as welding of the reservoir 380a to the internal surface) or indirect attachment means (such as with use of a mounting bracket).

In embodiments where the remineralization material is provided as a solid block (e.g., as a block of calcite), the remineralization material may be coupled to one of the lines or another system component of the water treatment system 300 without an outer reservoir or cartridge. For example, a solid block may be disposed within the tank 318 via coupling to an internal surface of the tank 318 using one or more indirect attachment means (i.e., a mounting bracket or holding mechanism). In such instances, water may be directed to pass through or proximate to the remineralization material upon entering the tank 318, increasing the contact time between the water and remineralization material (e.g., during no flow situations). Furthermore, removing the cartridge surrounding the remineralization material may additionally contribute to reducing the overall footprint of the system 300.

In some instances, a single pass of the permeate water through the reservoir 380a may be insufficient to achieve the desired TDS or pH of the permeate water. In such instances, the system 300 may optionally include a recirculation line 384, and the permeate water may be recirculated through the reservoir 380a as many times (e.g., more than once) as necessary to achieve the desired TDS concentration and pH. For example, the permeate water may be recirculated through the reservoir 380a once, twice, three times, four times, and so on. In some cases, the recirculation line 384 may be provided with or in fluid communication with a recirculation valve designed to control the flow of fluid through the recirculation line (and thus the number of times the permeate stream is recirculated through the reservoir 380a). In some instances, the output of the recirculated permeate water may be provided to the tank 318 via a conduit (not illustrated). In some instances, the output of the recirculated permeate water may be provided to the outlet 348 of the water treatment system 300 and to a point of use.

In embodiments where the remineralization material is provided as an aqueous solution, the remineralization system may be coupled to one of the lines or another system component of the water treatment system 300. In addition, the remineralization system 380 may be in fluid communication with a remineralization pump 380b and/or a dosing mechanism designed to dose the remineralization material (e.g., a mineral solution) to the permeate water. In some instances, the system 300 includes more than one remineralization pump 380b. For example, in some cases, the remineralization system 380 may be positioned in-line with an outlet feed line 346. The outlet feed line 346 may be designed to deliver remineralized water to the outlet of the system 300. In other cases, as shown in FIG. 4F, the remineralization pump 380b may dose water with the remineralization material to a mixing point 383 positioned on the outlet feed line 346. In some instances, the remineralization pump 380b may be designed to add specific concentrations and/or amounts of the remineralization material (e.g., in the form of aqueous solutions) to the permeate water. In some instances, the system 300 may include a bypass conduit that routes at least a portion of the permeate water around the remineralization system 380.

In some embodiments, the remineralization pump 380b may be a single-phase or a multi-phase booster pump. In other embodiments, the remineralization pump 380b may be defined by a diaphragm pump, a peristaltic pump, a piston pump, or a solenoid-driven pump. The remineralization pump 380b may be in electronic communication with the controller 394 and be actuated upon receipt of a command from the controller 394.

In some instances, sodium bicarbonate (or another remineralization material including, but not limited to, a calcium chloride compound, a magnesium chloride compound, a sodium chloride compound, a potassium chloride compound, a magnesium citrate compound, a sodium hydroxide compound, a potassium hydroxide compound, a calcium sulfate compound, a magnesium sulfate compound, a calcium carbonate compound, a magnesium carbonate compound, a magnesium oxide compound, a calcium oxide compound, and dolomite) may be added via the remineralization system 380 to the permeate water before, after, and/or when the system is processing water through the membrane element 334.

In some instances, the water treatment system 300 comprises a first valve in communication with the remineralization system 380 in which the first valve meters an amount of the permeate provided to the remineralization system 380 and/or the amount of a remineralized aqueous solution dosed to the output water of the system 300. In additional instances, the system 300 may place the controller 394 in electronic communication with a sensor associated with the first valve and the first valve itself, in which the controller 394 may be designed to actuate the first valve in response to the measured values obtained from the associated sensor. In multiple instances, the first valve may be configured as any suitable valve. In further instances, the first valve may be configured as a blend back valve.

As shown in FIGS. 4A-4E, the remineralization system 380 may include a blend back valve 380c. The blend back valve 380c may be designed to provide an amount of prefiltered water via a blend back conduit 382 to the permeate water to achieve a target TDS value, a target alkalinity value, and/or a target pH value. In some cases, the target TDS value, the target alkalinity value and/or the target pH value may be at least partially based on the characteristics of the feed water or the prefiltered water. In addition, the incorporation of the blend back valve 380c providing an amount of prefiltered water to the permeate water may allow the system 300 to produce water at a higher rate of delivery in addition to achieving the target TDS value, the target alkalinity value and/or the target pH value.

The blend back valve 380c may be in fluid communication with one or more conduits that are in fluid communication with the prefiltered water. In addition, the blend back valve 380c may be in fluid communication with one or more conduits carrying the permeate stream. In some non-limiting cases, the blend back valve 380c may be positioned on or proximate to a blend back conduit 382 that is positioned between an additive line and an outlet feed line (see, e.g., the example coupling of the blend back conduit to the additive line 326 and the outlet feed line 346 in FIGS. 4A-4D). In other non-limiting cases, the blend back valve 380c may be positioned on or proximate to a blend back conduit 382 that is positioned between a membrane feed line (e.g., the membrane feed line 332) and a membrane permeate line (e.g., the membrane permeate line 338 in FIG. 4A). In yet other non-limiting cases, the blend back valve 380c may be positioned on or proximate to a blend back conduit 382, where the blend back conduit 382 is positioned between the additive line (see, e.g., additive line 326 in FIG. 4A) and either upstream of a valve coupled to the additive line (as shown in relation to, e.g., the second valve 329a in FIG. 4A) or downstream of a valve coupled to the additive line (as shown in relation to, e.g., the second valve 329a in FIGS. 4B-4E).

In certain cases, the blend back line 382 may be coupled to an outlet line of the system 300 upstream of a post-filtration unit. For example, the blend back line 382 may be coupled to the outlet feed line 346 upstream of the post-filtration unit 350 (see FIGS. 4B and 4D). In other cases, the blend back line 382 may be coupled to an outlet line of the system 300 downstream of a post-filtration unit. For example, the blend back line 382 may be coupled to the outlet feed line 346 downstream of the post-filtration unit 350 (see FIG. 4C).

In some instances, the blend back valve 380c and the blend back line 382 may be in fluid communication with one or more tanks of the system 300. For example, as shown in FIG. 4E, the blend back valve 380c and the blend back line 382 may be in fluid communication with the tank 318 and/or the second tank 360. More specifically, the blend back line 382 may be coupled to the tank connector line 362. Thus, the blend back valve 380c may provide prefiltered water to the tank 318 and/or the second tank 360. As such, the permeate water stored in the tank 318 and/or the second tank 360 may be remineralized.

In some instances, as shown in FIG. 4F, the blend back valve 380c may also be provided in systems that include a remineralization pump (e.g., the remineralization pump 380b). In such instances, the blend back line 382 may be coupled to the outlet feed line 346 upstream of the mixing point 383 (as shown in FIG. 4F) or downstream of the mixing point 383.

It is to be understood that the blend back line 382 may be coupled to or in fluid communication with any conduit described herein that is designed to carry the feed water and/or the prefiltered water, in addition to any conduit described herein that is designed to carry the permeate water.

It is also to be understood that, in instances in which the blend back valve 380c is provided proximate to the blend back line 382, one or more additional conduits may couple the blend back valve 380c to the blend back line 382.

In some embodiments, the blend back valve 380c may be a needle valve. In some embodiments, the blend back valve 380c may be an actuated ball valve, a gate valve, a butterfly valve, a globe valve, a pressure relief valve, or a check valve. In some instances, the amount of feed water added to the permeate water via the blend back valve 380c may be automated and controlled (e.g., via the controller 394). In such instances, one or more sensors in communication with the controller 394 (e.g., at least one TDS sensor 316 and/or one or more pH sensor 390)) may provide information to the controller regarding one or more characteristics of the feed water, the prefiltered water, and/or the membrane permeate.

In various instances, the blend back valve 380c may be provided in the form of a variable valve controlled by feedback from one or more TDS sensors (i.e., the at least one TDS sensor 316) and/or one or more pH sensors (i.e., the one or more pH sensor 390) installed in the system 300. This may allow for real-time adjustments to deliver the desired water chemistry profile.

The remineralization material introduced or otherwise provided by the remineralization system 380 via the reservoir 380a, block of remineralization material, and/or remineralization pump 380b or dosing mechanism may change at least one quality or characteristic of the membrane permeate such as the pH level and/or the TDS level. Changing at least one quality or characteristic of the membrane permeate may improve the aesthetics (e.g., taste) of the membrane permeate and/or reduce the possible corrosion of metal plumbing and appliances downstream from the water treatment system 300. Generally, one or more TDS sensors and/or one or more pH sensors may be positioned upstream and/or downstream of the remineralization system 380. In some embodiments, one or more TDS sensors may be disposed proximate to, adjacent to, and/or in fluid communication with the remineralization system 380 to monitor the TDS level of the membrane permeate before and/or after the membrane permeate passes by or through the remineralization system 380. In some cases, the one or more TDS sensors may be provided in the form of ion-selective electrodes. The ion-selective electrodes may be designed to detect one or more ions in a water stream that may impact a measured TDS or alkalinity value. For example, the one or more TDS sensors may be provided in the form of an ion-selective electrode designed to detect calcium ions, an ion-selective electrode designed to detect magnesium ions, an ion-selective electrode designed to detect alkalinity values, and the like. Additionally, or alternatively, the one or more pH sensor 390 may be disposed proximate to, adjacent to, and/or in fluid communication with the remineralization system 380 to monitor the pH level of the membrane permeate before and/or after the membrane permeate passes by or through the remineralization system 380. The one or more pH sensor 390 may be fluidly coupled to a particular line and be positioned downstream of the remineralization system 380. Further, the system 300 may include one or more additional sensors adapted to measure a different quality or characteristic of the remineralized or prefiltered water. In some embodiments, the blend back valve 380c may be positioned downstream of the one or more pH sensor 390.

In various instances, the controller 394 may also be in communication with the reservoir 380a, the remineralization pump 380b, and/or the blend back valve 380c in order to control their functions and output. In some instances, the controller 394 may be used to control the amount of additive dosed by the remineralization pump 380b (e.g., sodium bicarbonate or other buffer solutions) such that the output water of the system 300 is imparted with a desired pH level. In some instances, the controller 394 may use feedback information (e.g., information obtained from the one or more pH sensor 390) in order to adjust for variations in the properties of the feed and permeate water. In other instances, a separate pH controller (not shown) may be used to control the dosing of aqueous sodium bicarbonate or other buffer solutions by the remineralization pump 380b in order to impart the output water of the system 300 with the desired pH level. In yet other instances, the pH controller may use feedback information (e.g., measurements from the pH sensor 390) in order to adjust for variations in the properties of the feed water, the permeate water, and/or permeate water. The remineralized membrane permeate may be imparted with a TDS concentration of at least about 50 ppm to at least about 500 ppm, or at least about 100 ppm to at least about 400 ppm. In some instances, the remineralized water may be imparted with a TDS concentration of at least about 50 ppm (or at least 50 ppm).

In various instances of the system 300, after the permeate stream is provided to the remineralization system 380, the permeate stream may be imparted with a third concentration of solutes that is greater than the first concentration of solutes of the permeate stream. In some instances, the first concentration of solutes of the permeate stream may be less than 60 ppm, although the first concentration of solutes may be somewhat less or greater than these values. The remineralized membrane permeate that exits the remineralization system 380 or that is created when the membrane permeate passes by or through the remineralization system 380 may be imparted with a third concentration of at least about 50 ppm to at least about 500 ppm, or at least about 100 ppm to at least about 400 ppm. In some instances, the remineralized water may be imparted with a third concentration of at least about 50 ppm (or at least 50 ppm).

In other embodiments, the remineralized membrane permeate that exits the remineralization system or that is created when the membrane permeate passes by or through the remineralization system may be imparted with a third concentration of at least 50 ppm to at least 500 ppm, or at least 100 ppm to at least 400 ppm. In some instances, the remineralized membrane permeate that exits the remineralization system 380 or that is created when the membrane permeate passes by or through the remineralization system 380 may be imparted with a third concentration of less than 50 ppm or greater than 500 ppm.

In some embodiments, the remineralized membrane permeate may be imparted with a third concentration of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more.

In other embodiments, the remineralized membrane permeate may be imparted with a third concentration of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more.

In some instances, the system 300 may target a particular TDS value (a “target TDS value”) for the remineralized water stream by taking one or more actions. For example, the controller 394 may direct the opening or closing of one or more valves (e.g., the blend back valve 380c) associated with a remineralization system 380, direct an amount of a remineralization material to be provided from a remineralization pump (e.g., the remineralization pump 380b), and/or direct a predetermined amount of water to flow past a remineralization material. In various cases, the target TDS value may be imparted with a value of at least about 10 ppm, or at least about 20 ppm, or at least about 30 ppm, or at least about 40 ppm, or at least about 50 ppm, or at least about 60 ppm, or at least about 70 ppm, or at least about 80 ppm, or at least about 90 ppm, or at least about 100 ppm, or at least about 110 ppm, or at least about 120 ppm, or at least about 130 ppm, or at least about 140 ppm, or at least about 150 ppm, or at least about 160 ppm, or at least about 170 ppm, or at least about 180 ppm, or at least about 190 ppm, or at least about 200 ppm, or at least about 210 ppm, or at least about 220 ppm, or at least about 230 ppm, or at least about 240 ppm, or at least about 250 ppm, or at least about 260 ppm, or at least about 270 ppm, or at least about 280 ppm, or at least about 290 ppm, or at least about 300 ppm, or at least about 310 ppm, or at least about 320 ppm, or at least about 330 ppm, or at least about 340 ppm, or at least about 350 ppm, or at least about 360 ppm, or at least about 370 ppm, or at least about 380 ppm, or at least about 390 ppm, or at least about 400 ppm, or at least about 450 ppm, or at least about 500 ppm, or at least about 600 ppm, or at least about 700 ppm, or at least about 800 ppm, or more. In various instances, the target TDS value may be imparted with a value of at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 110 ppm, or at least 120 ppm, or at least 130 ppm, or at least 140 ppm, or at least 150 ppm, or at least 160 ppm, or at least 170 ppm, or at least 180 ppm, or at least 190 ppm, or at least 200 ppm, or at least 210 ppm, or at least 220 ppm, or at least 230 ppm, or at least 240 ppm, or at least 250 ppm, or at least 260 ppm, or at least 270 ppm, or at least 280 ppm, or at least 290 ppm, or at least 300 ppm, or at least 310 ppm, or at least 320 ppm, or at least 330 ppm, or at least 340 ppm, or at least 350 ppm, or at least 360 ppm, or at least 370 ppm, or at least 380 ppm, or at least 390 ppm, or at least 400 ppm, or at least 450 ppm, or at least 500 ppm, or at least 600 ppm, or at least 700 ppm, or at least 800 ppm, or more

In further embodiments, the remineralized membrane permeate may be imparted with a pH value within drinkable limits (e.g., about 6.5 to about 10, or 6.5 to 10). In some embodiments, the remineralized membrane permeate may be imparted with a pH value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In some embodiments, the remineralized membrane permeate may be imparted with a pH value of 6.5, or at least 6.5, or at least 6.6, or at least 6.7, or at least 6.8, or at least 6.9, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

In some instances, the system 300 may target a particular pH value (a “target pH value”) for the remineralized water stream by taking one or more actions. For example, the controller 394 may direct the opening or closing of one or more valves (e.g., the blend back valve 380c) associated with a remineralization system 380, the amount of a remineralization material provided from a remineralization pump (e.g., the remineralization pump 380b) and/or may direct a predetermined amount of water to flow past a remineralization material. In various cases, the target pH value may be imparted with a value of about 6.5, or at least about 6.5, or at least about 6.6, or at least about 6.7, or at least about 6.8, or at least about 6.9, or at least about 7, or at least about 7.1, or at least about 7.2, or at least about 7.3, or at least about 7.4, or at least about 7.5, or at least about 7.6, or at least about 7.7, or at least about 7.8, or at least about 7.9, or at least about 8, or at least about 8.1, or at least about 8.2, or at least about 8.3, or at least about 8.4, or at least about 8.5, or at least about 8.6, or at least about 8.7, or at least about 8.8, or at least about 8.9, or at least about 9, or at least about 9.1, or at least about 9.2, or at least about 9.3, or at least about 9.4, or at least about 9.5, or at least about 9.6, or at least about 9.7, or at least about 9.8, or at least about 9.9, or less than about 10, or about 10. In various instances, the target pH value may be imparted with a value of 6.5, or at least 6.5, or at least 6.6, or at least 6.7, or at least 6.8, or at least 6.9, or at least 7, or at least 7.1, or at least 7.2, or at least 7.3, or at least 7.4, or at least 7.5, or at least 7.6, or at least 7.7, or at least 7.8, or at least 7.9, or at least 8, or at least 8.1, or at least 8.2, or at least 8.3, or at least 8.4, or at least 8.5, or at least 8.6, or at least 8.7, or at least 8.8, or at least 8.9, or at least 9, or at least 9.1, or at least 9.2, or at least 9.3, or at least 9.4, or at least 9.5, or at least 9.6, or at least 9.7, or at least 9.8, or at least 9.9, or less than 10, or 10.

The water treatment system 300 may include and be in communication with a control system 392. The control system 392 may include the controller 394 and a display 396. The controller 394 may be electronically connected to and may be in electronic communication with the display 396. The controller 394 also may be electronically connected to and may be in electronic communication with one or more of the water treatment system components including the one or more sensors (306a-306d, 314a-314c, 316a-316f, and 322), the first, second, third, fourth, fifth, or sixth valves (308a, 329a, 342a, 308b, 342b, and 329b, respectively), the feeder 328, and/or the pump 330.

In some embodiments of the water treatment system 300, the prefiltration unit 310 of the water treatment system 300 may be provided in the form of a first prefilter element 310a, a second prefilter element 310b, a third prefilter element 310c, and a fourth prefilter element 310d (see, e.g., FIGS. 3A-3C, 4B, 4C, and 4D). The first prefilter element 310a may be in fluid communication with the inlet line 304 and the second prefilter element 310b. The second prefilter element 310b may be in fluid communication with the first prefilter element 310a and the third prefilter element 310c. The third prefilter element 310c may be in fluid communication with the second prefilter element 310b and the fourth prefilter element 310d. The fourth prefilter element 310d may be in fluid communication with the third prefilter element 310c and the prefiltered water line 312.

Inlet water may enter the prefiltration unit 310 via the inlet line 304 and exit the prefiltration unit 310 via the prefiltered water line 312. When inlet water passes through the prefiltration unit 310, the prefiltration unit 310, via the first prefilter element 310a, the second prefilter element 310b, the third prefilter element 310c, and the fourth prefilter element 310d, may remove sediment, particulates, certain chemicals, and other contaminants from the inlet water, producing a prefiltered water that may flow out of the prefiltration unit 310 via the prefiltered water line 312.

In some embodiments, one or more of the first prefilter element 310a, the second prefilter element 310b, the third prefilter element 310c, and/or the fourth prefilter element 310d may be defined by a sediment filter. The sediment filter may remove sediments, such as sand, silt, and dirt, and other particulates such as rust from the inlet water. In some embodiments, the sediment filter may include a filter media including pores with a pore size of no more than 5 microns. For example, the sediment filter may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In some embodiments, the sediment filter may include a depth media, woven fabric, or nonwoven fabric.

In some embodiments, one or more of the first prefilter element 310a, the second prefilter element 310b, the third prefilter element 310c, and/or fourth prefilter element 310d may comprise an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, or the like. In some embodiments, a non-carbon-based media, such as clay or an ion exchange media, may be used in place of the activated carbon media.

By removing sediment, chlorine, chloramine, and other contaminants, the prefiltration unit 310 may provide prefiltered water that may have substantially no odor and have an improved taste compared to the inlet water. In addition, by removing sediment, chlorine, chloramine, and other contaminants, the prefiltration unit 310 may protect a membrane element from sediment fouling or oxidation.

In some embodiments, the prefiltration unit 310 may be comprised of a series of prefilter elements (e.g., two or more sediment filters) or may be comprised of a combination of prefilter elements (e.g., one or more sediment filters and one or more activated carbon filters). One of ordinary skill in the art would understand that the one or more prefilter elements that comprise the prefiltration unit 310 may be retained within a single prefiltration element or may be separate and distinct prefilter elements (see, e.g., FIG. 4B) that are in fluid communication with one another. In some embodiments, the prefiltration unit 310 may be a PENTAIR® EVERPURE® filter. In other embodiments, the prefiltration unit 310 may be a PENTAIR® PENTEK® BIG BLUE® filter.

In some embodiments of the water treatment system 300, the first pressure sensor 306a may be in fluid communication with the inlet line 304. Alternatively, the first pressure sensor 306a may be in fluid communication with inlet water within the first prefilter element 310a. The first pressure sensor 306a may measure, monitor, or sense the pressure of the inlet water in the inlet water or within the first prefilter element 310a. In some embodiments, the first pressure sensor 306a may be coupled to the prefiltration unit 310. In some embodiments, the first pressure sensor 306a may be coupled to the first prefilter element 310a (see, e.g., FIG. 4B), the second prefilter element 310b, the third prefilter element 310c, or the fourth prefilter element 310d.

In some embodiments of the water treatment system 300, the first TDS sensor 316a may be in fluid communication with the prefiltered water line 312. The first TDS sensor 316a may measure, monitor, or sense the conductivity of the prefiltered water to determine the concentration or amount of dissolved solids in the prefiltered water. Alternatively, the first TDS sensor 316a may be in fluid communication with water within the fourth prefilter element 310d. The first TDS sensor may measure, monitor, or sense the conductivity of the water within the fourth prefilter element 310d to determine the concentration or amount of dissolved solids in the water within the fourth prefilter element 310d. In some embodiments, the first TDS sensor 316a may be coupled to the prefiltration unit 310. In some embodiments, the first TDS sensor 316a may be coupled to the fourth prefilter element 310d (see, e.g., FIG. 4B), the first prefilter element 310a, the second prefilter element 310b, or the third prefilter element 310c.

In some embodiments, the water treatment system 300 may also include a post-filtration unit 350 as shown in FIGS. 3A-3C, 4B, 4C, and 4D. The post-filtration unit 350 may be in fluid communication with the outlet feed line 346 and a post-filtration line 356. The post-filtration unit 350 may be provided in the form of one or more of a first postfilter element 350a, a second postfilter element 350b, a third postfilter element 350c, and a fourth postfilter element 350d (see, e.g., FIG. 4B). In some embodiments, the post-filtration unit 350 may be in the form of one or more ultraviolet (UV) lights or ozone. In further embodiments, the post-filtration unit 350 may be in the form of one or more remineralization cartridges.

The first postfilter element 350a may be in fluid communication with the outlet feed line 346 and the second postfilter element 350b. The second postfilter element 350b may be in fluid communication with the first postfilter element 350a and the third postfilter element 350c. The third postfilter element 350c may be in fluid communication with the second postfilter element 350b and the fourth postfilter element 350d. The fourth postfilter element 350d may be in fluid communication with the third postfilter element 350c and the fourth valve 308b.

In some embodiments, membrane permeate may enter the post-filtration unit 350 via the outlet feed line 346 and exit the post-filtration unit 350 via the post-filtration line 356. When membrane permeate passes through the post-filtration unit 350, the post-filtration unit 350, via the first postfilter element 350a, the second postfilter element 350b, the third postfilter element 350c, and the fourth postfilter element 350d, may remove sediment, particulates, certain chemicals, and other contaminants from the inlet water, producing a postfiltered permeate that may flow out of the post-filtration unit 350 via the post-filtration line 356.

In some embodiments, the first postfilter element 350a, the second postfilter element 350b, the third postfilter element 350c, and/or the fourth postfilter element 350d may be an activated carbon filter. In other embodiments, the first postfilter element 350a, the second postfilter element 350b, the third postfilter element 350c, and/or the fourth postfilter element 350d may include filter media specifically designed to remove bacteria, nitrates, perfluoroalkyl and polyfluoroalkyl (PFAS) compounds, heavy metals such as arsenic, lead, iron, cadmium, and the like, and/or volatile organic compounds.

The fourth valve 308b and the outlet 348 may be in fluid communication with the post-filtration line 356. The fourth valve 308b may be used to control or regulate the amount of water (e.g., membrane permeate) flowing from a second tank 360, through the tank line 344, into the outlet feed line 346, through the post-filtration unit 350 and post-filtration line 356, and out of the outlet 348. The fourth valve 308b may open, either partially or fully, to enable or increase the flow or the amount of water from the second tank 360, through the tank line 344, into the outlet feed line 346, through the post-filtration unit 350 and post-filtration line 356, and out of the outlet 348. The fourth valve 308b may close, either partially or fully, to stop or decrease the amount of water flowing from the second tank 360, through the tank line 344, into the outlet feed line 346, through the post-filtration unit 350 and post-filtration line 356, and out of the outlet 348. The amount of water flowing through the outlet feed line 346 through the post-filtration unit 350 and post-filtration line 356, and out of the outlet 348 may increase or decrease the water pressure in the water treatment system 300.

As illustrated in FIGS. 4C and 4E, in some embodiments, the water treatment system 300 may include a second tank 360, which may be in fluid communication with the tank 318 via a tank connector line 362. The second tank 360 may be used to store water. The second tank 360 may be defined by a housing having a bottom portion 360a, a center portion 360b, and a top portion 360c. In some instances, each of the portions 360a, 360b, 360c may be separated by a physical barrier (e.g., if the second tank 360 is provided as a bladder tank), although in preferred embodiments no physical barrier is positioned between the portions 360a, 360b, 360c. In some embodiments, the second tank 360 may be a pressurized tank. In some embodiments, the second tank 360 may be a fiberglass reinforced plastic (FRP) tank. In some embodiments, the second tank 360 may range in size from about 24 gallons (91 liters) to about 200 gallons (757 liters).

The second tank 360 may include a second riser tube 320b that extends vertically from the bottom portion 360a of the second tank 360 to the top portion 360c of the second tank 360, or vice versa. The second riser tube 320b may be in fluid communication with the tank 318 via the tank connector line 362. In some embodiments, the second riser tube 320b may be PVC tubing.

The second tank 360 may optionally include a second flow distributor (not shown), which may be attached or coupled to the second riser tube 320b. The second flow distributor may prevent or reduce the mixing of higher TDS water that may be stored in the bottom portion 360a of the second tank 360 with lower TDS water that may be stored in the top portion 360c of the second tank 360. In some embodiments, the second flow distributor may be a dome flow distributor. In some embodiments, multiple second flow distributors may be used.

In some embodiments, depending on the flow conditions when the water treatment system 300 is in use, the prefiltered water may flow from the prefiltration unit 310 through the prefiltered water line 312, down the riser tube 320 of the tank 318, and into the bottom portion 318a of the tank 318. The prefiltered water may be stored in the tank 318. The prefiltered water may also flow from the prefiltration unit 310 via the prefiltered water line 312 toward the pump 330 via the additive line 326. The prefiltered water may then flow from the pump 330 to the membrane element 334 via the membrane feed line 332 for processing by the membrane element 334. The prefiltered water may further flow from the bottom portion 318a of the tank 318, where the prefiltered water may be stored, up the riser tube 320 of the tank 318, through the prefiltered water line 312 toward the pump 330 via the additive line 326, and to the membrane element 334 via the membrane feed line 332 for processing by the membrane element 334. The prefiltered water may pass through the membrane element 334, resulting in retentate exiting the membrane element 334 via the retentate line 336 and/or membrane permeate exiting the membrane element 334 via the membrane permeate line 338.

The membrane permeate line 338 may be connected to or otherwise in fluid communication with the tank line 344. The tank line 344 may be in fluid communication with the top portion 360c of the second tank 360. The tank line 344 also may be connected to or otherwise in fluid communication with an outlet feed line 346.

In some embodiments, depending on flow conditions when the water treatment system 300 is in use, the membrane permeate may flow from the permeate side of the membrane element 334 through the membrane permeate line 338 and the tank line 344 into the top portion 360c of the second tank 360. The membrane permeate may be stored in the second tank 360. The membrane permeate may also flow from the permeate side of the membrane element 334 through the membrane permeate line 338 and the tank line 344, into the outlet feed line 346 (thereby bypassing the second tank 360) through the post-filtration unit 350 and the post-filtration line 356, and out of the outlet 348. By enabling the flow of membrane permeate from the membrane element 334 directly to the outlet 348, membrane permeate may be provided to a point of use in real time.

The third valve 342 may be used to control or regulate the amount of membrane permeate entering or flowing through the membrane permeate line 338 into the tank line 344 and into the top portion 360c of the second tank 360 or toward the outlet 348 via the outlet feed line 346 and post-filtration line 356. The third valve 342 may open, either partially or fully, to enable or increase the flow or the amount of membrane permeate flowing through the membrane permeate line 338 to the tank line 344, and into the top portion 360c of the second tank 360 or into the outlet feed line 346 and toward the outlet 348. The third valve 342 may close, either partially or fully, to stop or decrease the amount of membrane permeate flowing through the membrane permeate line 338 and the tank line 344, into the top portion 360c of the second tank 360 or into the outlet feed line 346 and toward the outlet 348. The amount of membrane permeate entering or flowing through the membrane permeate line 338 and into the second tank 360 or toward the outlet 348 may increase or decrease the water pressure in the water treatment system 300.

A second flowmeter 314b may be positioned within or otherwise in fluid communication with the tank line 344. The second flowmeter 314b may measure, monitor, or sense the flow rate of the prefiltered water through the tank line 344.

In some embodiments, the second tank 360 may include zero, one, two, three, or more TDS sensors (not shown) disposed in each of the top, center, or bottom portions of the second tank 360. For example, in some embodiments, a TDS sensor may only be disposed in the center portion 360b of the second tank 360, not the top portion 360c or the bottom portion 360a. In other embodiments, a TDS sensor may be disposed in each of the top portion 360c and the bottom portion 360a of the second tank 360, but not the center portion 360b. In some embodiments, zero TDS sensors may be disposed in the second tank 360.

Depending on flow conditions, in some embodiments, the membrane permeate (i.e., the lower TDS water) that may be stored in the second tank 360 may flow from the second tank 360 through the tank line 344, the outlet feed line 346, the post-filtration unit 350, and the post-filtration line 356 and out of the outlet 348. The outlet 348 may be in fluid communication with various appliances, fixtures, and plumbing of the residential or commercial property. In some embodiments, the outlet 348 may be in fluid communication with a water heater, faucets, fixtures, or toilets via one or more pipes or tubes.

In some embodiments, higher TDS water may be stored in the tank 318 (e.g., prefiltered water from the prefiltration unit 310), and lower TDS water (e.g., membrane permeate from the membrane element 334) may be stored in second tank 360. Depending on flow conditions when the water treatment system 300 is in use, the lower TDS water (e.g., membrane permeate) stored in the second tank 360 may flow from the bottom portion 360a of the second tank 360 through the second riser tube 320b and tank connector line 362 and into the tank 318 as the high TDS water (e.g., prefiltered water) in tank 318 flows out of the tank 318 via the riser tube 320, through the prefiltered water line 312, the additive line 326, and the membrane feed line 332 toward the membrane element 334 for processing by the membrane element 334. Once processed, the resulting membrane permeate may flow toward and into the second tank 360 via the membrane permeate line 338 and the tank line 344 or toward and out of the outlet 348 via the outlet feed line 346 and the post-filtration line 356.

In some embodiments of the water treatment system 300, the optional remineralization system 380 may be disposed on the post-filtration line 356 as shown in FIG. 4C. In other embodiments of the water treatment system 300, the optional remineralization system 380 may be disposed on the membrane permeate line 338. In various instances of the water treatment system 300, the optional remineralization system 380 may be disposed on the tank line 344 and/or the tank connector line as shown in FIG. 4E. In yet other instances of the water treatment system 300, the optional remineralization system 380 may be disposed on the outlet feed line 346 as shown in FIGS. 4A, 4B, and 4D. In some embodiments, the remineralization system 380 may be disposed on the post-filtration line 356 before the fourth valve 308b.

Turning to FIG. 4D, in some embodiments, the water treatment system 300 may further include a second membrane element 370, which may be a reverse osmosis (RO) membrane. In some embodiments, the RO membrane may be spiral wound and may include feed spacers imparted with a certain thickness and/or structure as discussed in more detail above with respect to the membrane element 334.

In some embodiments, the second membrane element 370 may be a nanofiltration (NF) membrane, an ultrafiltration (UF) membrane, a microfiltration (MF) membrane, or a particulate membrane. In some embodiments, the second membrane element 370 may be a hollow fiber NF membrane. In other embodiments, the second membrane element 370 may be an electrodialysis membrane system.

In other embodiments, the second membrane element 370 may comprise a combination of one or more of an RO membrane, an NF membrane, a UF membrane, an MF membrane, a particulate membrane, and/or an electrodialysis membrane, which may be disposed in parallel or in series as discussed in further detail above with respect to membrane element 334. The one or more membranes in the combination of membranes may be contained within a single housing, in separate housings, or a combination thereof.

In further embodiments, the second membrane element 370 may include two or more RO membranes, NF membranes, UF membranes, MF membranes, particulate membranes, and/or electrodialysis membranes, which may be disposed in parallel or in series. In some embodiments, the second membrane element 370 may be a series of membranes of the same type (e.g., two or more RO membranes) but of a different size (e.g., each membrane is imparted with a different diameter) as discussed in more detail above with respect to membrane element 334. The two or more membranes may be contained within a single housing, in separate housings (e.g., as shown in FIG. 4D), or a combination thereof.

The second membrane element 370 may be in fluid communication with the retentate line 336 of the membrane element 334 on a feed side (not shown) of the second membrane element 370. The second membrane element 370 also may be in fluid communication with a second retentate line 372 on the feed side of the second membrane element 370. The second membrane element 370 may be in fluid communication with a second membrane permeate line 374 on a permeate side (not shown) of the second membrane element 370.

In some embodiments, the retentate of the membrane element 334 may be processed by the second membrane element 370 producing a second membrane permeate that may exit the second membrane element 370 via the second membrane permeate line 374. The second membrane element 370 may produce a second membrane retentate that may exit the second membrane element 370 via the second retentate line 372.

In some embodiments, as the retentate from the membrane element 334 enters the feed side of the second membrane element 370 via the retentate line 336, the second membrane element 370 may allow a solvent (e.g., water) in the retentate to pass through a surface of a membrane (not shown) retained within the second membrane element 370. The solvent that passes through the surface of the membrane within the second membrane element 370 may exit from the permeate side of the second membrane element 370 as the second membrane permeate via the second membrane permeate line 374. Solutes (e.g., dissolved minerals and ions and various organic compounds) in the retentate from the membrane element 334 may not pass through the membrane of the second membrane element 370 and may be retained at the surface of the membrane. The solutes may be discharged from the feed side of the second membrane element 370 as the second membrane retentate via the second retentate line 372.

In some embodiments, when the pump 330 is activated, the pump 330 may increase the rate at which water flows into the membrane feed line 332 toward the membrane element 334 and the second membrane element 370. Increasing the flow rate of water into the membrane feed line 332 may increase pressure in the membrane feed line 332. The increased pressure may in turn aid in pushing solvent through the pores formed within the surface of the membrane retained within the membrane element 334 and through the pores formed within the surface of the membrane retained within the second membrane element 370.

In the embodiment of the water treatment system 300 illustrated in FIG. 4D, the flow restrictor tube 339, which may be in communication with the retentate line 336, may be used to control or regulate the amount of the retentate leaving the membrane element 334 and/or entering the second membrane element 370. In some embodiments, the flow restrictor tube 339 may be a capillary tube imparted with an inner diameter of at least about 1/16 inches (at least about 1.6 mm) to no more than about ⅛ inches (no more than about 3.2 mm). In some embodiments, the flow restrictor tube 339 may be imparted with a length of at least about 1 inch (at least about 2.5 centimeters) to at least about 4 feet (at least about 122 cm). For example, the flow restrictor tube 339 may be imparted with a length of no less than 1 foot (30.5 centimeters) and no more than 3 feet (91.4 centimeters). In some embodiments, the flow restrictor tube 339 may be provided in the form of material that has a low energy surface to prevent the formation of scale on the surface of the flow restrictor tube 339, given that retentate may be beyond the saturation limit of the water. For example, the flow restrictor tube 339 may be made from polyethylene tubing. In other embodiments, a valve (e.g., a ball valve, needle valve, or globe valve) may be used instead of or in combination with the flow restrictor tube 339. In some embodiments, no flow restrictor tube 339 or valve is provided on the retentate line 336.

In the embodiment of the water treatment system 300 illustrated in FIG. 4D, a second flow restrictor tube 339b may be in fluid communication with the second retentate line 372. The second flow restrictor tube 339b may be used to control or regulate the amount of the second membrane retentate leaving the water treatment system 300 via the second retentate line 372 into the drain 341. In some embodiments, the second flow restrictor tube 339b may be a capillary tube imparted with an inner diameter of at least about 1/16 inches (at least about 1.6 mm) to no more than about ⅛ inches (no more than about 3.2 mm). In some embodiments, the second flow restrictor tube 339b may be imparted with a length of at least about 1 inch (at least about 2.5 centimeters) to at least about 4 feet (at least about 122 cm). For example, the second flow restrictor tube 339b may be imparted with a length of no less than 1 foot (30.5 centimeters) and no more than 3 feet (91.4 centimeters). In some embodiments, the second flow restrictor tube 339b may be provided in the form of material that has a low energy surface to prevent the formation of scale on the surface of the second flow restrictor tube 339b, given that the second membrane retentate may be beyond the saturation limit of the water. For example, the second flow restrictor tube 339b may be made from polyethylene tubing. In further embodiments, a valve may be used instead of or in combination with the second flow restrictor tube 339b. The amount of the second membrane retentate exiting the water treatment system 300 into the drain 341 may increase or decrease the water pressure in the water treatment system 300.

In some embodiments (see FIG. 4D), the second TDS sensor 316b and the first flowmeter 314a may each be in communication with the second retentate line 372 instead of the retentate line 336. The second TDS sensor 316b may measure, monitor, or sense the conductivity of the second membrane retentate to determine an amount or concentration of dissolved solids in the second membrane retentate. The first flowmeter 314a may measure, monitor, or sense the flow rate of the second membrane retentate in the second retentate line 372.

In some embodiments, the membrane permeate line 338, which may be in fluid communication with the membrane element 334, may include a third flow restrictor tube 339c. The third flow restrictor tube 339c may be used to control or regulate the amount of membrane permeate flowing from the membrane element 334 through the membrane permeate line 338. In some embodiments, the third flow restrictor tube 339c may be a capillary tube imparted with an inner diameter of at least about 1/16 inches (at least about 1.6 mm) to no more than about ⅛ inches (no more than about 3.2 mm). In some embodiments, the third flow restrictor tube 339c may be imparted with a length of at least about 1 inch (at least about 2.5 centimeters) to at least about 4 feet (at least about 122 cm). For example, the third flow restrictor tube 339c may be imparted with a length of no less than 1 foot (30.5 centimeters) and no more than 3 feet (91.4 centimeters). In some embodiments, the third flow restrictor tube 339c may be provided in the form of material that has a low energy surface to prevent the formation of scale on the surface of the third flow restrictor tube 339c. In further embodiments, a valve may be used instead of or in combination with the third flow restrictor tube 339c.

In some embodiments (see FIG. 4D), the water treatment system 300 may have a combined membrane permeate line 376. The combined membrane permeate line 376 may be in fluid communication with the membrane permeate line 338. The membrane permeate line 338 may bypass the second membrane element 370 providing a fluid flow of membrane permeate from the membrane element 334 to the combined membrane permeate line 376. The combined membrane permeate line 376 may also be in fluid communication with the second membrane permeate line 374.

In some embodiments (see FIG. 4D), the combined membrane permeate line 376 may be in fluid communication with the third valve 342a. Depending on flow conditions, in some embodiments of the water treatment system 300, membrane permeate from the membrane element 334 may flow from the membrane element 334 through the membrane permeate line 338 and third flow restrictor tube 339c, into the combined membrane permeate line 376 and toward the third valve 342a. In addition, the second membrane permeate from the second membrane element 370 may flow from the second membrane element 370 element through the second membrane permeate line 374, into the combined membrane permeate line 376 toward the third valve 342a.

In some embodiments (see FIG. 4D), the third valve 342a may be in fluid communication with the tank line 344. Depending on flow conditions, in some embodiments of the water treatment system 300, the membrane permeate and/or the second membrane permeate in the combined membrane permeate line 376 may flow through the third valve 342a and the tank line 344 into the top portion 318c of the tank 318. The membrane permeate and/or the second membrane permeate in the combined membrane permeate line 376 also flow through the third valve 342a and the tank line 344 into the outlet feed line 346 toward the outlet 348.

In some embodiments, the third valve 342a may be used to control or regulate the amount of membrane permeate and/or second membrane permeate entering or flowing through the combined membrane permeate line 376 into the tank line 344 and into the top portion 318c of the tank 318 or toward the outlet 348 via the outlet feed line 346. The third valve 342a may open, either partially or fully, to enable or increase the flow or the amount of membrane permeate and/or second membrane permeate flowing through the combined membrane permeate line 376 to the tank line 344, and into the top portion 318c of the tank 318 or into the outlet feed line 346 and toward the outlet 348. The third valve 342a may close, either partially or fully, to stop or decrease the amount of membrane permeate and/or second membrane permeate flowing through the combined membrane permeate line 376 and the tank line 344 into the top portion 318c of the tank 318 or into the outlet feed line 346 and toward the outlet 348. The amount of membrane permeate and/or second membrane permeate entering or flowing through the combined membrane permeate line 376 and into the tank 318 or toward the outlet 348 may increase or decrease the water pressure in the water treatment system 300.

In various embodiments, the water treatment system 300 includes the first tank 318 and the second tank 360 for supplying water to the point of use. In various instances, the first tank 318 and the second tank 360 may simultaneously supply water to the point of use such that low TDS water (from the membrane element 334) enters the second tank 360 and is pushed through the second tank 360 into the first tank 318.

In certain instances, the water treatment system 300 may be designed such that once the first tank 318 is depleted, the second tank 360 may be used to supply water to the point of use. In some such instances, as the second tank 360 provides water to the point of use, the first tank 318 may be processed and remineralized via recirculating the water from the tank 318 through the remineralization system 380. Once the water reaches a desired TDS concentration, the recirculation may cease, and the water may be delivered to the point of use. In some instances, the water may be delivered to the point of use even when the second tank 360 is depleted. In some embodiments, the recirculation occurs prior to the water entering the tank 318. In other embodiments, the entire volume of purified water stored in the tank 318 is recirculated through the remineralization system 380.

In various instances of the water treatment system 300, the TDS content of water may be determined indirectly by measuring the conductivity of a water stream. Generally, a conductivity value provides a proxy for TDS content in a water stream, as the presence of ions affects an ability of a water stream to conduct electricity. Accordingly, in some instances, conductivity measurements may be carried out in place of, or in conjunction with, measurements of TDS values. In such instances, one or more conductivity threshold values may be used in addition to or in place of the TDS threshold values when determining actions of the water treatment system 300. For example, the control system 400 may use the conductivity threshold values instead of the TDS threshold values for determining an action. In addition, the control system 400 may convert the measured conductivity values to TDS values. The conversion may partially depend on the solution used to calibrate the conductivity sensor (e.g., a sodium chloride solution, a potassium chloride solution, a mixed-ion solution such as a “442” solution).

To measure the conductivity values of the water streams in the water treatment system 300, one or more conductivity sensors may be provided in the water treatment system 300. The conductivity sensors may be placed in fluid communication with any of the conduits provided in the water treatment system 300. In addition, the conductivity sensors may be positioned in the same locations, or substantially the same locations, as the one or more TDS sensors 316 described with reference to FIGS. 4A-4F.

It is to be understood that, while the above-described conductivity sensors have been described with reference to the water treatment system 300, conductivity sensors having a similar structure and function may also be used in the water treatment systems 100, 200.

One skilled in the art would appreciate that less or more of each of the water treatment system components, e.g., inlets, outlets, filters, feeders, valves, pumps, tanks, lines, membranes, sensors, and/or control systems may be used in any of the embodiments disclosed herein without departing from the scope of the present disclosure. In addition, other sensors, e.g., ORP probes, colorimeter sensors, ion-selective electrode sensors, volume-based batching sensors, or pH sensors, may be used in any of the embodiments disclosed herein. Further, the specific location of each of the water treatment system components may vary from the locations disclosed in the embodiments described herein without departing from the scope of the present disclosure.

FIG. 5 is a schematic illustration of a control system 400, which may be substantially similar in structure and function to the control systems 192, 292, and 392 used with the water treatment systems of FIGS. 1, 2, 3A-3C, and 4A-4F according to some embodiments. Further, it is to be understood that any of the functionality described herein with reference to the control system 400 may be implemented in the control systems 192, 292, 392. The control system 400 may include a controller 402 electronically connected to a display 450 and the water treatment system components including the various sensors, valves, feeder, and pump via one or more wires or may be electronically connected via a communications network. The communications network may be a wireless network such as a personal area network (PAN) or local area network (LAN), a cellular network, or the Internet. In some embodiments, the display 450 may be an LED, LCD, or OLED display.

The controller 402 may be Bluetooth enabled and have Internet of Things (IoT) connectivity. The water treatment system components (e.g., the sensors, valves, feeder, and/or pump) may be IoT-enabled and/or communicatively connected smart components.

The controller 402 may send or receive electronic signals from one or more of the sensors including the pressure sensors (e.g., 106a-160g, 206a-206g, 306a-306d), flowmeters (e.g., 114a-114d, 214a-214d, 314a-314c), TDS sensors (e.g., 116a-116h, 216a-216h, 316a-316f), the temperature sensors (e.g., 122, 222, 322), and/or any other sensors provided in the water treatment system (e.g., 100, 200, 300). The electronic signals received from one or more of the sensors may provide measurements and other data regarding pressure, flow rate, total dissolved solids, conductivity, pH level, or the temperature of the water at various locations in the water treatment system. The measurements and other data may be sent to the controller 402 by the one or more sensors continuously, frequently or periodically.

The control system 400 may use the measurements or other data received from one or more of the sensors to send electronic signals to the valves, feeders, or the pumps. In some embodiments, the controller 402 may send an electronic signal to a first valve (e.g., 108, 208a, 308a), a second valve (e.g., 140, 229a, 329a), a third valve (e.g., 142, 242, 342a), a fourth valve (e.g., 208b, 308b), a fifth valve (e.g., 229b, 342b), and/or a sixth valve (e.g., 329b) to open or close, partially or fully. The controller 402 may send an electronic signal to a feeder (e.g., 128, 228, 328) to start, stop, increase, or decrease the amount of chemical additive released by the feeder 128. The controller 402 may send an electronic signal to a pump (e.g., 130, 230, 330) to start, stop, increase, or decrease the speed of the pump. Adjusting one or more of the valves, the feeder, and/or the pump may change the flow rate of the water into, through, or out of the system, the flow direction of the water within the system, and/or the pressure of the water in various lines of the water treatment system. The controller 402 may also receive electronic signals from the valves, feeders, and/or pumps.

It is to be understood that one or more of the values associated with the water treatment systems described herein (such as the systems of FIGS. 4A-4F), such as a target compound concentration, a target threshold value, a target tank threshold value, a treatment chemical value, a target pH value, a target TDS value, and the like, may be measured at different time intervals. In addition, the one or more values described with reference to the water treatment systems herein (such as the systems of FIGS. 4A-4F) may be measured on demand, manually implemented, or at predetermined time intervals (e.g., continuously, once a second, once a minute, once a day, once a week, once a month, etc.). Further, it is to be understood that the one or more of the values associated with the water treatment systems described herein (e.g., such as the systems described with reference to FIGS. 4A-4F) may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition. In each instance, such measurements may be carried out by one or more systems provided with the water treatment system and then received and stored by a controller (e.g., controller 402).

In addition, the predetermined values, thresholds, ranges, and other information described with reference to the water treatment systems of FIGS. 4A-4F may be manually implemented or otherwise input into the system. For example, the predetermined values, target values, and predetermined ranges may be manually input into a user interface of a controller (e.g., controller 402), provided to the controller via a user device, or otherwise associated with and retained by the controller.

In some instances, a lookup table of predetermined values, thresholds, ranges, and other information may be stored by a controller (e.g., the controller 402), and the controller may determine an appropriate action based on one or more of the variables discussed herein. In addition, the controller may include pre-stored lookup tables. Furthermore, the controller may be in communication with a network and may be capable of downloading lookup tables. The controller may select threshold values (e.g., a target threshold value, a target tank threshold value, a target pH value, a target TDS value) from the lookup tables based on a number of factors including a determined pressure, flow rate, conductivity, total dissolved solids, pH level, the temperature of the water at various locations, and/or other similar factors.

The controller 402 may include electronic components such as one or more processors 404, a memory 406 (e.g., random access memory (RAM)), an input/out device 408, and a power supply 410 (e.g., battery or AC adapter plug). The controller 402 may be able to download, store, and/or execute software having computer executable instructions. The software may include one or more modules. The one or more modules may include, for example, algorithms to monitor and/or store the measurements or other data received from one of more of the system components such as the sensors, valves, feeders, or pumps or may monitor and/or store real-time and historic flow patterns and usage data. The controller 402, via the one or more modules, may also perform calculations or other data analysis or modeling processes to determine various outcomes. The outcomes may include, for example, turning one or more of the system components of the water treatment system on or off at certain times or intervals or placing one or more of the system components in standby mode.

In some embodiments, the controller 402 may be able to self-diagnose or troubleshoot problems that arise without input from a user. Artificial intelligence or machine learning may be used to learn different patterns of usage to predict future behavior.

In some embodiments, the one or more modules may include a training module that may be designed to execute instructions related to one or more data analysis and modeling processes. In some embodiments, the training module may generate and iteratively train the machine learning training model to provide dynamic data analysis and outcomes, and the advanced analytics may be used to perform system and/or component diagnostics, generate alerts, notifications, or action items, provide customized recommendations according to user or service provider settings or preferences, and similar processes.

In some embodiments, one or more metrics or characteristics (e.g., historic water usage data, system pressure, TDS concentration, or water flow rates) may be used as parameters in one or more processes to iteratively train a training model or a plurality of machine learning training models. One skilled in the art will understand that processes for “iteratively training the machine learning training model” may include machine learning processes, artificial intelligence processes, and other similar advanced machine learning processes. In various embodiments, the iteratively trained machine learning model(s) may be designed to perform various advanced data analysis and modeling processes. In some embodiments, these processes may be performed by multiple machine learning models, or multiple aspects of a single machine learning model (e.g., an ensemble model), or a combination thereof. In one non-limiting embodiment, the machine learning training model(s) may be designed to generate, train, and execute a plurality of nodes, neural networks, gradient boosting algorithms, mutual information classifiers, random forest classifications, and other machine learning and artificial intelligence-related algorithms. It will be appreciated by one skilled in the art that the system and processes described herein may include different and/or additional details, data, measurements, parameters, metrics, and/or characteristics than those described herein.

For example, in some embodiments, if water usage is high during certain intervals of the day, the control system 400 may activate the water treatment system to enter certain phases of the operational cycle during low water usage times. For example, if water usage is high during the morning and/or afternoon, the controller 402 may activate the water treatment system to process high TDS water that may be stored in the tank through the membrane element to produce more membrane permeate and/or the controller 402 may activate the water treatment system to perform a membrane permeate flush of the membrane element during the night when there is less demand on the system.

In addition, if the water treatment system is not being used regularly (e.g., the user is on vacation or is traveling frequently), then certain components of the system, for example, the membrane element, may be adversely affected due to stagnation. To combat stagnation, the controller 402 may activate certain operational cycles of the system (e.g., the membrane permeate flush) if the water treatment system is not used within a certain period of time (e.g., 24 hours, 48, hours, 72 hours, 96 hours, etc.). Furthermore, seasonal changes may affect inlet water chemistry or temperature. For example, the pH, total alkalinity, and temperature of the inlet water may decrease in the winter and increase in the summer. The controller 402 may learn when the seasonal change is likely to occur and recalibrate system components or modify calculations performed by the controller 402 to account for the seasonal changes.

In some embodiments, the measurements or other data collected by the sensors may provide information regarding the performance, integrity, or “health” of the membrane element, which may assist in the operation of the water treatment system. Membrane element and water treatment system performance may decline over time due to a variety of factors including, but not limited to, membrane fouling, filter media loading, and chemical additive depletion. These types of issues are undesirable not only because a reduction in the water treatment system performance may lower system efficiency, but also because they may produce a poor experience for the user. Therefore, it may be beneficial to monitor and optimize system performance. Analyzing real-time data and adjusting processing conditions may lead to improvements in the operation and efficiency of the membrane element or other system components such as the prefiltration unit or chemical additive feeder, which in turn may improve the longevity of the components and the overall performance of the water treatment system. The analysis may either be performed locally via the controller 402 or remotely.

Additionally, the controller 402 may communicate information to the user of the water treatment system, a system servicer, or other person or company. For example, an alert or warning may be sent by the controller 402 to the display 450 or to another user device such as a mobile phone, tablet, laptop, or desktop computer identifying or describing a system level issue (e.g., the system pressure is too high or too low or a leak has been detected) or a system component problem (e.g., the prefiltration unit is not working or is not operating efficiently). The alert may be followed by, or may occur simultaneously, with the controller 402 taking an automatic action to address the issue. For example, if the system pressure is too high or too low, the controller 402 may shut the water treatment system down and/or open or close certain valves in the system to reduce or increase pressure. Additionally, or alternatively, the alert may provide a potential solution to the problem with or without any automatic action by the controller 402. For example, if a prefiltration unit is not working, the alert may suggest that the prefiltration unit be serviced or replaced, or if the prefiltration unit is not performing efficiently, the alert may suggest, for example, that a filter cartridge of one of the prefilter elements be replaced. In such scenarios, the water treatment system may continue normal operation unless a user or other operator instructs the controller 402 to shut down the water treatment system or take other action.

In some embodiments, flowmeters may be used to determine when a certain operational cycle may be triggered. For example, one or more flowmeters may be placed on an outlet feed line and/or on a membrane permeate line. A flowmeter on the outlet feed line may monitor the water consumed, and a flowmeter on the membrane permeate line may monitor the amount of membrane permeate produced. After a certain amount of water has been consumed, which may be monitored by the flowmeter on the outlet feed line, the water treatment system may be activated to start processing inlet water through the membrane element. After a determined amount of membrane permeate has been produced through the membrane element, which may be monitored by the flowmeter on the membrane permeate line, the water treatment system may shut off and return to standby mode until the cycle may be triggered again.

In some embodiments, flowmeters may be used to observe permeate flow rate over a period of time to determine if the performance of the water treatment system (e.g., the membrane element) is decreasing. For example, the membrane permeate flow rate may decrease from 4 gallons per minute (GPM) (15 liters per min (L/min)) in Week 1, to 3.75 GPM (14 L/min) in Week 2, to 3.5 GPM (13 L/min) in Week 3, to 3 GPM (11 L/min) in Week 4. At the same time, pressure in a membrane feed line may increase over the same time frame, e.g., from 200 pounds per square inch (PSI) (1379 kilopascals (kPa)) in Week 1, to 203 PSI (1400 kPa) in Week 2, to 206 PSI (1420 kPa) in Week 3, and 212 PSI (1462 kPa) in Week 4. The controller 402 may identify this trend and change certain operating metrics, characteristics, or parameters or send a communication to a user or system servicer to perform maintenance on the water treatment system.

In some embodiments, one or more pressure sensors may be disposed or otherwise associated with different locations of the water treatment system's plumbing to provide feedback on the water treatment system's performance. For example, the inlet and outlet pressures of a prefiltration unit or post-filtration unit of the water treatment system may be measured by one or more pressure sensors disposed at a location that is before and/or after the prefiltration unit. A significant drop in pressure across the prefiltration unit during flow events may signify that the filter media may be clogged and lowering system performance. Communicating the need for a new filter cartridge for the prefiltration unit to a user or system servicer in a timely manner may help prevent future performance loss and cause the water treatment system to operate better. In addition, depending on the location of the pressure sensors, the data provided by the pressure sensors may determine if the water treatment system is operating safely. If the water treatment system is not operating within a certain threshold (over or under a certain pressure parameter), the water treatment system may be shut down. Pressure measurements provided by the one or more sensors may also be used to trigger the water treatment system cycle to turn off or enter a standby mode. For example, a pressure sensor on an outlet feed line may sense a reduced pressure in the line when the water in the outlet feed line reduces in total dissolved solids, which may indicate that a sufficient amount of membrane permeate has been produced, which in turn may trigger the pump to stop operating.

In some embodiments, one or more TDS sensors may measure TDS or conductivity in the various lines to track ions in solution. The data received from the one or more TDS sensors may be used to evaluate membrane rejection, concentration factor, and other metrics or characteristics that may indicate whether the membrane element may be operating efficiently or if the processing parameters need adjustment. In some instances, a TDS sensor may be placed on the inlet water line to monitor the TDS levels of the inlet water. Another TDS sensor may be placed on the outlet side of the membrane element and/or the retentate line. The TDS levels of the inlet water may be compared to the TDS levels of the membrane permeate exiting the membrane element and/or the retentate. If there is a change in the TDS levels of the membrane permeate (e.g., there is an at least 10% rise or decline in the TDS levels of the membrane permeate while the inlet water TDS levels remain constant) or the TDS levels of the retentate (e.g., there is an at least 10% decrease in the TDS levels of the retentate while the inlet water TDS levels remain constant, or if there is at least a 10% change in the TDS levels of the retentate while the inlet water TDS levels remain constant), then the controller 402 may provide an alert to the user or system servicer (e.g., via the display 405 or via another device) that the membrane is not functioning properly.

In some embodiments, the pump may be turned on or off based on data received from the one or more sensors in the water treatment system. For example, one or more TDS sensors may be used inside the tank to trigger the pump to start producing membrane permeate when there is a rise in TDS of the water within the tank. For example, a TDS sensor may be placed at a center portion of the tank. As the amount of high TDS water increases in the tank, the TDS sensor may register a change in TDS of the water in the center portion of the tank. If the amount of TDS in the water at the center portion of the tank rises by a certain percent (e.g., at least 10%, at least 15%, at least 20%, etc.), then the pump may be triggered/turned on to start circulating high TDS water located in the bottom portion of the tank through the membrane element to produce membrane permeate. Another TDS sensor may be placed at the bottom portion of the tank and, as the level of TDS of the water begins to decrease by a certain percent in the bottom portion of the tank (e.g., because high TDS water in the bottom portion of the tank may have been circulated through the membrane element to produce membrane permeate that fills the top portion of the tank), the pump may be triggered to turn off. Alternatively, the pump may be activated using one or more flowmeters to trigger the pump on when a significant portion of the low TDS water has been used from the tank. In some embodiments, the water treatment system may use one or more flowmeters to totalize water used since the last time the pump was run and the tank refilled with low TDS water. By using the totalized water and the current flow demand at the point of use, a logic circuit may determine when to turn on the pump. As it may be preferable to turn on the pump sooner in high-demand cases, the totalized water, tank volume, and current flow may be used to calculate the time remaining for low TDS water in the tank. When the time remaining for low TDS water drops below a certain threshold, the pump may be started. Furthermore, a flowmeter monitoring water consumed may also be used to turn the pump off. The controller 402, with inputs of a known tank volume, membrane element production rate, and desired flush volume along with the real-time readings from the flowmeter monitoring water, use tracks the level of membrane permeate water present in the tank at any given time. When the controller 402 determines the water treatment system has completely refilled the tank and flushed enough membrane permeate past the membrane element, the pump may be shut off.

In some embodiments, one or more temperature sensors may be used to sense influent water temperatures and downstream temperatures to determine the quantity of water to process. The temperature sensors may be used to identify when the water in the tank has been fully processed as the downstream temperatures may be compared to the inlet temperature, and when the downstream and/or the inlet temperature are within a chosen parameter, the water treatment system may shut off and return to standby mode. Additionally, temperature sensors may be used to sense higher water temperatures and create variations in the processing of water and flushing of the membrane element. As temperatures increase, the water treatment system may identify the rise in temperature and adjust how long the membrane element is flushed and whether changes in the operational cycle are used to reduce potential scaling at higher water temperatures.

In some embodiments, one or more oxidation reduction potential (ORP) probes may be placed on an inlet and an outlet side of the prefiltration unit and used to monitor the one or more prefilter elements. For example, the one or more ORP probes may monitor the sediment filter or activated carbon filter performance and indicate when the sediment filter or activated carbon filter may no longer be removing contaminants.

In some embodiments, one or more colorimeter sensors may be placed at various locations in the water treatment system. The one or more colorimeter sensors may measure the different concentrations of contaminants or other solutes dissolved in the water and trigger the system to turn on and off according to certain parameters or conditions selected by the user or the control system 400.

In other embodiments, one or more pH sensors may be placed on the inlet line and outlet feed line to measure the differences in pH of the water entering and exiting the water treatment system. Certain parameters or conditions selected by the user or the control system 400 may trigger the water treatment system to start and stop an operational cycle of the water treatment system to improve the quality of the water in the tank.

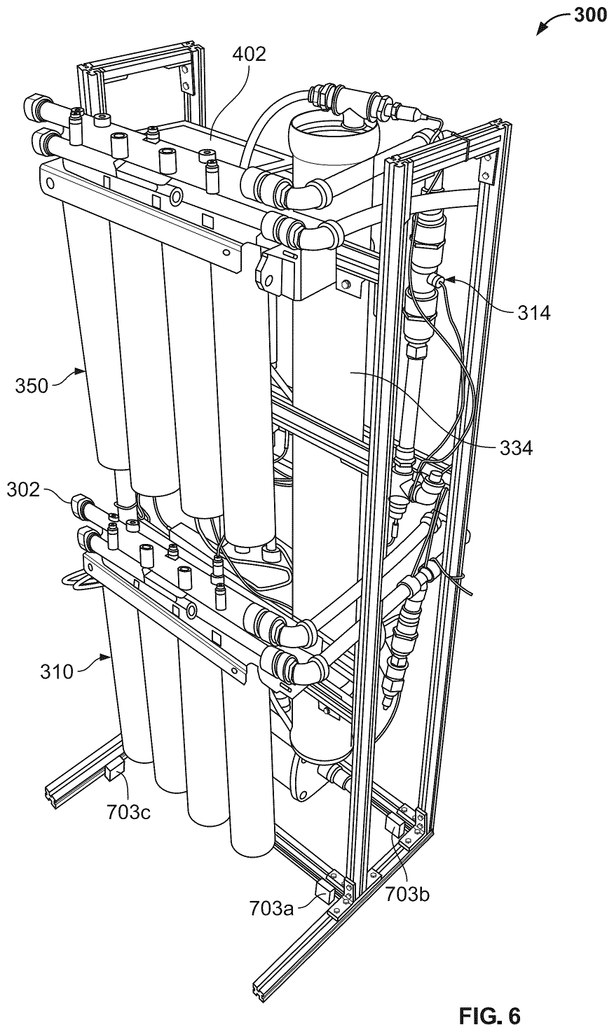

In further embodiments, the one or more sensors of the water treatment system (e.g., 100, 200, 300) may include, for example, one or more moisture sensors 703a, 703b, and 703c. In some embodiments, more than three moisture sensors may be used; in other embodiments, fewer than three moisture sensors may be used. The one or more moisture sensors 703a, 703b, and 703c may be disposed at various positions on or around the water treatment system as shown in FIG. 6. Additionally, or alternatively, the moisture sensors 703a, 703b, and 703c may be disposed at different locations in the residential or commercial property. For example, the one or more moisture sensors 703a, 703b, and 703c may be disposed in the same room or area as the water treatment system, on the same floor as the water treatment system, but in a different room or area, or on a floor below the water treatment system. The moisture sensors 703a, 703b, and 703c may be electronically connected to and/or in electronic communication with the controller 402.

The one or more moisture sensors 703a, 703b, and 703c may be designed to sense the presence of water or other fluids. The presence of water or other fluids may indicate a leak or a flooding event. If the one or more moisture sensors sense the presence of water or another fluid, the one or more moisture sensors 703a, 703b, and 703c may send a signal to the controller 402. In response to receiving the signal from the one or more moisture sensors 703a, 703b, and 703c, the controller 402 may shut down the water treatment system by, for example, sending a signal to stop the pump and/or to close one or more valves. For example, the controller 402 may send a signal to close a valve on the inlet line to prevent water from entering the water treatment system. Additionally, or alternatively, the controller 402 may send a signal to close a valve on the outlet feed line to prevent water from exiting the water treatment system. By shutting down the water treatment system, the flow of water may be interrupted, which may reduce the potential for water damage.

In other embodiments, one or more pressure sensors may monitor the pressure in the water treatment system to determine if there are abnormal pressure increases or decreases. For example, if the pressure in the inlet line or the outlet feed line is greater than or about 100 pounds per square inch (PSI) (689 kPa) or the pressure in the membrane feed line is greater than or about 250 PSI (1724 kPa), then the controller 402 may send or otherwise indicate a warning. If a high-pressure event occurs in the system (e.g., the pressure in the inlet line or the outlet feed line is greater than or about 150 PSI/1034 kPa), the water treatment system via the controller 402 may close a valve, for example, on the inlet water line, which may protect one or more components of the water treatment system as well as the plumbing, appliances, and/or structure of the residential or commercial building from the high-pressure event. Additionally, or alternatively, during a high-pressure event, the water treatment system may open a valve to relieve pressure in the water treatment system. Relieving or reducing pressure may protect the water treatment system and/or the plumbing, appliances, or structure of the residential or commercial building.

If a low-pressure event occurs (e.g., there is insufficient pressure to operate the water treatment system without causing damage), then the water treatment system via the controller 402 may stop normal operation and default to a nonoperating standby mode until the low-pressure situation is resolved.

In some embodiments, the water treatment system may use a pressure decay test during times of low usage to detect leaks. For example, during a low usage time (e.g., at night or early morning) the water treatment system may close one or more valves to create a substantially closed system. For example, to detect a leak in the water treatment system, a valve disposed on the inlet line and a valve disposed on the outlet feed line may both be closed, via the controller, to create the closed system. In another instance, to detect a leak in the residential or commercial property, only the valve disposed on the inlet line may be closed, via the controller. Once the system is substantially closed, the water treatment system may then use one or more pressure sensors disposed at various locations in the water treatment system to determine if there is a decrease in pressure during a time period (e.g., there is at least or about a 10-50% decrease in pressure over at least or about 1-5 minutes). If a certain decrease in system pressure is observed during the predefined time period, then the pressure decrease may indicate that there is a leak in the water treatment system (or the residential or commercial property). The controller may then close or keep closed one or more valves (e.g., the valve on the inlet line and the valve on the outlet feed line) to prevent damage to one or more components of the water treatment system or to the plumbing, appliances and/or structure of the residential or commercial property. The controller may also identify which valves may be closed in the event of a leak.

FIG. 7 illustrates an operational cycle 501 according to some embodiments of the water treatment systems of FIGS. 1, 2, 3A-3C, and 4A-4F. At a high level, some embodiments of the water treatment systems disclosed herein may operate according to the operational cycle 501. The operational cycle 501 may include four phases: Phase I, Phase II, Phase III, and Phase IV.

As shown in FIG. 7, the operational cycle 501 may begin at a Phase I. In Phase I, consumption of water at a point of use (POU) (not shown) such as a facet, fixture, or toilet, may commence. When water consumption commences, a change in pressure in the line going from an outlet 548 of a water treatment system 500 to the POU may cause water to flow to the POU. The pressure change may also cause untreated inlet water to enter the water treatment system through an inlet 502. The untreated inlet water may flow into a prefiltration unit 510. The prefiltration unit 510 may filter the untreated inlet water producing a prefiltered water. The prefiltered water may flow into a bottom portion of a tank 518. The flowing of the prefiltered water (denser, higher TDS water) into the bottom portion of the tank 518 may cause membrane permeate (less dense, lower TDS water) at the top portion of the tank 518 to flow out of tank. The membrane permeate flowing out of the top of the tank 518 may flow through the outlet 548 of the water treatment system toward the POU.

As the membrane permeate from the top portion of the tank 518 begins to flow out toward the outlet 548, the amount of prefiltered water entering the tank 518 may rise.

When the level of prefiltered water in the tank 518 reaches a certain threshold (e.g., reaches a certain volume within the bottom portion of the tank), the pump 530 may be activated in Phase II. When the pump 530 is activated, untreated inlet water may flow into the prefiltration unit 510. The prefiltered water produced by the prefiltration unit 510 may flow toward the pump 530, rather than directly into the tank 518. The prefiltered water may then be directed toward the membrane element 534 either via pressure changes in the system or by the pump 530. The membrane element 534 may remove solutes from the prefiltered water producing a membrane permeate (water with no solutes) that may exit the membrane element 534, and a retentate (water with solutes) that may be discharged from the water treatment system via a retentate line 536. If water consumption is high, then the membrane permeate may flow directly from the membrane element 534 out of the outlet 548 to the POU, thereby bypassing the tank 518.

Otherwise, if the amount of water being consumed is not high or has stopped, then membrane permeate may flow from the membrane element 534 into the tank 518 for later use as shown in Phase III. In Phase III, once consumption of the water has ceased, the prefiltered water that had previously entered the bottom portion of the tank 518 directly from the prefiltration unit 510 may be processed by the membrane element 534. The prefiltered water may flow from the bottom portion of the tank 518 toward the pump 530 and through the membrane element 534 for processing. The membrane permeate that may be produced from the processing of the prefiltered water from the tank 518 may flow into the top portion of the tank 518 for storage, and any retentate may be discharged from the water treatment system via the retentate line 536.

Once all the prefiltered water in the tank 518 has been processed (e.g., the tank is full or mostly full of membrane permeate), the water treatment system may then move to Phase IV in the operational cycle 501. In Phase IV, the stored membrane permeate may be used to clean or flush the membrane element 534. The membrane permeate stored in the tank 518 may flow out of the tank 518 and toward the membrane element 534. The pump 530 may be activated to direct the membrane permeate toward the membrane element 534 to clean the membrane element 534. In some embodiments, pressure in the various lines of the water treatment system may be sufficient to cause the membrane permeate to flow out of the tank 518 and toward the membrane element 534 to clean the membrane element 534 with the pump 530 turned off. The membrane permeate used to clean the membrane element 534 may be discharged from the water treatment system via the retentate line 536.

Once the membrane element 534 has been flushed, the water treatment system may enter a standby mode (not shown). In standby mode, none of the system components are activated. However, water may still flow through the system, between components, and/or out of the outlet 548 to a point of use. In some embodiments, water may not flow from the prefiltration unit 510 to the pump 530 or membrane element 534 when the system 500 is in standby mode.

When consumption of water commences again, the operational cycle 501 may move to Phase I.

In some instances, consumption of water may be so high that the water treatment system cannot keep up with the demand (e.g., all the membrane permeate stored in the tank is used up and the system is unable to produce more membrane permeate at a rate fast enough to keep up with consumption). In such instances, in some embodiments of the water treatment systems, inlet water may pass through the prefiltration unit into the tank and directly out of the water treatment system. The direction of water flow may be determined automatically by changes in pressure in the lines of the water treatment system without any input from the system (e.g., activating the pump or opening/closing valves). Thus, POUs of the residence or commercial property will always be receiving at least prefiltered water (e.g., water that has been filtered by a prefiltration unit such as a sediment filter, activated carbon filter, or a combination thereof), some of which may be membrane permeate. Once the water consumption decreases, the water treatment system may return to its usual operational cycle (e.g., operational cycle 501). Furthermore, more than one tank or a larger tank may be used in any of the disclosed embodiments to scale the system up if there is a high demand for membrane permeate water.

The systems and methods for extending the health and lifespan of a membrane element as described herein may be incorporated or used in any of the described systems 100, 200, and 300. The descriptions of systems and methods for extending the health and lifespan of the membrane element are examples and not exhaustive.

In some embodiments of any of the water treatment systems described herein, (e.g., the systems 100, 200, 300), a membrane flush may be used to clean the membrane element 134, 234, 334, which in turn may help extend the lifetime of the membrane element 134, 234, 334. In some instances, the membrane flush may comprise providing a high-pressure water stream to the membrane element 134, 234, 334 via the membrane feed line 132, 232, 332. In other instances, the membrane flush comprises providing a high flow rate water stream to the membrane element 134, 234, 334 via the membrane feed line 132, 232, 332. Flushing the membrane element 134, 234, 334 may rinse away the concentrated solutions of salts stagnated near the surface of the membrane element 134, 234, 334 and prevent the salts from forming a precipitate layer on the surface of the membrane element 134, 234, 334.

The flush process may be carried out after each use of the membrane element 134, 234, 334 or the flush process may be carried out on a set schedule (e.g., the flush process may be initiated at predetermined intervals and/or after a predetermined number of permeate production cycles). In addition, different types of solutions or water streams may be used when flushing the membrane element 134, 234, 334. For example, the flush process may include low TDS water (e.g., prefiltered water), untreated water (e.g., inlet water), water processed by the membrane element 134, 234, 334 (i.e., membrane permeate), prefiltered water with additive (as previously defined), and/or water dosed with the chemical additive (e.g., citric acid). A membrane flush may help minimize the build-up of scale on the membrane element 134, 234, 334 because the surface of the membrane element may not be continuously or substantially continuously exposed to high TDS water. In some instances, the membrane element 134, 234, 334 is flushed with low TDS water immediately after the operational cycle stops (e.g., when the membrane element 134, 234, 334 stops producing low TDS permeate). In some instances, the membrane flush may occur when the system 100, 200, 300 completes Phase III of the operational cycle 501, as described with reference to FIG. 7. Flushing the membrane element 134, 234, 334 may push the water that is saturated or supersaturated with minerals away from the membrane element 134, 234, 334 and into a retentate line 136, 236, 336 and to the subsequent drain 141, 241, 341. In some instances, the membrane permeate stored in the tank 118, 218, 318 may be directed to the membrane element 134, 234, 334 to dislodge the water that is saturated or supersaturated with minerals from the membrane element 134, 234, 334. In some instances, flushing the membrane element 134, 234, 334 with membrane permeate after any operational cycles prevents the formation of mineral precipitates on the membrane element 134, 234, 334.

In some instances, the water provided to the membrane element 134, 234, 334 as part of the flush process may be the membrane permeate produced by the membrane element 134, 234, 334. For example, the membrane element 234, 334 may be provided with membrane permeate as described in Phase IV of the operational cycle 501 (see FIG. 7) and further described herein.

In some embodiments of the water treatment system 100, 200, 300 a membrane element soak may be used to clean the membrane element 134, 234, 334. In some instances, the membrane element soak comprises providing a water solution to the membrane element 134, 234, 334 via the membrane feed line 132, 232, 332. Such soak processes may help extend the lifespan of the membrane element 134, 234, 334.

In some instances, flushing of the membrane element 134, 234, 334 is carried out for at least about 1 minute to at least about 30 minutes. In other instances, flushing the membrane element 134, 234, 334 is carried out for at least about 1 minute to at least about 1 hour, or longer. In some instances, flushing of the membrane element 134, 234, 334 is carried out for at least 1 minute to at least 30 minutes. In other instances, flushing the membrane element 134, 234, 334 is carried out for at least 1 minute to at least 1 hour, or longer.

Soaking the membrane element 134, 234, 334 with water may dislodge the concentrated solutions of salts stagnated near the surface of the membrane element 134, 234, 334, dissolve already-formed scale, and help prevent the salts from forming a precipitate layer on the surface of the membrane element 134, 234, 334. The soaking process may utilize different types of solutions or water streams. For example, the membrane element soak may utilize low TDS water (e.g., prefiltered water), untreated water (e.g., inlet water), water processed by the membrane element 134, 234, 334 (i.e., permeate water), prefiltered water with additive, and/or water dosed with the chemical additive (e.g., citric acid). In some instances, the membrane element 134, 234, 334 is soaked with low TDS water immediately after the operational cycle stops (e.g., when the membrane element 134, 234, 334 stops producing low TDS permeate). Regardless of the water or solution used, the soaking process may remove scale and concentrated salts from the membrane element 134, 234, 334. Then, the scale and concentrated salts may be provided to the retentate line 136, 236, 336 and, ultimately, the drain 141, 241, 341. Furthermore, soaking the membrane element 134, 234, 334 may prevent formation of scale on the surface of the membrane element 134, 234, 334.

In some instances, the soaking of the membrane element 134, 234, 334 is carried out for at least about 5 minutes, or at least about 10 minutes, or at least about 20 minutes, or at least about 30 minutes, or at least about 40 minutes, or at least about 1 hour, or at least about 2 hours, or at least about 3 hours, or at least about 6 hours, or at least about 7 hours, or at least about 9 hours, or at least about 12 hours. In other instances, the soaking of the membrane element 134, 234, 334 is carried out for at least 5 minutes, or at least 10 minutes, or at least 20 minutes, or at least 30 minutes, or at least 40 minutes, or at least 1 hour, or at least 2 hours, or at least 3 hours, or at least 6 hours, or at least 7 hours. In multiple instances, the soaking is carried out for at least about 3 hours to at least about 6 hours. In some instances, the soaking is carried out for at least 3 hours to at least 6 hours. In some instances, the soaking of the membrane element 134, 234, 334 is carried out for at least about 24 hours or at least about 48 hours. In other instances, the soaking of the membrane element 134, 234, 334 is carried out for at least 24 hours or at least 48 hours. In some instances, the soaking of the membrane element 134, 234, 334 is carried out in between uses for at least a few days (e.g., when a user is on vacation). In various instances, the soaking of the membrane element 134, 234, 334 is carried out for at least about 2 days, or at least about 3 days, or at least about 5 days, or at least about a week, or at least about 2 weeks, or at least about 3 weeks, or at least about 4 weeks. In various instances, the soaking of the membrane element 134, 234, 334 is carried out for at least 2 days, or at least 3 days, or at least 5 days, or at least a week, or at least 2 weeks, or at least 3 weeks, or at least 4 weeks. Referring again to FIGS. 2-4E, in some instances, chemical agents may be introduced into the flush or rinse of the membrane element 134, 234, 334 at the end of the operational cycle (e.g., the end of operational cycle 501) and then allowed to soak the membrane element 134, 234, 334 during periods of inactivity.

In some instances, the chemical agent is allowed to soak the membrane element 134, 234, 334 for at least about 1 minute, or at least about 5 minutes, or at least about 10 minutes, or at least about 20 minutes, or at least about 30 minutes, or at least about 40 minutes, or at least about 60 minutes, or at least about 90 minutes, or at least about 1 hour, or at least about 2 hours, or at least about 3 hours, or at least about 6 hours, or at least about 7 hours. In other instances, the chemical agent is allowed to soak the membrane element 134, 234, 334 for at least 1 minute, or at least 5 minutes, or at least 10 minutes, or at least 20 minutes, or at least 30 minutes, or at least 40 minutes, or at least 60 minutes, or at least 90 minutes, or at least 1 hour, or at least 2 hours, or at least 3 hours, or at least 6 hours, or at least 7 hours. In multiple instances, the chemical agent is allowed to soak the membrane element 134, 234, 334 for at least about 3 hours to at least about 6 hours. In some instances, the chemical agent is allowed to soak the membrane element 134, 234, 334 for at least 3 hours to at least 6 hours. In various instances, the chemical agent is allowed to soak the membrane element 134, 234, 334 for at least about 24 hours or at least about 48 hours. In some instances, the chemical agent is allowed to soak the membrane element 134, 234, 334 for at least 24 hours or at least 48 hours. In some instances, the chemical agent is allowed to soak the membrane element 134, 234, 334 in between uses for at least a few days (e.g., when a user is on vacation). In various instances, the chemical agent is allowed to soak the membrane element 134, 234, 334 for at least about 2 days, or at least about 3 days, or at least about 5 days, or at least about a week, or at least about 2 weeks, or at least about 3 weeks, or at least about 4 weeks. In various instances, the chemical agent is allowed to soak the membrane element 134, 234, 334 for at least 2 days, or at least 3 days, or at least 5 days, or at least a week, or at least 2 weeks, or at least 3 weeks, or at least 4 weeks.

Soaking the membrane element 134, 234, 334 with the chemical additive may allow a significant amount of time for chemical processes to take place. In some instances, the water treatment system 100, 200, 300 is restarted, the pump 130, 230, 330 turns on, and the materials that have been dissolved or dislodged from the membrane element 134, 234, 334 and spacer are then carried out of the membrane element 134, 234, 334 via the retentate line 136, 236, 336 and to the subsequent drain 141, 241, 341.

A forward membrane flush process may be used to clean the membrane element 134, 234, 334 and help extend the lifespan of the membrane element 134, 234, 334. The water treatment system 100, 200, 300 may include a retentate valve (not illustrated) or a flow restrictor tube 239, 339 that is in fluid communication with the retentate line 136, 236, 336. The retentate valve or the flow restrictor tube 239, 339 may control or regulate the amount of retentate leaving the water treatment system 100, 200, 300 via the retentate line 136, 236, 336 and provided to the drain 141, 241, 341. In the forward membrane flush process, the flow of water (i.e., the retentate from the membrane element 134, 234, 334) through the retentate valve or flow restrictor tube 239, 339 may be increased. Increasing the flow of water through the retentate valve or flow restrictor tube 239, 339 may increase the flow of water through the feed side of the membrane element 134, 234, 334. The elevated water flow may dislodge particulates, biofilms, and scale that have collected on the feed side of the membrane element 134, 234, 334 and within the feed spacer. The dislodged particulates, biofilms, and scale may be removed via the retentate line 136, 236, 336 along with the retentate and provided to the subsequent drain 141, 241, 341. In some instances, a backward membrane flush may be used in addition to or in place of the forward membrane flush. The backward membrane flush may comprise a membrane flush in which the flushing fluid flows in the opposite direction compared to fluid flow during normal operation of the membrane element 134, 234, 334.

Additionally, the rejection of the membrane element 134, 234, 334 (e.g., a calcium rejection percentage, a TDS rejection percentage, an alkalinity rejection percentage) may be dependent on the recovery. As the recovery increases, the TDS level of the permeate may increase. In some instances, if the TDS level of the permeate is lower than desired, the recovery may be increased until the desired TDS value is achieved. In various instances, increasing the recovery may be accomplished by reducing the retentate flow. At high recoveries and/or low retentate flows, it may be difficult to maintain a consistent retentate flow through conventional means (e.g., using a capillary restrictor and/or a needle valve). In some embodiments, an automated adjustable retentate valve (e.g., a needle valve, a restriction valve, an orifice provided as a flow restrictor) may maintain consistent retentate flow with feedback control, in which measurements of the retentate flow (e.g., a measurement of the flow rate of the retentate stream) are utilized to maintain the setpoint flow. In other instances, monitoring the membrane feed or permeate flow may be used to determine a setpoint that may be adjusted to maintain a specified recovery to achieve the desired TDS level in the permeate water. In various instances, the recovery of the membrane element 134, 234, 334 may be determined by the control system 400. In addition, the control system 400 (e.g., the controller 402) may take an action when the recovery of the membrane element 134, 234, 334 is at, above, or below a specified setpoint (or a predetermined setpoint). In some cases, the action may comprise at least one of decreasing the retentate flow, increasing the retentate flow, or taking no action. In some such cases, adjusting the retentate flow may be accomplished by adjusting the automated adjustable retentate valve or by manually adjusting an adjustable retentate valve.

In additional instances, a process for modifying a TDS level, a calcium concentration, an alkalinity value, and/or a pH value of the permeate may be accomplished using an adjustable retentate valve. In some instances, the process includes a step of identifying whether the TDS level, the calcium concentration, the alkalinity value, and/or the pH value of the permeate is outside a target threshold range, within a target threshold range, above a threshold value, at or near a threshold value, or below a threshold value. In some such instances, the determination may be made by the controller 402. Next, the process may include a step of adjusting or modifying the recovery of the membrane element by adjusting the retentate valve to adjust or modify the retentate flow until the permeate is imparted with a desired or target TDS level, a desired or target calcium concentration, a desired or target alkalinity value, and/or a desired or target pH value. In some instances, the process may include a step of adjusting or modifying the recovery of the membrane element by adjusting the retentate valve to adjust or modify the retentate flow until the permeate is imparted with a TDS level that falls within a target TDS range, a calcium concentration that falls within a target calcium concentration range, an alkalinity value that falls within a target alkalinity range, and/or a pH value that falls within a target pH range. In various instances, adjustment of the retentate valve may be carried out by the controller 402, although the retentate valve may also be manually adjusted.

In some instances of the process for modifying the TDS level, the calcium concentration, the alkalinity value, and/or the pH value of the permeate using the retentate valve, the process may include a step of maintaining a consistent flow rate with feedback control using an automated and adjustable retentate valve. The process may further comprise the steps of measuring the flow rate of the retentate stream and adjusting the valve (e.g., a needle valve) to maintain a setpoint flow. In other instances, the process may include the steps of monitoring the membrane feed or permeate flow rate and determining a setpoint that may be adjusted to maintain a specified recovery to achieve the desired TDS in the permeate water.

In various instances, the forward membrane flush process may be done periodically alone, or as part of a clean-in-place effort, for example after treatment of the membrane element 134, 234, 334 with a chemical additive (e.g., citric acid). In some instances, in conjunction with a clean-in-place effort, the forward flush process may dislodge and carry out contaminants that were partially broken down by the chemical additive. In multiple instances, the water treatment system 100, 200, 300 may pulse the water provided in the forward flush in an on-off fashion or using a high flow/low flow operation to dislodge contaminants on the surface of the membrane element 134, 234, 334. In some instances, in addition to forward flushing, other mechanical treatments may dislodge contaminants and carry them out of the membrane element 134, 234, 334 with the retentate flow. Such mechanical treatment may include microbubbles, backward membrane flush, and vibration.

In some instances, the water treatment system 100, 200, 300 may change the flow rate of the retentate (and thus the amount of retentate produced by the membrane element 134, 234, 334) by adjusting the retentate valve or flow restrictor tube 239, 339 that controls the flow of the retentate to the drain 141, 241, 341. In turn, adjusting the retentate flow may alter the recovery of the membrane element 134, 234, 334, even as the membrane flux changes. Specifically, the retentate flow and the permeate flow generated by the membrane element 134, 234, 334 are proportional; thus, a change in the retentate flow rate may impact the membrane flux. In some instances, adjusting the retentate valve or the flow restrictor tube 239, 339 may change the membrane element 134, 234, 334 recovery, even as the water quality (e.g., the TDS level) provided to the water treatment system 100, 200, 300 changes. For example, by adjusting the quantity of retentate flowing through the retentate valve or the flow restrictor tube 239, 339, the recovery of the membrane element 134, 234, 334 may be reduced as the TDS content or the hardness of the inlet water increases. In other instances, by adjusting the quantity of retentate allowed to flow through the retentate line 136, 236, 336, the recovery of the membrane element 134, 234, 334 may be reduced when the membrane flux decreases (indicating fouling).

As the membrane flux decreases and the retentate flow is held constant, the recovery of the water treatment system 100, 200, 300 may decrease, but in some cases, the system may be configured to increase the retentate and decrease the recovery even more to help keep permeate quality constant. In other instances, through use of adjusting the flow of retentate through the retentate line 136, 236, 336, the water treatment system 100, 200, 300 may optimize water use and decrease the quantity of retentate when the membrane flux decreases to help keep the membrane element 134, 234, 334 recovery constant.

The prefiltration unit 110, 210, 310 and the feeder 128, 228, 328 may introduce or add the chemical additive to the inlet water or the prefiltered water, respectively. For example, the feeder 128, 228, 328 may provide the polyphosphate compound or citric acid to the water stream in the additive line 126, 226, 326. In some instances, the addition of the chemical additive may occur after the water stream in the additive line 126, 226, 326 has been pressurized by the pump 130, 230, 330 (i.e., when the feeder 128, 228, 328 is positioned downstream of the pump 2130, 30, 330). As an additional example, the prefiltration unit 110, 210, 310 may provide the polyphosphate compound or citric acid to the water stream in the prefiltered water line 112, 212, 312. Furthermore, in some embodiments of the system 100, 200, 300, the chemical additive released by the prefiltration unit 110, 210, 310 or the feeder 128, 228, 328 may be used to maintain membrane element 134, 234, 334 health. In some embodiments, when the prefiltered water flows through or passes the feeder 128, 228, 328, the chemical additive may be added or introduced to the prefiltered water in the additive line 126, 226, 326. The chemical additive may dissolve or otherwise degrade in the prefiltered water.

In some instances, the polyphosphate compound may be incorporated into a membrane flush, rinse, soak, or clean-in-place process. In various instances, the polyphosphate compound may include one or more polyphosphates. The polyphosphate compound retained within the feeder 128, 228, 328 may include pyrophosphates, hexametaphosphate (HMP), orthophosphates, or a blend of several types of polyphosphates.

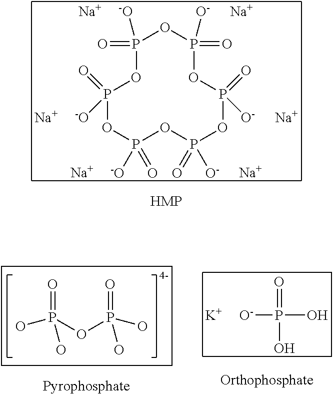

The polyphosphate compound may include crystalline pyrophosphate, metaphosphate, tripolyphosphate, glassy beaded HMP, and glassy polyphosphate blends. In some cases, other organic ions besides the polyphosphate may be used for a similar function, including polyacrylic acids, carboxylic acids, polymaleic acids, organo-phosphates, phosphonates, and anionic polymers. In some instances, the polyphosphate compound may be a blend of HMP and silicate in glassy bead form. In some instances, the polyphosphate compound is suspended in a “netting” within the feeder 128, 228, 328 or the prefiltration unit 110, 210, 310, the netting configured to help improve the polyphosphate's absorption into the water stream provided to the feeder 128, 228, 328 or the prefiltration unit 110, 210, 310. In some instances, the polyphosphate compound may tolerate temperatures up to about 90° C.

In some instances, the concentration of the polyphosphate compound provided by the feeder 128, 228, 328 or the prefiltration unit 110, 210, 310 imparts the water with a concentration of the polyphosphate compound of at least about 0.01 ppm to no more than about 10 ppm. In some instances, the concentration of the polyphosphate compound is at least about 1 ppm to no more than about 10 ppm. In some instances, the concentration of the polyphosphate compound is at least about 2 ppm to no more than about 5 ppm. In some instances, the concentration of the polyphosphate compound is at least about 0.01 ppm, or at least about 0.1 ppm, or at least about 0.25 ppm, or at least about 0.5 ppm, or at least about 1 ppm, or at least about 5 ppm, or at least about 9 ppm.

In some instances, the concentration of the polyphosphate compound provided by the feeder 128, 228, 328 or the prefiltration unit 110, 210, 310 imparts the water with a concentration of the polyphosphate compound of at least 0.01 ppm to no more than 10 ppm. In some instances, the concentration of the polyphosphate compound is at least 1 ppm to no more than about 10 ppm. In some instances, the concentration of the polyphosphate compound is at least 2 ppm to no more than 5 ppm. In some instances, the concentration of the polyphosphate compound is at least 0.01 ppm, or at least 0.1 ppm, or at least 0.25 ppm, or at least 0.5 ppm, or at least 1 ppm, or at least 5 ppm, or at least 9 ppm.

In some instances, the polyphosphate compound may control or impede scale formation on the surface of the membrane element 134, 234, 334 when the water provided to the membrane element 134, 234, 334 is imparted with a hardness value of over about 85 mg/L, or over about 170 mg/L, or over about 340 mg/L, or over about 510 mg/L. In some instances, the polyphosphate compound may impede or control scale formation in water imparted with a hardness value of over 85 mg/L, or over 170 mg/L, or over 340 mg/L, or over 510 mg/L. In various instances, the polyphosphate compound may help control scale formation on the surface of the membrane element 134, 234, 334 at a concentration of less than about 1 ppm, and in water imparted with a hardness value of over about 510 mg/L. In various instances, the polyphosphate compound prevents scale at a concentration of less than 1 ppm, and in water imparted with a hardness value of over 510 mg/L.

In some instances, the polyphosphate introduced into the membrane element system may inhibit CaCO₃ scale formation according to the method TM0374-2016-G by at least about 20%, or at least about 30%, or at least about 40%, or at least about 50%, or at least about 60%, or at least about 70%, or at least about 80%, or at least about 90%, or at least about 100%.

In some instances, the polyphosphate introduced into the membrane element system may inhibit CaCO₃ scale formation according to the method TM0374-2016-G by at least 20%, or at least 30%, or at least 40%, or at least 50%, or at least 60%, or at least 70%, or at least 80%, or at least 90%, and at least 100%.

In some instances, the polyphosphate compound may be introduced into the water stream ahead of the membrane element 134, 234, 334 via the feeder 128, 228, 328 or the prefiltration unit 110, 210, 310. Imparting the water provided to the membrane element 134, 234, 334 with a polyphosphate compound may help sequester divalent ions and prevent the ions from precipitating on the membrane element 134, 234, 334 as scale, allowing the polyphosphate to function similarly to a chelating agent. The ions sequestered by the polyphosphate compound may be carried out with the retentate stream in the retentate line 136, 236, 336 and to the drain 141, 241, 341. In addition, the polyphosphate compound may interfere with scale formation. Water imparted with a polyphosphate compound concentration of less than about 1 ppm (e.g., less than about 0.1 ppm, or less than about 0.01 ppm) may help prevent scale from forming thermodynamically stable solids on the surface of the membrane element 134, 234, 334. Thermodynamically stable solids (e.g., crystalline structures of minerals) are harder to remove from the membrane element 134, 234, 334 than amorphous mineral material. Therefore, preventing formation of thermodynamically stable solids may help improve the performance and extend the lifetime of the membrane element 134, 234, 334.

In some instances, instead of using the feeder 128, 228, 328 or the prefiltration unit 110, 210, 310 to introduce the polyphosphate compound to their respective water streams, the water treatment system 100, 200, 300 may introduce the polyphosphate compound into the rinse water at other locations. In each case, the polyphosphate may be introduced to the water stream using a feeder, a cartridge, or another appropriate dosing mechanism. In some instances, the polyphosphate compound may be introduced to the inlet water by the addition of the polyphosphate to the inlet line 104, 204, 304, and/or to the prefiltered water in the prefiltered water line 112, 212, 312. In other instances, the polyphosphate compound may be introduced to the permeate water of the permeate flush line 252, 352. In some instances, the water treatment system 100, 200, 300 may introduce the polyphosphate compound into only the rinse water (i.e., water used to rinse the membrane element 134, 234, 334). In some instances, the water treatment system 100, 200, 300 may be configured to add the polyphosphate to the rinse water and the inlet water, wherein a higher concentration of polyphosphate is added to the rinse water than compared to the inlet water.

In some instances, a chelating agent may be incorporated into a membrane flush, rinse, soak, or clean-in-place process. In various instances, the chelating agents may include citric acid, ethylenediaminetetraacetic acid (EDTA) sodium gluconate, sodium galactarate, sodium citrate, and N-(2-Hydroxyethyl)ethylenediaminetriacetic acid (HEDTA). In some instances, the chelating agents may be provided as an acid or as a salt (e.g., sodium or potassium salts). The ability of the chelating agent to bind with dissolved cations may increase the dissolution of scale on the membrane element 134, 234, 334 by reducing the concentration of ions in solution. In some instances, using a chelating agent at an optimal pH to ensure that the chelating agent is in its most effective form may be beneficial. The optimal pH may depend on the target ion as well as the identity of the chelating agent. The chelating agent may also be introduced into the flush water to contact the membrane element 134, 234, 334 during periods of inactivity. In some instances, the chelating agent may be used to soak the membrane element 134, 234, 334.

In some instances, the acidic compound may be incorporated into a membrane flush, rinse, soak, or clean-in-place process. In some instances, the acidic compound may be provided as citric acid, acetic acid, sulfuric acid, phosphoric acid, hydrochloric acid, fumaric acid, lactic acid, malic acid, nitric acid, methanesulfonic acid, hydrofluoric acid, tartaric acid, and combinations thereof. Preferably, the acidic compound is provided as citric acid. In various cases, citric acid may be added into the prefiltered water via the feeder 128, 228, 328 and the additive line 126, 226, 326 to be provided to the membrane element 134, 234, 334 to help increase the lifetime of the membrane element 134, 234, 334. In other cases, the citric acid is added to the inlet water provided to the prefiltration unit 110, 210, 310.

It may be beneficial to add the acidic compound (e.g., citric acid) upstream of the membrane element 134, 234, 334 (e.g., via the feeder 128, 228, 328) to reduce the pH value of the water provided to the membrane element 134, 234, 334. In various instances, imparting the water provided to the membrane element 134, 234, 334 with a lower pH value will increase the solubility of scale-forming minerals, e.g., calcium carbonate, magnesium carbonate, and calcium phosphate. In some instances, the acidic compound imparts the water provided to the membrane element with a pH value of no more than about 2, or no more than about 3, or no more than about 4, or no more than about 5, or no more than about 6, or no more than about 6.5, or no more than about 7, or no more than about 7.5.

In some instances, the acidic compound imparts the water provided to the membrane element with a pH value of no more than 2, or no more than 3, or no more than 4, or no more than 5, or no more than 6, or no more than 6.5, or no more than 7, or no more than 7.5.

In some instances, the acidic compound may be stored in the feeder 128, 228, 328 and introduced into the feed water through the additive line 126, 226, 326 and to the membrane feed line 132, 232, 332. The acidic compound may be introduced during the reverse osmosis process, lowering the pH of the water being treated, and reducing the potential for many ions to form scale on the surface of the membrane element 134, 234, 334.

In some instances, a reduction in pH value of the water or solution in the membrane feed line 132, 232, 332 by at least about 0.5 may increase the solubility of scale-forming compounds significantly and thus reduce scale formation on the surface of the membrane element 134, 234, 334. In some instances, reducing the pH value by at least about 0.5, or by at least about 1, or by at least about 2, or by at least about 3, or by at least about 4, or by at least about 5 may increase the solubility of the scale-forming compounds significantly and thus reduce scale formation. In some instances, reducing the pH value by at least 0.5, or by at least 1, or by at least 2, or by at least 3, or by at least 4, or by at least 5 may increase the solubility of the scale-forming compounds significantly and thus reduce scale formation.

In various instances, a clean-in-place process may be applied where the acid compound may be introduced into the membrane flush or to the rinse water introduced to the membrane element 134, 234, 334 after the reverse osmosis cycle has been stopped. By introducing the acid compound into the permeate flush instead of the feed water, less acid may be used when cleaning the membrane element 134, 234, 334. Furthermore, the pH value of a low TDS water (e.g., the permeate flush) is easier to change. In some instances, the acidic compound in the membrane flush may be introduced directly to the membrane element 134, 234, 334. In some instances, the acidic compound is directed from a dosing tank (not shown) through a dosing conduit (not shown) to the membrane element 134, 234, 334.

A membrane flush imparted with a low pH value may increase the solubility of any minerals that have not already precipitated on the membrane element 134, 234, 334 and may redissolve any scale that has formed on the surface of the membrane element 134, 234, 334. In some instances, the acidic flush water may be used to soak the membrane element 134, 234, 334 when the water treatment system 100, 200, 300 is inactive (e.g., when the system 100, 200, 300 is in the standby mode). Soaking the membrane element 134, 234, 334 with the acidic flush water when the system is inactive may allow significant time for the dissolution of any scale present into the acidic water.

In some instances, the water treatment system 100, 200, 300 may flush the water imparted with a low pH value out of the membrane element 134, 234, 334 prior to the water treatment system 100, 200, 300 going into standby mode to help ensure that water sitting against the membrane element 134, 234, 334 is imparted with a more neutral pH. Minerals may slowly permeate across the membrane element 134, 234, 334 during periods of inactivity, a phenomenon known as “TDS creep”. In some instances, TDS creep may reduce the stress on the membrane element 134, 234, 334, prevent the membrane element 134, 234, 334 from becoming acidified, or allow the acid to slowly permeate across the membrane element 134, 234, 334, thereby lowering the pH of the permeate water.

In various instances, the water treatment system 100, 200, 300 may utilize a cleaning cycle that is executed at fixed, predetermined times of day and/or at predefined intervals (e.g., after a defined number of operational cycles). The cleaning cycle may include any of the physical or chemical cleaning methods as described herein. In some instances, the predefined intervals may be no more than about 30 minutes, or no more than about 1 hour, or no more than about 3 hours, or no more than about 6 hours, or no more than about 12 hours, or no more than about 1 day, or no more than about a week, or no more than about a month. In some instances, the predefined intervals may be no more than 30 minutes, or no more than 1 hour, or no more than 3 hours, or no more than 6 hours, or no more than 12 hours, or no more than 1 day, or no more than 1 week, or no more than 1 month. In some instances, the predefined intervals may be after at least every operational cycle, or at least after every 2 operational cycles, or at least after every 3 operational cycles, or at least after every 5 operational cycles, or at least after every 10 operational cycles, or at least after every 15 operational cycles of the system 100, 200, 300.

In some instances, the cleaning cycle may occur at nighttime when water use is low, such that the chemical additive may soak the membrane element 134, 234, 334 for a longer period compared to daytime settings before the water treatment system 100, 200, 300 returns to use. In some instances, multiple cleaning programs or methods may be implemented, for example running an acid rinse after one cycle, a first chemical additive rinse after another cycle, and a second chemical additive rinse after a further cycle. The ratio, selection, and frequency of running multiple cleaning programs may be determined manually, determined by the control system 400, based upon membrane flux, varied depending on test results of the water supply (e.g., increased TDS content of the water supply), and/or based upon a municipal water report or regional water chemistry.

Since membrane stagnation is a risk factor for reducing the total lifetime of the membrane element 134, 234, 334, in some instances, the water treatment system 100, 200, 300 may run in vacation mode wherein when the membrane element 134, 234, 334 is stagnant for a given period of time, a membrane flush cycle is initiated. The control system 400 as described in FIG. 5 may activate the cleaning cycle if the water treatment system 100, 200, 300 is stagnant for a predetermined amount of time. In some instances, vacation mode may be initiated using a remote device (e.g., a user may use a cell phone to trigger vacation mode). In some instances, the vacation mode and subsequent permeate flush cycle may be triggered by a period of stagnancy lasting at least about 12 hours, or at least about 18 hours, or at least about 24 hours, or at least about 36 hours, or at least about 48 hours, or at least about 72 hours. In some instances, the vacation mode and subsequent permeate flush cycle may be triggered by a period of stagnancy lasting at least 12 hours, or at least 18 hours, or at least 24 hours, or at least 36 hours, or at least 48 hours, or at least 72 hours.

Eventually, membrane fouling will cause the need for membrane element 134, 234, 334 replacement; however, the systems and methods as described herein may be configured to extend the membrane element 134, 234, 334 lifetime. In various instances, the membrane element 134, 234, 334 lifetime may be extended by at least about 1 month, or at least about 2 months, or at least about 3 months, or at least about 6 months, or at least about 1 year, or at least about 2 years, or at least about 4 years, or at least about 5 years, or at least about 10 years. In various instances, the membrane element 134, 234, 334 lifetime may be extended by at least 1 month, or at least 2 months, or at least 3 months, or at least 6 months, or at least 1 year, or at least 2 years, or at least 4 years, or at least 5 years, or at least 10 years.

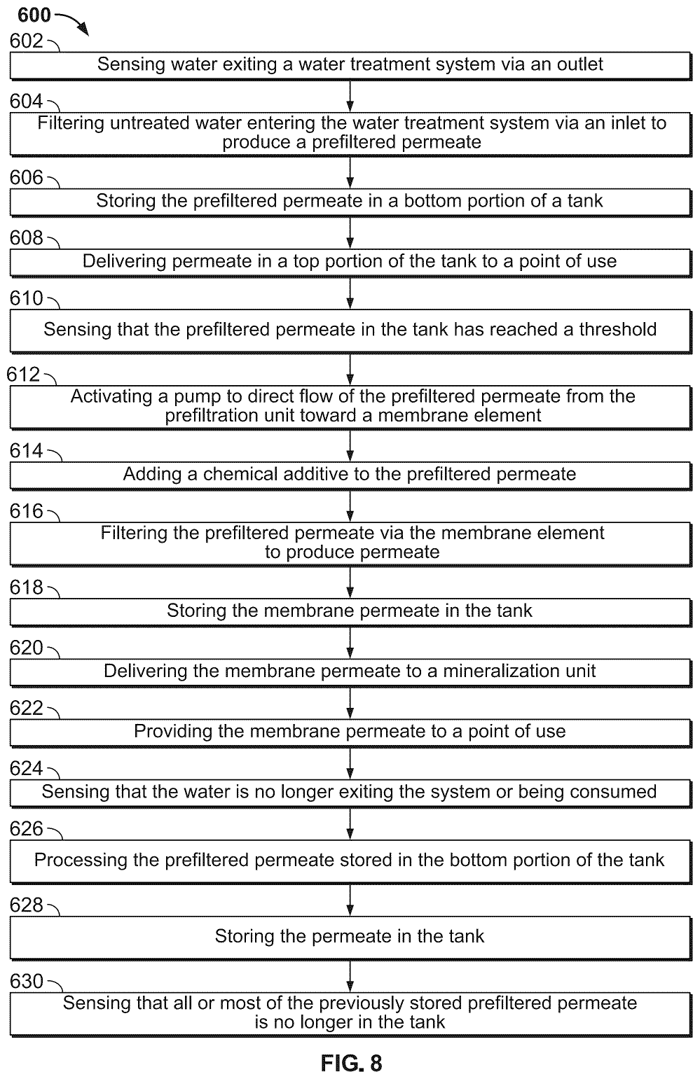

FIG. 8 is a flowchart of an embodiment of a method of treating water 600 using the water treatment systems of FIGS. 1, 2, 3A-3C, and 4A-4F. The method may begin at a step 602. At the step 602, the water treatment system may use one or more sensors to sense water exiting the water treatment system through an outlet of the water treatment system. The water may exit through the outlet in response to water being consumed at a point of use (POU). In some embodiments, the one or more sensors may be a pressure sensor, a TDS sensor, a flowmeter, or a combination thereof.

At a step 604, inlet water, which may be untreated water (e.g., hard water), may enter the water treatment system via an inlet. The inlet water may be untreated water from an external source such as a municipal water source or a well. The inlet water may enter the water treatment system in response to a change in pressure in the water treatment system due to water exiting the water treatment system through the outlet. Additionally, or alternatively, one or more valves in the water treatment system may be opened or closed by a controller to enable the inlet water to enter the water treatment system via the inlet. The inlet water may flow from the inlet to a prefiltration unit where the inlet water may be filtered. The prefiltration unit may filter the inlet water via one or more filter elements, producing a prefiltered water that may flow out of the prefiltration unit.

At a step 606, the prefiltered water, or a portion thereof, may flow into a bottom portion of a tank. The prefiltered water, or a portion thereof, may optionally be stored in the tank.

At a step 608, the prefiltered water entering the bottom portion of the tank may push membrane permeate that may be stored in a top portion of a tank out of the tank toward the outlet for consumption at the POU.

At a step 610, one or more sensors of the water treatment system may sense that the prefiltered water or the membrane permeate that may be stored in the tank has reached a predetermined threshold amount. The threshold may be a value corresponding to a certain volume of prefiltered water in the tank and/or a certain volume of membrane permeate in the tank. The threshold may also be a value corresponding to a certain level of TDS in the water stored in the tank or exiting the tank. The threshold may be calculated using measurements from one or more TDS sensors or pressure sensors disposed in the tank or on a line in fluid communication with the tank. The threshold may also be calculated using measurements from one or more flowmeters disposed on a line in fluid communication with the tank.

At a step 612, a pump in the water treatment system may be activated via the controller in response to the prefiltered water and/or the membrane permeate reaching the threshold. Upon activation of the pump, prefiltered water may flow from the prefiltration unit toward a membrane element, rather than directly into the tank. Additionally, or alternatively, one or more valves in the water treatment system may be opened or closed by the controller to enable the prefiltered water to flow toward the membrane element with or without activation of the pump.

At a step 614, a chemical additive may be optionally added to the prefiltered water by a feeder as the prefiltered water flows past or through the feeder. Alternatively, the chemical additive may be added by the prefiltration unit at step 604.

At a step 616, the prefiltered water (with or without the chemical added) may flow through a membrane element. The membrane element may filter the prefiltered water producing membrane permeate and retentate. The retentate may be discharged from the water treatment system via a retentate line.

At a step 618, the membrane permeate may flow into a top portion of the tank, where the membrane permeate, or a portion thereof, may be optionally stored.

At a step 620, the membrane permeate may be delivered to a remineralization system, which may remineralize the membrane permeate before the membrane permeate exits the water treatment system via the outlet The remineralization system may be any of the remineralization systems described with reference to the systems 100, 200, 300.

At step 622, the membrane permeate may flow from the top portion of the tank to a POU via an outlet of the water treatment system. Additionally, or alternatively, the membrane permeate may flow directly to the POU at step 620 and bypass the tank at step 618. The membrane permeate may flow directly out of the outlet to the POU if, for example, water consumption is high. Whether the membrane permeate flows to the top of the tank or directly to the POU via the outlet may be determined by changes in pressure in the various lines.

At a step 624, one or more sensors may sense that water consumption has stopped, and water is no longer exiting the water treatment system via the outlet.

At a step 626, one or more valves may be opened or closed via the controller to direct the prefiltered water from the bottom portion of the tank to the membrane element to be processed into membrane permeate.

At a step 628, the membrane permeate that may be produced from the processing of the prefiltered water from the tank may flow into the top portion of the tank for optional storage, and any retentate may be discharged from the water treatment system via the retentate line.

At a step 630, the one or more sensors may sense that all or most of the prefiltered water previously stored in the tank is no longer in the tank, and the method may end.

Optionally, the system may activate a cleaning cycle to extend the health and lifetime of the membrane element. In some instances, the cleaning cycle may comprise physical and/or chemical cleaning processes. The physical cleaning processes may include membrane flush, rinse, and/or soak processes using feed water or permeate water. Chemical processes may include membrane flush, rinse, soak, or clean-in-place processes using a chemical additive. In some instances, the chemical additive introduced by the feeder may include a chelation agent, a polyphosphate compound, and/or an acidic compound. In some instances, the chemical additive may be incorporated into a cleaning cycle including a membrane flush, rinse, soak, or clean-in-place process.

As mentioned above, the water treatment system (100, 200, 300) may include one or more RO membranes, which may be spiral wound RO membranes having feed spacers imparted with a certain thickness and/or structure. Through testing, thinner feed spacers (e.g., feed spacers imparted with a thickness of about 17 mil or less) have been found to have several unexpected benefits, as described herein.

Table 3 provides test results of spiral wound 4040 RO membranes, each RO membrane including feed spacers having a diamond-shaped structure but a different feed spacer thickness. Specifically, the spiral wound 4040 RO membranes had diamond-shaped feed spacers with a thickness of 34 mil, 17 mil, and 13 mil. The RO membranes were evaluated to determine the rate at which they rejected unwanted components of inlet water (i.e., total dissolved solids and ions increasing water hardness) and the volume of permeate output (i.e., the permeate flux). The RO membrane having 34 mil feed spacer thickness was provided as a comparator for the RO membranes having 17 mil and 13 mil feed spacer thicknesses. The test was performed under 120 pounds per square inch (PSI) of pressure and at an 80% water recovery. Table 3 shows that by reducing the thickness of the feed spacer (e.g., to 17 mil or less) the membrane permeate output drastically improved while the TDS and hardness rejection of the RO membrane remained relatively constant. While a spiral wound 4040 RO membrane with a thinner feed spacer has more surface area, so an increase in membrane permeate output is to be expected, the increase in membrane permeate output was a magnitude much larger than the relative increase in surface area caused by using the thinner feed spacers (e.g., a membrane permeate output increase of 146% versus a surface area increase of 43% for 17 mil and a membrane permeate output increase of 163% versus a surface area increase of 54% for 13 mil). Without being bound to a particular theory, it is believed that the increased performance in membrane permeate production may be attributed to the higher feed and retentate velocity induced in the water by passing the water through the thinner feed spacer channels. In addition, the thinner feed spacers consist of a diamond-shaped structure, which has a smaller unit size than larger feed spacers. Without being bound to a particular theory, it is believed that the smaller unit size of the diamond-shaped feed spacers creates a higher density of turbulizing features, which reduces the concentration of ions on the membrane surface. The improved membrane performance (e.g., an increase in permeate production with a relatively small increase in the surface area) is a unique result that may only occur at high water recoveries (e.g., 80% recovery or higher).

TABLE 3

| Feed Spacer Size | 34 mil | 17 mil | 13 mil |
|---|---|---|---|
| TDS rejection % | 93.3 | 91.8 | 92.1 |
| Hardness rejection % | 96.6 | 97.6 | 96.2 |
| Permeate flow, gallons per | 1.23 | 3.02 | 3.24 |
| minute (GPM) | | | |
| Permeate flow increase | Control | 146% | 163% |
| Surface Area, square feet (ft²) | 78.5 | 112 | 121 |
| Surface Area Increase | Control | 43% | 54% |

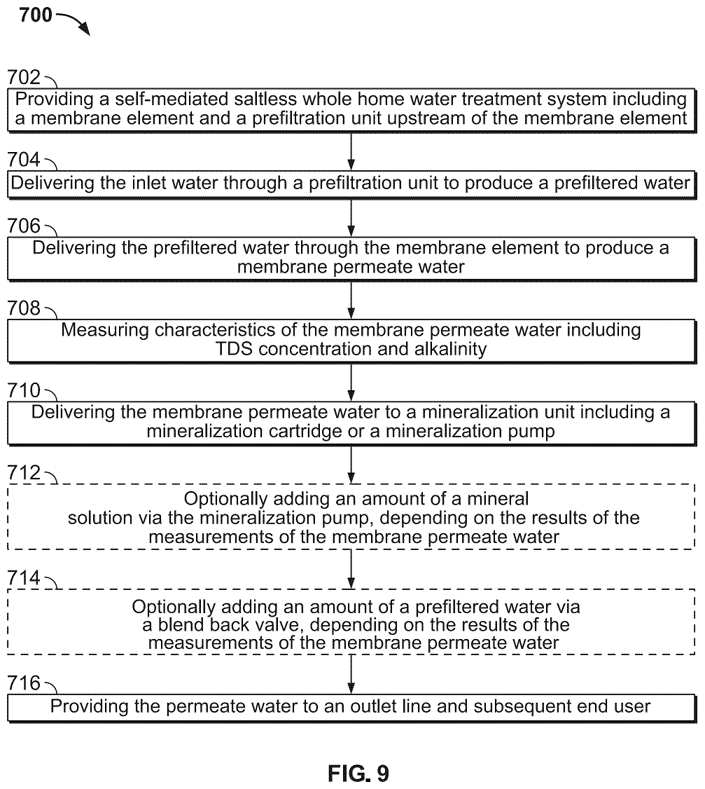

FIG. 9 is a flowchart of an embodiment of a method 700 of treating water using any of the water treatment systems of FIGS. 1, 2, 3A-3C, and 4A-4F. The method 700 may begin at a step 702. At the step 702, a self-mediated saltless whole-home water system including a membrane element and a prefiltration unit positioned upstream of the membrane element is provided.

At a step 704, the inlet water may be delivered through the prefiltration unit to produce a prefiltered feed water. The inlet water, which may be untreated water (e.g., hard water), may enter the water treatment system via an inlet. The inlet water may be untreated water from an external source such as a municipal water source or a well. The inlet water may enter the water treatment system in response to a change in pressure in the water treatment system due to water exiting the water treatment system through the outlet. The prefiltration unit may filter the inlet water via one or more filter elements, producing a prefiltered water that may flow out of the prefiltration unit.

At a step 706, the prefiltered water may be delivered through the membrane element to produce a membrane permeate water. The membrane element may include a combination of one or more of an RO membrane, an NF membrane, a UF membrane, an MF membrane, a particulate membrane, and/or an electrodialysis membrane, which may be disposed in parallel or in series. The one or more membranes in the combination of membranes may be contained within a single housing, in separate housings, or a combination thereof. In some cases, the membrane element used in the step 706 may be a NF membrane. In some such cases, the NF membrane may be a treated NF membrane. In addition, the NF membrane may be treated, processed, or designed to produce a balanced permeate water.

At a step 708, the characteristics of the membrane permeate water, including TDS concentration and alkalinity, may be measured using various sensors including TDS sensors and/or pH sensors. The step 708 may further comprise defining an action based on the obtained sensor information. In some instances, the step 708 may include taking an action. In some cases, the action may be initiated by a controller (e.g., the controller 402). The actions may include, but are not limited to, maintaining a normal operating condition of the system; adding an amount of a mineral solution to the permeate water via a remineralization pump; adding an amount of a prefiltered water via a blend back valve; and providing the permeate water to an outlet line and subsequent end user. For example, the action may include at least one of: maintaining a normal operating condition of the system; adding an amount of a mineral solution to the permeate water via a remineralization pump; adding an amount of a prefiltered water via a blend back valve; and/or providing the permeate water to an outlet line and subsequent end user. In certain cases, a controller may determine an amount of the prefiltered water and/or an amount of the mineral solution to add to the permeate water based on a target TDS concentration and/or a target pH for the outlet water produced by the water treatment system.

At a step 710, the membrane permeate water may be delivered to a remineralization system that includes a remineralization cartridge or a remineralization pump. In some embodiments of the step 710, the remineralization system may be a device containing a remineralization material that has an inlet and an outlet through which water passes. For example, the remineralization system may be provided as a cartridge that may be replaced when the remineralization material is depleted. In some embodiments of the step 710, the remineralization system may include a bed or cartridge of remineralization material disposed on a line (e.g., an outlet feed line) or another system component of the water treatment system, which water passes by but does not flow through. In further embodiments of the step 710, the remineralization system may be disposed within a top portion of a tank so that the membrane permeate contacts the remineralization material in the remineralization system while the membrane permeate is stored in the tank, including during periods when there is no flow of membrane permeate into or out of the tank. In yet other embodiments of the step 710, the remineralization system may be provided in the form of a solid block (e.g., as a block of calcite) that is disposed within the tank or within one of the lines or another system component of the water treatment system.

In other instances of the step 710, one pass of the permeate water through the remineralization cartridge may or may not be sufficient to achieve the desired TDS level and/or pH level of the permeate water. In such instances, the step 710 may optionally include recirculating the permeate water through the remineralization cartridge as many times as necessary to achieve the desired TDS concentration and pH level. In some such instances, a recirculation valve may be provided on a recirculation line, in which the recirculation valve is designed to control the number of times the permeate water is recirculated through the remineralization cartridge. In some instances of the step 710, the output of the recirculated permeate water may be provided to the tank via a conduit. In other instances of the step 710, the output of the recirculated permeate water may be provided to an outlet of the water treatment system to a point of use.

At a step 712, depending on the results of the measurements of the membrane permeate water, an amount of mineral solution may optionally be added to the membrane permeate water via the remineralization pump. In some instances of the step 712, the remineralization pump may dose aqueous solutions of minerals to the permeate water. In some instances, the step 712 may use at least one or more than one remineralization pump. In addition, the remineralization pump may be designed to add specific concentrations of at least one or a plurality of aqueous solutions of minerals to the permeate water. In some instances of the step 712, an aqueous solution of sodium bicarbonate, sodium hydroxide, potassium hydroxide, potassium bicarbonate, sodium carbonate, potassium carbonate, any other suitable compound, or any suitable combination thereof may be added via the remineralization pump to the permeate water when the system is processing water through the membrane element. In some instances of the step 712, the addition of sodium bicarbonate via the remineralization pump to the permeate water may fill the tank with product water with the desired pH level.

At a step 714, depending on the results of the measurements of the membrane permeate water, an amount of prefiltered water may optionally be added to the membrane permeate water via a blend back valve. In various instances of the step 714, the blend back valve may provide an amount of prefiltered water via a blend back conduit to the permeate water to achieve a target TDS value and/or alkalinity value and/or pH value based on the characteristics of the feed water. In some embodiments of the step 714, the incorporation of the blend back valve provides an amount of prefiltered water to the permeate water, which may allow the system to produce water at a higher rate of delivery. In some embodiments of the step 714, the blend back valve may be configured to blend an amount of the prefiltered water into the permeate water to achieve a target TDS value and/or alkalinity value and/or pH value based on the measurement of the characteristics of the membrane permeate water in the step 708. In another instance of the step 714, the amount of feed water added to the permeate water via the blend back valve may be automated and integrated with at least one TDS sensor and/or at least one pH sensor. In various instances of the step 714, the blend back valve may be a variable valve controlled by feedback from TDS sensors and/or pH sensors provided in the system. This may allow for real-time adjustments to deliver the desired water chemistry profile.

At a step 716, the permeate water may be provided to an outlet line and a subsequent end user.

In some embodiments, a method for treating an inlet stream with a water treatment system may include supplying water to a membrane element, wherein the membrane element comprises a treated or processed NF membrane. The method may further include treating the NF membrane with one or more corrosive agents to intentionally tailor pore geometry and impart desired separation characteristics to the NF membrane. Representative separation characteristics tailored by the treatment step may include one or more of a calcium rejection percentage, total hardness rejection percentage, a TDS rejection percentage, an alkalinity rejection percentage, a permeate pH value, a membrane permeance value, a pollutant removal percentage, a permeate flow rate, and calculated LSI/CPP values (and/or other index values). In some cases, the values of the calcium rejection percentage, total hardness rejection percentage, a TDS rejection percentage, an alkalinity rejection percentage, a permeate pH value, a membrane permeance value, a pollutant removal percentage, a permeate flow rate, and calculated LSI/CPP values (and/or other index values) may be any of the values discussed with reference to those characteristics with respect to the water treatment system 300 of FIGS. 4A-4F.

In some embodiments, the method may further include removing micro-pollutants from the inlet feed stream. In some instances, the micro-pollutants may comprise PFAS compounds. Representative PFAS compounds that may be removed with the NF membrane may include perfluorobutane sulfonate (PFBS), perfluorohexanesulfonic acid (PFHxS), perfluorooctanoic acid (PFOA), perfluorooctane sulfonic acid (PFOS), perfluorodecanoic acid (PFDA), perfluoroheptanoic acid (PFHpA), and/or perfluorononanoic acid (PFNA). In certain cases, at least about 95%, or at least about 96%, or at least about 97%, or at least about 98%, or at least about 99%, or at least about 99.5%, or at least about 99.9%, or about 100% of total PFAS compounds present in the inlet water may be removed by the treated or processed NF membrane.

In some embodiments, the method may further include removing heavy metals from the inlet water. In some instances, the heavy metals may include, for example, copper, lead, arsenic, chromium, and iron. In certain cases, at least about 70%, or at least about 75%, or at least about 80%, or at least about 85%, or at least about 90%, or at least about 95%, or at least about 96%, or at least about 97%, or at least about 98%, or at least about 99%, or about 100% of the heavy metals in the inlet water may be removed from the inlet water by the treated or processed NF membrane.

In some embodiments, the method may include providing a permeate water from the membrane element. In some instances, the permeate water stream may be imparted with desired parameters or characteristics. For example, the permeate water may be imparted with a calcium ion concentration that is about 75% to about 90% less than a calcium ion concentration of the inlet water, a total hardness concentration that is about 75% to about 90% less than a total hardness concentration of the inlet water, a TDS level that is about 70% to about 90% less than the TDS level of the inlet water, an alkalinity value that is about 75% to about 90% less than the alkalinity value of the inlet water, and/or a pH level of about 6.2 to about 8.5. As an additional example, the permeate water may be imparted with a calcium ion concentration that is about 81% to about 84% less than a calcium ion concentration of the inlet water, a total hardness concentration that is about 81% to about 84% less than a total hardness concentration of the inlet water, a TDS level that is about 81% to about 84% less than the TDS level of the inlet water, an alkalinity value that is about 81% to about 84% less than the alkalinity value of the inlet water, and/or a pH level of about 6.8 to about 7.5. In some such instances, the membrane element may be treated, processed, or designed to have a desired membrane permeance of about 13 LMBH to about 20 LMBH, or about 17 LMBH to about 20 LMH/bar, although the desired membrane permeance may be greater than these values. In further such instances, the permeate water stream provided from the membrane element may be imparted with a flow rate of about 5 GPM to about 8 GPM, although the flow rate may be even greater than these values. As such, in various cases, the permeate water stream may be provided from the NF membrane as a balanced water stream.

It is to be understood that any steps of any of the methods described herein (e.g., the methods 600, 700, the method of using a treated NF membrane) may be performed more than once or may be omitted. In addition, the steps of the methods described herein may be performed in any order. Furthermore, the methods may include additional steps in accordance with any of the teachings described herein.

In some instances, one or more of the above methods may use machine learning (ML), artificial intelligence (AI), or similar, to iteratively train the controller and improve the performance of the system based on one or more feedback parameters, characteristics, or similar. For example, in some instances, ML/AI may be used to predict an optimal cleaning schedule based on system data such as filter loading data, bather load data, geographic location of the system, weather data, user preferences, and other similar factors. In some instances, ML/AI may be used to provide accurate remineralization dosing and/or predict chemical usage trends. Thus, the system may be optimized to reduce fluctuations in the remineralization dosage, which may beneficially reduce the likelihood of undesirably high or low remineralized permeate water leaving the water treatment system. Additionally, this may help a user determine amounts or types of chemicals needed to remineralize the permeate stream and/or when to reorder chemical or replace components of the remineralization system.

As described with reference to the water treatment systems 100, 200, 300 (e.g., see FIGS. 1-4E), in some instances the chemical additive introduced by the feeder 128, 228, 328 may include glassy beaded HMP, a blend of HMP and silicate in glassy form, and/or a blend of polyphosphates.

Various polyphosphates may have different dissolution rates. All polyphosphates are highly soluble in water, but the rate at which they dissolve may at least partially depend on their form, molecular weight, and binder matrix. For example, it was determined that after an overnight dwell in 1 L of deionized water, using 10 grams each of glassy beaded HMP, a blend of HMP and silicate in glassy bead form, and blend of polyphosphates, the solutions had a solubility of 20 mg/L, 200 mg/L and >10000 mg/L total phosphate, respectively.

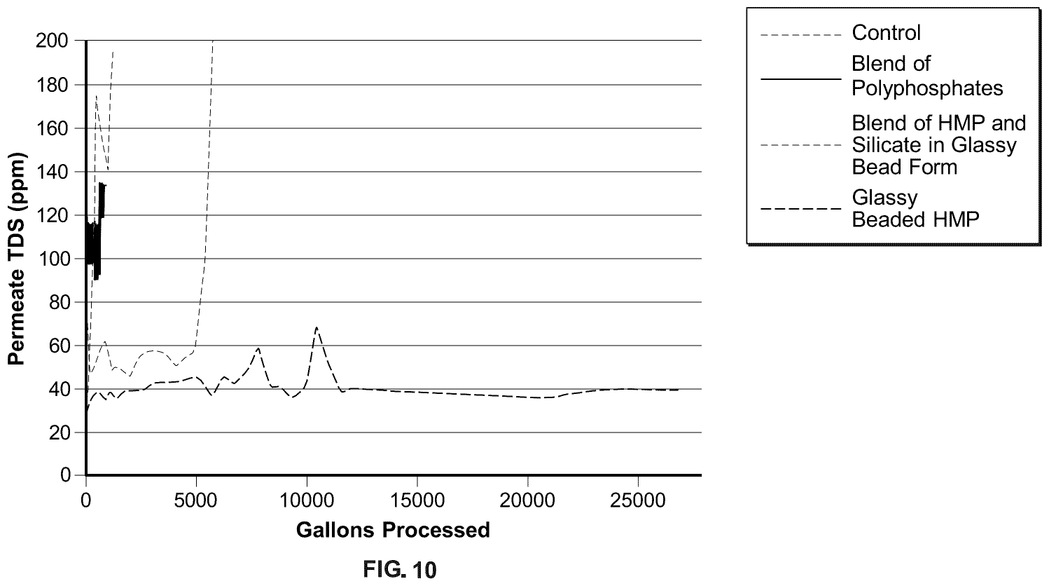

Turning to FIG. 10, performance of a membrane within an RO membrane element was monitored as various polyphosphates were dosed to the water provided to the membrane. Specifically, FIG. 10 depicts the volume of water processed by the membrane element 234, 334 (in gallons) versus the TDS content of the water when glassy beaded HMP, a blend of HMP and silicate in glassy form, and a blend of polyphosphates were used. MRS-600 units were operated using artificially prepped water imparted with a hardness value of 200 ppm, and the artificially prepped water was introduced to the membrane at a rate of 600 gallons per day (gpd) (approximately 2270 liters per day) under cyclical operational conditions (i.e., 4 minute tank emptying and 9 minute tank filling). Additionally, transmembrane pressure and outlet TDS were regularly monitored to track performance, as well as the inlet side total phosphate. Failure was defined as when the TDS value of the permeate rapidly increased. FIG. 10 shows that the blend of polyphosphates failed at 800 gallons (approximately 3030 liters), which was worse than the failure point of the control (1000 gallons, or approximately 3790 liters). The blend of HMP and silicate in glassy bead form performed better, with a failure point near 5000 gallons (approximately 18,930 liters). The glassy beaded HMP prevented membrane failure up to more than about 25000 gallons (approximately 94,640 liters) processed, at which time the experiment was terminated.

In some instances, the polyphosphate products may be characterized using the NACE method TM0374-2016-G which measures the polyphosphate's absolute ability to keep calcium in solution under scaling conditions of a calcium concentration of 599 mg/L provided at 70° C. for 24 hours. The results were relative to a blank control, in both calcium carbonate and calcium sulfate brines. Test water was imparted with polyphosphate concentrations of 1 ppm and 20 ppm, and said test waters were tested to gauge calcium sensitivity. Table 4 shows that glassy beaded HMP is the most effective under scaling conditions of a calcium concentration of 599 mg/L provided at 70° C. for 24 hours and is more effective at 1 ppm. Additionally, Table 4 shows that glassy beaded HMP has very high affinity for calcium.

TABLE 4

Percent Inhibition

| | | | |
|---|---|---|---|
| Polyphosphate Type | Dosage | CaCO₃ | CaSO₄ |

| | | | | |
|---|---|---|---|---|
| Glassy beaded HMP | 1 | ppm | 99.5% | 95.7% |
| | 20 | ppm | 58.4% | 39.1% |
| Blend of HMP and silicate | 1 | ppm | 32.3% | 9.9% |
| in glassy bead form | 20 | ppm | 57.1% | 85.6% |
| Blend of | 1 | ppm | 32.3% | 21.9% |
| polyphosphates | 20 | ppm | 57.1% | 81.9% |

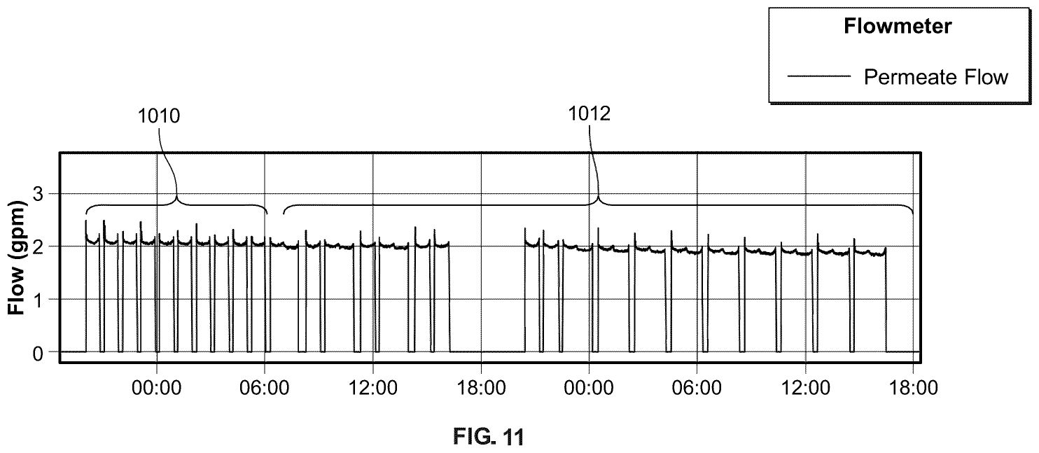

FIGS. 10 and 11 demonstrate that consistent permeate flushing may maintain a desired permeate flow rate. Consistent flushing may be defined as flushing that is repeated at defined time intervals or after a set number of water processing operations. FIG. 11 depicts the permeate flow rate (in gallons per minute (GPM)) of a water treatment system during a first time period 1010 wherein the flush process is consistent as compared to a second time period 1012 wherein the flush process is inconsistent (i.e., not regularly provided or not provided at all). It was determined that, when the permeate flush was consistently applied as in the first time period 1010, no substantial decline in the permeate flow rate was observed. However, when the permeate flush between processing cycles is inconsistent, as in the second time period 1012, the permeate flow consistently decreases over time.

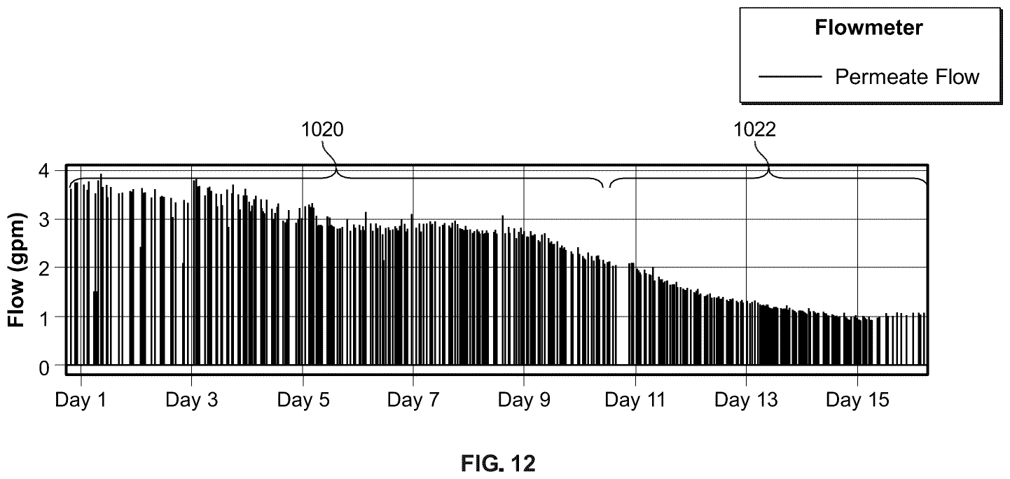

FIG. 12 depicts the permeate flow rate in another system installation during a first time period 1020 wherein the flush process is consistent compared to a second time period 1022 when a flush process was not used. Subsequently, the non-use of flushing during the second time period 1022 led to a rapid decline of the permeate flow rate compared to when the system was flushing at regular intervals during the first time period 1020. Thus, FIGS. 10 and 11 illustrate that flushing the membrane element surface with solution may be beneficial for membrane health. If the flush is not maintained at regular intervals, especially when operating the membrane element at high recovery, then a decline in permeate flow rate may result.

Various properties of the water treatment systems and methods described with reference to FIGS. 1-12 were described in association with one or more values or one or more ranges of values. It is to be understood that each property described herein with reference to numerical values or ranges may be imparted with a discrete value, or a range of values, consistent with all values recited with reference to said property. In addition, each property described herein with reference to numerical values or ranges may be imparted with a discrete value, or range of values, falling within any minimum and maximum value or range recited with reference to said property.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

1. A water treatment system, comprising:
a prefiltration unit in fluid communication with a source of untreated water, wherein the prefiltration unit is designed to produce a prefiltered water from the untreated water;
a pump in fluid communication with the prefiltration unit;
a membrane element in fluid communication with the pump via a first line, wherein the membrane element is designed to produce a permeate stream;
one or more valves designed to regulate a first flow of the prefiltered water and a second flow of the permeate stream;
a remineralization system in fluid communication with the membrane element, wherein the remineralization system provides a remineralization material to the permeate stream to produce a remineralized water stream; and
a first sensor in fluid communication with the remineralization system, wherein the first sensor is positioned downstream of the remineralization system and is designed to measure a first characteristic of the remineralized water stream.

2. The water treatment system of claim 1, wherein the remineralization material is selected from the group consisting of a calcium carbonate compound, a magnesium carbonate compound, a magnesium oxide compound, a calcium oxide compound, a sodium carbonate compound, a sodium bicarbonate compound, dolomite, a magnesium oxysulfate compound, a potassium carbonate compound, a potassium bicarbonate compound, and combinations thereof.

3. The water treatment system of claim 1 further including a tank in fluid communication with the membrane element and the prefiltration unit, wherein the tank is designed to store the prefiltered water provided from the prefiltration unit and the permeate stream provided from the membrane element.

4. The water treatment system of claim 3, wherein the remineralization material is disposed within the tank.

5. The water treatment system of claim 3, wherein the remineralization material is provided in the form of a solid block.

6. The water treatment system of claim 1, wherein the remineralization material is provided in the form of an aqueous solution.

7. The water treatment system of claim 1, wherein the remineralization system further includes a reservoir provided in the form of a remineralization cartridge designed to store the remineralization material, wherein the remineralization cartridge is positioned in-line with an outlet feed line or a membrane permeate line.

8. The water treatment system of claim 1, wherein the remineralization system further includes a remineralization pump designed to dose the permeate stream with the remineralization material.

9. The water treatment system of claim 1, wherein:
a second sensor is positioned upstream of the remineralization system,
the second sensor is provided in the form of a pH sensor designed to monitor a pH level of the permeate stream,
the remineralization material released by the remineralization system is designed to alter the pH level of the permeate stream and remineralize the permeate stream.

10. The water treatment system of claim 1 further including a blend back valve in fluid communication with the prefiltration unit and the permeate stream, wherein the blend back valve is designed to provide a metered amount of prefiltered water to the permeate stream to achieve a desired parameter in the permeate stream, and the desired parameter is selected from the group consisting of a target TDS value, a target alkalinity value, a target pH value, and combinations thereof.

11. The water treatment system of claim 1, wherein:
the permeate stream is imparted with a first concentration of solutes,
the remineralized water stream is imparted with a second concentration of solutes that is greater than the first concentration of solutes,
the first concentration of solutes is less than about 60 ppm,
the second concentration of solutes is more than about 60 ppm.

12. A water treatment system comprising:
an inlet in fluid communication with a source of inlet water;
a pump in fluid communication with the inlet;
a membrane element designed to remove solutes from the inlet water, wherein the membrane element is in fluid communication with the pump via a first line, and the membrane element produces a membrane permeate water imparted with a first concentration of solutes and a membrane retentate water imparted with a second concentration of solutes that is greater than the first concentration of solutes,
a membrane permeate line designed to carry the membrane permeate water produced by the membrane element;
an outlet feed line in fluid communication with the membrane permeate line and an outlet;
a remineralization system in fluid communication with the membrane element, the remineralization system positioned and located downstream of the membrane element; and
a first sensor in communication with the outlet feed line, wherein the first sensor measures a TDS concentration of the membrane permeate water,
wherein an output water stream provided from the outlet is imparted with a third concentration of solutes.

13. The water treatment system of claim 12, wherein:
the remineralization system includes a remineralization material and a remineralization pump;
a controller is in electrical communication with the first sensor and the remineralization pump,
the remineralization pump is designed to provide a quantity of the remineralization material to the membrane permeate water,
the controller is designed to actuate the remineralization pump in response to measured values obtained from the first sensor.

14. The water treatment system of claim 12, wherein the remineralization system introduces a remineralization material to the membrane permeate water before the membrane permeate water exits the outlet, the remineralization material is selected from the group consisting of a calcium-containing compound, a magnesium-containing compound, a carbonate-containing compound, a bicarbonate-containing compound, and combinations thereof.

15. The water treatment system of claim 12, wherein the third concentration of solutes is greater than the first concentration of solutes and is less than the second concentration of solutes.

16. The water treatment system of claim 12 further including a tank and a tank line that are in fluid communication with the membrane permeate line, wherein:
the tank is designed to store the membrane permeate water provided from the membrane element,
the tank line is in fluid communication with a top portion of the tank and the outlet feed line,
a reservoir of the remineralization system is located downstream of the membrane element and is in fluid communication with the tank line.

17. A method of treating water, the method comprising:
providing a water treatment system including a membrane element and a prefiltration unit positioned upstream of the membrane element;
passing inlet water through the prefiltration unit to produce a prefiltered water;
filtering the prefiltered water with the membrane element to produce a permeate water stream and a retentate water stream;
providing the permeate water stream to a remineralization system;
sensing, via a first sensor, a first characteristic of the permeate water stream;
determining an action based on the first characteristic; and
initiating the action, wherein the action comprises at least one of:
maintaining a normal operating condition of the water treatment system;
adding a first amount of a mineral solution to the permeate water stream via a remineralization pump;
passing the permeate water stream through a remineralization system;
adding a second amount of the prefiltered water to the permeate water stream via a blend back valve; and
providing the permeate water stream to an outlet feed line and subsequent end user.

18. The method of claim 17 further including determining a recovery of the membrane element, wherein the action further comprises adjusting a flow of the retentate water stream to modify the recovery of the membrane element.

19. The method of claim 17 further including recirculating the permeate water stream through the remineralization system before providing the permeate water stream to the outlet feed line.

20. The method of claim 17, wherein:
the blend back valve is configured to blend the second amount of the prefiltered water into the permeate water stream to achieve a target TDS value and a target alkalinity value,
the second amount of the prefiltered water added to the permeate water stream via the blend back valve is determined by measurements obtained from at least one of a TDS sensor and a pH sensor.
